(19) United States
(12) Patent Application Publication
(10) Pub. No.: US 2023/0236373 A1
(43) Pub. Date: Jul. 27, 2023

(54) SYSTEMS AND METHODS FOR PHOTONIC CHIP COUPLING

(71) Applicant: SiPhox, Inc., Cambridge, MA (US)

(72) Inventors: Diedrik Rene Vermeulen, Somerville, MA (US); Michael Whitson, Trondheim (NO); Michael Dubrovsky, Somerville, MA (US); Azra Horowitz, Astoria, NY (US)

(21) Appl. No.: 18/000,818

(22) PCT Filed: Jun. 4, 2021
(86) PCT No.: PCT/US2021/035894

§ 371 Date: Dec. 5, 2022

Related U.S. Application Data
(60) Provisional application No. 63/035,677, filed on Jun. 5, 2020.
(60) Provisional application No. 63/139,564, filed on Jan. 20, 2021.

(51) Int. Cl. G02B 6/43; G02B 6/42; B01L 3/00

(52) U.S. Cl. CPC G02B 6/43; G02B 6/4231; G02B 6/4239; B01L 3/502715; B01L 2200/027; B01L 2200/04; B01L 2200/12

(57) ABSTRACT

Systems and methods for coupling photonic integrated subcircuits are described herein. The example system can include a first cartridge (4702) including a first photonic integrated subcircuit (4706) and a first alignment feature (4720, 4722). The system can include a second cartridge (4704) including a second photonic integrated subcircuit (4708) and a second alignment feature (4724, 4726), where the first alignment feature (4720, 4722) and the second alignment feature (4724, 4726) can be configured to enable alignment between the first photonic integrated subcircuit (4706) and the second photonic integrated subcircuit (4708). When the first photonic integrated subcircuit (4706) is aligned to the second photonic integrated subcircuit (4708), a first light path of the first photonic integrated subcircuit (4706) can be optically coupled to a second light path of the second photonic integrated subcircuit (4708).

### CROSS-REFERENCE TO RELATED APPLICATIONS

This application claims priority to and the benefit of U.S. Provisional Application No. 63/035,677 titled “Adiabatic Photonic Chip Coupling” and filed Jun. 5, 2020 and U.S. Provisional Application No. 63/139,564 titled “Precision Mechanical Alignment for Optical Coupling” and filed Jan. 20, 2021, which are incorporated herein by reference in their entireties.

### TECHNICAL FIELD

The following disclosure is directed to systems and methods of coupling photonic integrated subcircuits and, more specifically, adiabatic optical coupling, precision mechanical alignment, and/or precision mechanical coupling of photonic integrated subcircuits.

### BACKGROUND

Attachment between photonic chips can be typically done using optical feedback that is coupled into both photonic chips to monitor the optical alignment. For such methods, users need to be able to optimize all 6 degrees of freedom: translation in the x, y, z axes and rotation in yaw, pitch and roll. This is can be an expensive, time-consuming process and is difficult to scale up.

### SUMMARY

A system for coupling photonic integrated subcircuits is presented. In some embodiments, the system can include a first cartridge including a first photonic integrated subcircuit and a first alignment feature. In some embodiments, the system can include a second cartridge including a second photonic integrated subcircuit and a second alignment feature, where the first alignment feature and the second alignment feature can be configured to enable alignment between the first photonic integrated subcircuit and the second photonic integrated subcircuit. In some embodiments, when the first photonic integrated subcircuit is aligned to the second photonic integrated subcircuit, a first light path of the first photonic integrated subcircuit can be optically coupled to a second light path of the second photonic integrated subcircuit.

In some embodiments, the second alignment feature includes a receiving feature configured to receive the first alignment feature. In some embodiments, the first light path can be within a side edge of the first photonic integrated subcircuit and the second light path is within a side edge of the second photonic integrated subcircuit. In some embodiments, the first light path is within a top surface of the first photonic integrated subcircuit and the second light path is within a bottom surface of the second photonic integrated subcircuit. In some embodiments, the top surface of the first subcircuit partially overlaps the bottom surface of the second subcircuit. In some embodiments, at least one of the first cartridge or the second cartridge includes a carrier configured to hold a respective one of the first photonics integrated subcircuit and the second photonics integrated subcircuit. In some embodiments, a surface of the carrier includes one or more pedestals located between the respective photonics integrated subcircuit and the carrier. In some embodiments, the first photonic integrated subcircuit includes at least two trench features and the carrier includes at least two extruded portions, and wherein each trench feature is configured to receive a respective extruded portion such that the first photonic integrated subcircuit is secured to the carrier. In some embodiments, the first photonic integrated circuit is bonded to the carrier. In some embodiments, the first photonic integrated circuit is bonded to the carrier using an adhesive. In some embodiments, the first alignment feature includes at least one of a rod shape, a cylindrical shape, or a cuboid shape. In some embodiments, the first cartridge includes a third alignment feature and the second cartridge includes a fourth alignment feature, where the third alignment feature and the fourth alignment feature are configured to further enable alignment between the first photonic integrated subcircuit and the second photonic integrated subcircuit. In some embodiments, the second alignment feature includes a groove, a hole or a receptacle. In some embodiments, the second alignment feature includes a triangular groove, rectangular groove or a cylindrical groove. In some embodiments, the system can further include a first optical component coupled to the first photonic integrated subcircuit and the first alignment feature. In some embodiments, the first optical component includes an optical fiber. In some embodiments, the system further includes a ferrule having a third alignment feature, the third alignment feature is configured to receive at least one of the first alignment feature or the second alignment feature.

A system for coupling photonic integrated subcircuits is presented. In some embodiments, the system can include a first cartridge includes a first alignment feature. In some embodiments, the system can include a microfluidics channel disposed within the first cartridge. In some embodiments, the system can include a first photonic integrated subcircuit disposed within the first cartridge and adjacent to the microfluidics channel. In some embodiments, the system can include a second cartridge including a second alignment feature. In some embodiments, the system can include a ferrule coupled to a spring disposed within the second cartridge. In some embodiments, the system can include a second photonic integrated subcircuit disposed within the second cartridge and adjacent to the ferrule. In some embodiments, the first alignment feature and the second alignment feature is configured to enable alignment between the first photonic integrated subcircuit and the second photonic integrated subcircuit. In some embodiments, when the first photonic integrated subcircuit is aligned to the second photonic integrated subcircuit, a first light path of the first photonic integrated subcircuit is optically coupled to a second light path of the second photonic integrated subcircuit.

In some embodiments, the first and second cartridges includes a multi-fiber push-on (MPO) connector. In some embodiments, the second alignment feature includes a receiving feature configured to receive the first alignment feature.

A method for coupling photonic integrated subcircuits is presented. In some embodiments, the method includes providing a first cartridge including a first photonic integrated subcircuit and a first alignment feature. In some embodiments, the method includes providing a second cartridge comprising a second photonic integrated subcircuit and a second alignment feature, where the first alignment feature and the second alignment feature are configured to enable alignment between the first photonic integrated subcircuit and the second photonic integrated subcircuit. In some embodiments, the method includes aligning, via the first alignment feature and the second alignment feature, the first photonic integrated subcircuit to the second photonic integrated subcircuit such that a first light path of the first photonic integrated subcircuit is optically coupled to a second light path of the second photonic integrated subcircuit.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the systems and methods described herein. In the following description, various embodiments are described with reference to the following drawings.

FIG. 1 is a diagram of a perspective view of an example integrated photonics assembly that multiple photonic integrated subcircuits.

FIG. 2 is a diagram of a top view illustrating light transfer between example subcircuits of an integrated photonics assembly.

FIGS. 3A-3C are diagrams of top views of example integrated photonics assemblies, which each include multiple subcircuits.

FIG. 4 is a diagram of a top view of an example packaged 1D integrated photonics assembly.

FIG. 5 is a diagram of a top view of an example packaged pseudo-2D integrated photonics assembly.

FIG. 6 is a diagram of a top view of an example packaged integrated photonics assembly formed in the shape of a closed-loop “snake”.

FIG. 7 is a diagram of a top view of an example packaged integrated photonics assembly formed in the shape of an open-loop “snake”.

FIG. 8 is a diagram of a top view of an example packaged assembly, illustrating that the subcircuits can be standardized.

FIG. 9 is a diagram of a top view of an example integrated photonics assembly formed into a “checker” type assembly.

FIG. 10A is a diagram of a top view of an example 1D integrated photonics assembly.

FIGS. 10B-10C are diagrams of top views of a representative subcircuit of the assembly of FIG. 10A.

FIGS. 11A-11B are diagrams of top views of alternative examples of the assembly of FIG. 10A.

FIGS. 12A-12B are diagrams of top views of example assemblies of four integrated photonic subcircuits, in which each subcircuit is configured to transfer light to an adjacent subcircuit.

FIGS. 13A-13B are diagrams of top views of four example integrated photonic subcircuits, in which each subcircuit is configured to transfer light to an adjacent subcircuit.

FIGS. 14A-14B are diagrams of top views of example assemblies including four subcircuits each.

FIGS. 15A-15B are diagrams of top views of examples photonic monitoring circuits for photonic integrated subcircuits.

FIG. 16A is a diagram of a top view of an example 1D integrated photonics assembly including three subcircuits, in which each subcircuit has at least one monitoring circuit and a useful circuit.

FIG. 16B is a diagram of a top view of a simplified representation of FIG. 16A to illustrate an example of wavelength dependence of the interfaces between the subcircuits.

FIG. 17 is a diagram of a top view of an example 1D integrated photonics assembly including four subcircuits.

FIG. 18 is a diagram of a top view of an example embodiment of a subcircuit.

FIG. 19 is a diagram of a top view of an example receptacle configured to be complementary to the subcircuit of FIG. 18 and configured to align two subcircuits of FIG. 18.

FIG. 20 is a diagram of a top view of multiple subcircuits of FIG. 18A positioned on the receptacle of FIG. 19.

FIG. 21 is a diagram of a top view of an example subcircuit including photonic circuit and input and output waveguides.

FIG. 22 is a diagram of a top view of an example connector chip that may be used in assembling two subcircuits.

FIG. 23 is a diagram of a top view of an example assembly of subcircuits.

FIGS. 24A-24D are diagrams of top views of example variations of subcircuits.

FIG. 25A is a diagram of a top view of an example receptacle configured to receive subcircuits of FIGS. 24A-24D.

FIG. 25B is a diagram of a top view of the receptacle of FIG. 25A connected to four subcircuits of FIG. 24A.

FIG. 26A is a diagram of a top view of an example receptacle configured to receive subcircuit of FIG. 24A. FIG. 26B is a diagram of a top view of an example receptacle connection to four subcircuits of FIG. 24A.

FIG. 27 is a diagram of a cross-sectional view of an example subcircuit.

FIG. 28 is a diagram of a cross-sectional view of the subcircuit of FIG. 27 in combination with the receptacle.

FIG. 29 is a diagram of a cross-sectional view of an example receptacle.

FIG. 30 is a diagram of a top view of example subcircuits aligned to an example receptacle.

FIGS. 31A-31D are diagrams of cross-sectional views of example fabrication steps for fabricating a receptacle wafer. FIG. 31E is a diagram of a top view of FIG. 31D.

FIGS. 32A-32E are diagrams of cross-sectional views of an example alternative method to fabricate a receptacle.

FIGS. 33A-33C are diagrams of cross-sectional views of an example method to fabricate the receptacle directly on a silicon wafer.

FIG. 34 is a diagram of a perspective view of an example 3D drawing of a subcircuit having shallow-etched vertical alignment features and deep-etched lateral alignment features.

FIG. 35 is a diagram of a top view of an example receptacle wafer including example assemblies of subcircuits.

FIG. 36 is a diagram of a cross-sectional view of portions of a receptacle and portions of subcircuits for illustrating a method for elastic averaging.

FIG. 37 is a flowchart of an example method for aligning two or more subcircuits to a receptacle.

FIG. 38 is a X-Z axis cross-sectional view of an example subcircuit-interposer-subcircuit coupling.

FIG. 39 is a X-Y axis cross-sectional view of the subcircuit-interposer-subcircuit in FIG. 39.

FIG. 40A-40B are exemplary data for an ideal and non-ideal waveguide alignment configuration.

FIG. 41 is an exemplary diagram for misaligned and/or offset waveguides.

FIG. 42 is a X-Z axis cross-sectional view of an example subcircuit-interposer-subcircuit coupling having an intermediate waveguide.

FIG. 43 is a X-Y axis cross-sectional view of the subcircuit-interposer-subcircuit of FIG. 42.

FIG. 44 is a X-Z axis cross-sectional view of an example subcircuit-interposer-subcircuit coupling having passive mechanical coupling.

FIG. 45 is a X-Z axis cross-sectional view of an example subcircuit-interposer-subcircuit coupling having passive mechanical coupling.

FIG. 46A is a representation of an example first cartridge and an example second cartridge to be coupled together via a subcircuit coupling structure.

FIG. 46B is a representation of an example first cartridge coupled with a ferrule.

FIG. 46C is a representation of an example first cartridge prior to installation of one or more alignment features.

FIG. 47A is a representation of an example first cartridge and an example second cartridge to be coupled together using alignment features.

FIG. 47B is a representation of an exemplary photonic integrated subcircuit including trench features configured to enable coupling with corresponding extruded features of a cartridge.

FIG. 47C is a cross-sectional view of the photonic integrated subcircuit of FIG. 47B coupled to a cartridge via trench features of the photonic integrated subcircuit and extruded features of the cartridge.

FIG. 47D is a cross-sectional view of an example cartridge including a mechanical alignment feature configured for aligning an optical alignment structure.

FIG. 47E is a top view of the cartridge from FIG. 47D.

FIG. 47F is a zoomed-in view of the mechanical alignment feature shown in FIG. 47D.

FIG. 47G is a cross-sectional view of an example cartridge including another mechanical alignment feature.

FIG. 47H is a top view of the cartridge from FIG. 47G.

FIG. 47I is a zoomed-in view of the mechanical alignment feature shown in FIG. 47G.

FIG. 47J is a cross-sectional view of an example first cartridge and an example second cartridge including another mechanical alignment feature.

FIG. 47K is a top view of the cartridge from FIG. 47J.

FIG. 47L is a perspective view of the first and second cartridges of FIG. 47J to be coupled with a ferrule.

FIG. 48A is a representation of an example wafer scale configuration for photonic integrated subcircuits prior to singulation and/or dicing.

FIG. 48B is a view showing separate portions of the wafer scale configuration of FIG. 48A.

FIG. 48C is a cross-sectional view of an example of two cartridges coupled together subsequent to singulation and/or dicing.

FIG. 48D is a top view of the cartridge from FIG. 48C.

FIG. 48E is a perspective view of the first and second cartridges of FIG. 48D.

FIG. 49A is a top view of an example cartridge optically aligned to a photonic integrated subcircuit.

FIG. 49B is a cross-sectional view of the cartridge of FIG. 49A optically aligned to the photonic integrated subcircuit.

FIG. 49C is a perspective view of the cartridge of FIG. 49A optically aligned to the photonic integrated subcircuit.

FIG. 49D is a perspective view of the cartridge of FIGS. 49A-49C coupled to a ferrule.

FIG. 49E is a perspective view of the ferrule of FIG. 49D.

FIG. 49F is a perspective view of the cartridge of FIGS. 49A-49C without a photonic integrated subcircuit coupled to the ferrule.

FIG. 49G is a zoomed-in view of the cartridge of FIGS. 49A-49C coupled to the ferrule and a positioning stage.

FIG. 49H is a perspective view of an example cartridge coupled to an example photonic integrated subcircuit.

FIG. 50A is a perspective view of an example first cartridge and an example second cartridge to be coupled together using alignment features having a light path.

FIG. 50B is a perspective view of an example cartridge including subcircuit mechanical alignment features.

FIG. 50C is a perspective view of an example male and female cartridge configuration.

FIG. 50D is a perspective view of the female cartridge configuration of FIG. 50C.

FIG. 50E is a perspective view of the male cartridge configuration of FIG. 50C.

FIG. 51A is a perspective view of an example system for coupling photonic integrated subcircuits including a microfluidic channel.

FIG. 51B is a zoomed-in cross-sectional view of the first and second cartridges of FIG. 51A.

FIG. 51C is a plan view of the example system of FIG. 51A for coupling photonic integrated subcircuits including a microfluidic channel.

FIG. 52A is a perspective view of an example first cartridge including top alignment features.

FIG. 52B is a perspective view of an example second cartridge including bottom alignment features.

FIG. 52C is a perspective view of the first and second cartridges of FIGS. 52A and 52B coupled together.

FIG. 53A is a top view of an example first cartridge and an example first photonic integrated subcircuit.

FIG. 53B is a bottom view of the first cartridge and second photonic integrated subcircuit of FIG. 53A.

FIG. 53C is a perspective view of the first cartridge of FIGS. 53A and 53B.

FIG. 54 is a flowchart of an example method for coupling photonic integrated subcircuits.

### DETAILED DESCRIPTION

Disclosed herein are embodiments of photonic integrated subcircuits that can be assembled into an integrated photonics assembly. These photonic integrated subcircuits may be referred to herein as “subcircuits”, “chiplets”, or “sub-chips”. The integrated photonics assembly may be referred to herein as “an assembly”, “an integrated photonics assembly”, or “a photonic integrated circuit” (PIC). A given photonic integrated subcircuit can be configured to transfer light to and/or receive light from at least one other subcircuit, for example, using one or more light transfer techniques. In various embodiments, each photonic integrated subcircuit is a discrete integrated circuit or chip that be physically separated from one another, moved, and/or attached to one another. The example subcircuits can be assembled to create a larger integrated photonics circuit using two or more subcircuits. The example subcircuits may be used to extend and/or combine an integrated photonic circuit into a larger integrated photonic circuit. The example subcircuits are configured to guide light via waveguide structures and may contain special functions including, e.g., splitting light, wavelength demultiplexing, photo detection, light generation, light amplification, etc.

### Standardization of Photonic Integrated Subcircuits

In various embodiments, each subcircuit is a pre-fabricated integrated circuit. By pre-fabricating the subcircuits, the subcircuits can be standardized so as to enable assembly of two or more subcircuits into a PIC. As discussed further herein, standardization of subcircuits can pertain to one or more properties of the subcircuits, including dimension(s), volume, weight, input(s), output(s), functionality, mechanical feature(s) (e.g., for coupling, alignment, etc.), active alignment feature(s), wirebond pad(s), electrical connection(s), feature(s) that are complementary to a receptacle (including vertical alignment feature(s) and/or lateral alignment features), etc. Standardization can include the configuration of complementary properties or structures of two or more adjacent subcircuits, as described further below. For instance, alignment structures and/or waveguide paths in a first type of subcircuit may be configured to be complementary with respective alignment structures and/or waveguide paths in a second type of subcircuit, such that a subcircuit of a first type can be attached to a subcircuit of a second type, e.g., with low optical loss. Standardization of the subcircuits can enable permutational assembly of the subcircuits into PICs. Further, standardization can enable time-efficient and/or cost-efficient packaging.

Because many different types of integrated photonics assembly can be created from the subcircuits, it is beneficial to standardize the subcircuits. One benefit of standardization is that a subcircuit can be switched or interchanged with another subcircuit, thereby creating a different optical assembly that is a variation of the first assembly. In some cases, subcircuits can be configured such that they enable many optical assemblies that are useful with a minimum number of subcircuits. Further, each subcircuit or type of subcircuit can be configured and/or selected for improved performance, reduced cost, efficient or ease of fabrication, efficient or ease of supply, etc.

Note that there is a nonzero likelihood that certain aspects and/or components (e.g., transistors) of an integrated circuit may fail or render the individual fabricated circuit defective. The resulting integrated circuits of a particular fabricated batch that function correctly is the “yield” of that particular batch. By fabricating (and subsequently testing) the integrated photonics subcircuits individually and/or independently, the non-functioning subcircuits can be eliminated from the supply of subcircuits. Further, it is found that a higher number of functioning subcircuits (of a given type) can be produced using a single type of fabrication process (e.g., on a given wafer). In comparison, a mixed-type integrated circuit (e.g., using more than one type of fabrication process) results in lower yield of that mixed-type integrated circuit. This results in a higher number of fully-functioning integrated subcircuits, thereby contributing to an increased number of integrated photonics assemblies. Therefore, in some cases, it may be preferable to generate an integrated optical circuit from subcircuits even if all the component subcircuits can be fabricated in the same process. This can increase the number of optical assemblies that can be built. Furthermore, the subcircuits can be yielded before they are used in the optical assembly, thereby increasing the total yield of a certain optical assembly. The optical assembly can thus be yield-optimized by forming the assembly from different sub-chips.

In some embodiments, yields are significantly improved in an integrated photonics assembly as compared to a monolithic chip. In some embodiments, cost is significantly reduced in an integrated photonics assembly as compared to a monolithic chip. As illustrated below, improvements in yield and/or cost may depend on the type of internal component or functionality. The following tables provide two numerical examples comparing the yields of traditional “monolithic” integrated photonic circuits to the yields of the modular integrated photonics assemblies, as described herein. In particular, the left side of Table 1 illustrates a monolithic chip that is fabricated with two wavelength demultiplexers (WDMs) in which each individual WDM typically has a 50% yield. Further, the right side of Table 1 illustrates a modular assembly including two 50%-yield WDMs. As illustrated, even with the cost of assembly, the total cost of the assembly is significantly less (e.g., at least 55% less) than the total cost of a monolithic chip.

TABLE 1
Yield comparison between a monolithic chip and
a modular assembly having two 50%-yield WDMs.

| Monolithic Chip having two 50%-yield WDMs | | Modular Assembly having two 50%-yield WDMs | |
|---|---|---|---|
| Cost | $10 | Cost | $10 |
| Yield | 25% | Yield | 50% |
| True Cost | $40 | True Cost | $20 |

| | |
|---|---|
| Total Cost = True | $22 |
| Cost + Assembly Cost | |

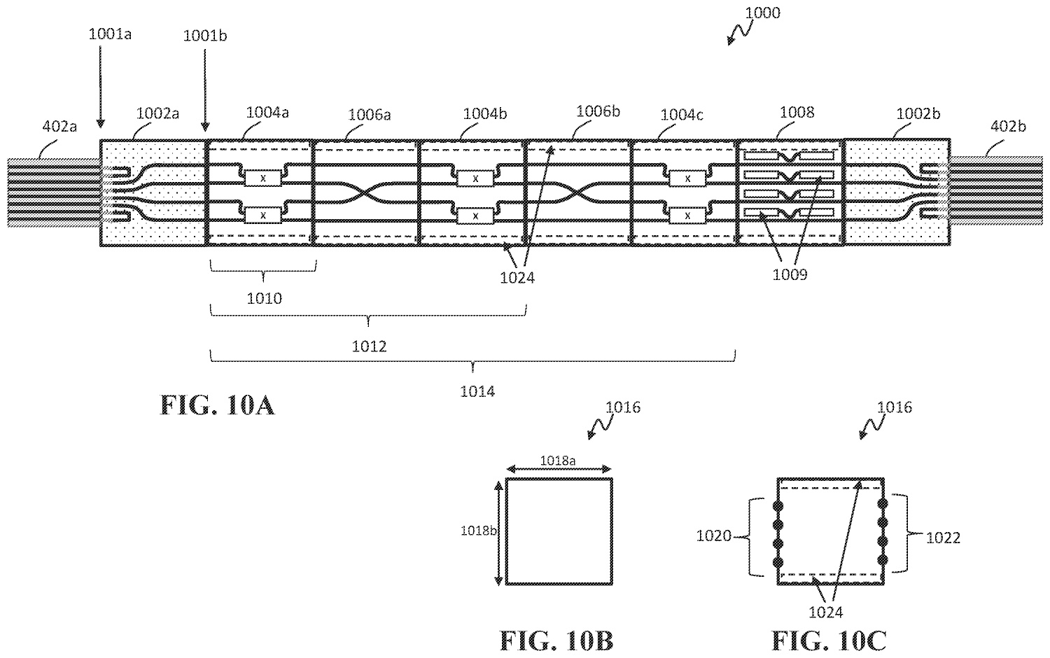

Another illustration of the yield difference and cost is provided in Table 2 below. Both yield and cost are dramatically improved for the modular assembly over the monolithic chip. Refer to FIG. 10A for an example of an integrated photonics assembly 1000 including a subcircuit 1008 having Ge photodetectors (PDs).

TABLE 2
Yield comparison between a monolithic chip and
a modular assembly having two 90%-yield PDs.

| Monolithic Chip having 100 98%-yield Ge PDs | | Modular Assembly having 100 98%-yield Ge PDs | |
|---|---|---|---|
| Cost | $20 | Cost | $20 |
| Yield | 13% | Yield | 81.7% |
| True Cost | $154 | True Cost | $25 |
| | | Total Cost = True | $27 |
| | | Cost + Assembly Cost | |

In some embodiments, subcircuits are standardized in size. For example, a standardized set of subcircuits may include subcircuits that are each 1 mm in width and 1 mm in length. In some cases, the standardized set may include two or more subsets of subcircuits in which the size of subcircuits in each subset is standardized. For example, a first subset may have subcircuits of 1 mm×1 mm, a second subset of subcircuits of 1 mm×2 mm, a third subset of subcircuits of 2 mm×2 mm, a fourth subset of subcircuits 1 mm×3 mm, etc.

In some embodiments, the subcircuits are standardized according to the light port positioning and/or electrical pad positioning. For instance, the position of light input ports and/or output ports along the edges or surface of the subcircuits may be standardized for groups of subcircuits. By leveraging standardization, a library of standard subcircuits can be produced to build nearly an endless variety of photonic assemblies without the need for costly or time-consuming customization of the package or assembly process.

In some embodiments, the standardization of subcircuits contributes to and/or directly beget the standardization of other components, e.g., printed circuit boards (PCBs), non-optical components, lasers, etc. For example, by standardizing the electrical pads in a subcircuit, connecting pads on a host PCB can also be standardized, thereby contributing greater efficiency.

### Modularity of Photonic Integrated Subcircuits

Importantly, each subcircuit is configured to be a modular component of an integrated photonics assembly. The modular character of the subcircuits is one benefit of the standardization of the subcircuits. For instance, two or more subcircuits, e.g., subcircuits S₁ and S₂, can be assembled into assembly A with functionality F_{A}. One or more of these subcircuits (e.g., subcircuit S₂) can be removed from assembly A and connected to another subcircuit (e.g., subcircuit S₃) and/or an assembly to form assembly B, in which assembly B has a functionality F_{B} (which may be different from functionality F_{A}). In doing so, the modular character of the subcircuits enable many useful integrated optical assemblies.

Various benefits flow from the modularity of the photonic integrated subcircuits. In particular, the modularity of the subcircuits facilitate the scaling (e.g., scaling up or down) of integrated photonics assemblies, replacement of subcircuits of an assembly, improvements to existing PICs, reconfigurability of assemblies, etc. Importantly, the described systems and methods can produce the desired subcircuits and/or customized integrated photonics assemblies faster than the fabrication of a conventional PIC. For example, a customized integrated photonics assembly may be produced within seven (7) days as compared to the one (1) year required for the conventional PIC. Accordingly, the described systems and methods enable efficiencies in time and/or cost.

Further, the modular subcircuits can reduce waste. For example, as described below, the described systems and methods permit the reuse of existing subcircuits and/or reconfiguring of existing assemblies. In another example, the described techniques enable the fabrication of subcircuits on demand (and therefore a reduction of inventory).

In some embodiments, in a given assembly, a particular subcircuit S is discovered to be faulty (e.g., inefficient, inoperable, incompatible, etc.). That particular subcircuit S may be removed from the assembly and a replacement subcircuit S′ may be installed in its place. In another example, the particular subcircuit S may need to reconfigured and/or translated to another portion of the assembly to be operable. This has the advantage of avoiding disturbing the rest of the assembly while providing a quick and/or simple solution to replacing a faulty part of the assembly. By contrast, a conventional PIC—which requires a single indivisible “chip”—may not be repairable by swapping out or reconfiguring of a fault component.

In another embodiment, the modularity of the subcircuits facilitate the evolution of engineering and/or design of integrated photonics assemblies over time. The development of an assembly A having a particular functionality may change from a first generation (e.g., assembly A₁) configuration to a second generation (assembly A₂), third generation (assembly A₃), and so on to accommodate needs of customers and/or adapt to changing markets, new technologies, different materials, different standards, a change in specifications, evolving regulation, etc. This may be achieved by adding, replacing, moving, reconfiguring, etc. one or more subcircuits in the assembly (e.g., assembly A₁) to produce another assembly (e.g., assembly A₂). For example, at some time after the production of the first generation assembly A₁, a new subcircuit may become available. This new subcircuit may be added to or replace an existing subcircuit in the first generation assembly A₁, to form the second generation assembly A₂.

In another embodiment, an existing assembly A may be repurposed or adapted with a different functionality by changing one or more subcircuits included in the assembly A. In another example, a conventional PIC may be repurposed or reconfigured with a different functionality by adding one or more subcircuits to the PIC. In such a case, an adapter-type subcircuit may be coupled to the conventional PIC and one or more subcircuits may be coupled to the adapter-type subcircuit. In another embodiment, two or more assemblies may be coupled together by one or more subcircuits, e.g., forming a light path between the two or more assemblies.

One primary characteristic of an integrated photonics chip (or subchip) is its ability to guide light. In various embodiments, the subcircuits can be fabricated from one or more electro-optic crystals, polymers, and/or semiconductor materials. For example, this can be achieved in a CMOS-compatible sub-chip or so-called silicon photonics, silicon-on-silica, silicon nitride, aluminum oxide, glass, III/V based integrated photonics chips, lithium niobate, silicon-on-insulator, gallium arsenide (GaAs), indium phosphide (InP), nitride, glass, etc. In some embodiments, the subcircuit is a combination of subcircuits. For example, a silicon photonics subcircuit can be enhanced with a III/V chip to increase its functionality (e.g., optical detection and optical gain), thereby creating a subcircuit that includes two or more chips or subchips.

The example integrated photonics assemblies may be configured for one or more functionalities. The assemblies may be configured for communication, biomedical, chemical, research, computing, or other applications. A non-limiting list of applications include beamforming, beam-steering, LiDAR, biomedical instrumentation (OCT, spectrometers, diagnostics, etc.), biophotonics (blood analysis, brain control, etc.), acousto-optics, astrophotonics, gyroscopes, metrology, optical clocks, magneto-optics (integrated magneto-optical devices, isolators, memory, switches, etc.), artificial intelligence, reconfigurable photonic processors, THz photonics, microwave photonics, fiber sensor interrogators, free-space optical communication (Li-Fi, satellite Internet, etc.), augmented reality, quantum optics (QKD, QRNG, etc.), etc.

### Light Transfer Techniques

Light may be transferred and/or received between two or more subcircuits using one or more light transfer methods, as described in further detail below. Each subcircuit can transfer light to at least one other subcircuit. In some cases, electrical signals, microwave signals, and/or fluids may be transferred and/or received by the subcircuits. In various embodiments, the wavelength of the light can span from 100 nm to 20 microns. Light can be transferred and/or received over one or more channels. In some embodiments, a given channel transmits light in one or more wavelengths, one or more polarizations, and/or one or more modes.

In various embodiments, a subcircuit can be as close as zero (0) micron distance edge-to edge with another subcircuit. This can be true when two or more subcircuits are stacked horizontally, stacked vertically, or configured to be partially overlapping (e.g., negative distance edge to edge). In various embodiments, the maximum distance between light-transferring subcircuits can be as large as 10 cm. In some embodiments, the distance is between is 0 um and 2 mm.

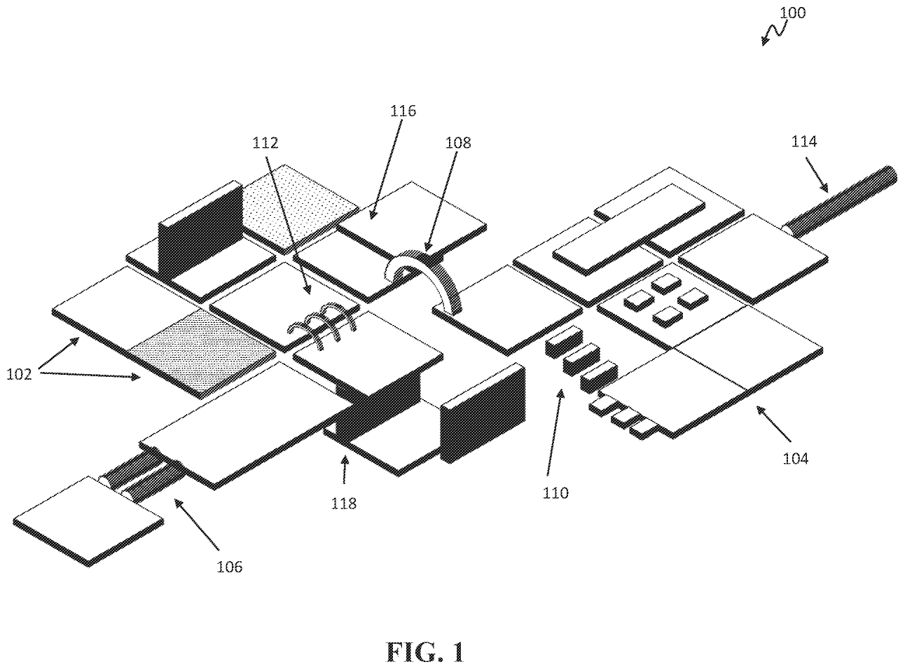

In various embodiments, an integrated photonics assembly can include two or more photonic integrated subcircuits. FIG. 1 illustrates an example integrated photonics assembly 100 that includes multiple subcircuits 102. As depicted, the subcircuits 102 can be coupled to one another by one or more techniques. For example, light can be transferring between two or more subcircuits via butt-coupling 104, optical fiber(s) 106, photonic wirebond(s) 108, a free-space optical train 110, electrical wirebonds 112, adiabatic coupling, out-of-plane coupling, etc. In various embodiments, the integrated photonics assembly 100 can be optically connected to an external system (e.g., a subcircuit, another assembly, a conventional PIC, an electrical system, a computing system, a biomedical system, etc.) by an optical fiber 114. In various embodiments, a channel between two subcircuits can transfer light of one or more polarizations, one or more modes, and/or one or more wavelengths.

The example subcircuits may be arranged in various configurations, e.g., side by side, overlapping, etc. For example, one or more subcircuits can be connected on top of, under, or to the side of a host subcircuit. In some embodiments, a host-type subcircuit is larger in at least one dimension than at least one other type of subcircuit so as to provide sufficient space to “carry” a number of subcircuits. In some embodiments, a host-type subcircuits is smaller in at least one dimension than at least one other type of subcircuit so as to act as a “bridge” between two or more subcircuits. Note that, in the drawings, some subcircuits are distinguished by different patterned or colored surfaces to indicate different types or functionalities.

Light transfer can be accomplished by any one or more of the following techniques. In some embodiments, light is transferred by edge-to-edge coupling (also referred to as butt-coupling) between two or more subcircuits (refer to arrow 104). In this technique, light abruptly exits the subcircuit (e.g. via the end of a light path, waveguide, from an output port, etc.) from one side or edge of the subcircuit into air or any other bulk medium. Light can enter abruptly into the side or edge (e.g., via the beginning of a light path, waveguide, into an input port, etc.) of another subcircuit.

In some embodiments, light is adiabatically transferred between subcircuits by a taper system or method. In this technique, two subcircuits are configured to overlap at least partially (refer to arrow 116). In at least one of the subcircuits, the geometry of a waveguide can be configured such that light can be transferred adiabatically or near-adiabatically to another subcircuit.

In some embodiments, light is transferred between subcircuits via an optical guiding medium. Such optical guiding mediums can include an optical fiber 106, a polymer waveguide, a polymer fiber, etc. The light may be guided in the region or space between the subcircuits and may therefore bridge a larger distance with lower optical loss (as compared two subcircuits without the optical guiding medium). In some embodiments, light is transferred in free-space or in a medium via a crossing lens, a collimator, etc.

In some embodiments, light is configured to exit a subcircuit non-horizontally (e.g., near-vertically or vertically) and enter non-horizontally into another subcircuit. In one example, integrated mirrors or grating couplers can be used to accomplish this type of light transfer. In some embodiments, light exits one subcircuit non-horizontally and enter another subcircuit horizontally. In one example, this is achieved by a subcircuit standing vertically on the surface of another sub-chip (illustrated by arrow 118).

The transfer of light between two or more subcircuits can involve any one or combination of the above-described light transfer methods. In some cases, light transfer can two or more methods (or combinations of methods) for two or more respective channels. Using two or more methods of transferring light can be particularly useful in some cases. In one scenario, butt-coupling of subcircuits may be preferred but a particular routing or direction of the light transfer path may be difficult or may require customization. Such a routing can be achieved by using a flexible connection, e.g., a polymer waveguide or a photonic wirebond. In some instances, some subchips may not be identically sized or shaped due to imperfect dicing or cleaving. Therefore, gaps between such subchips can be spanned using a flexible interconnection method.

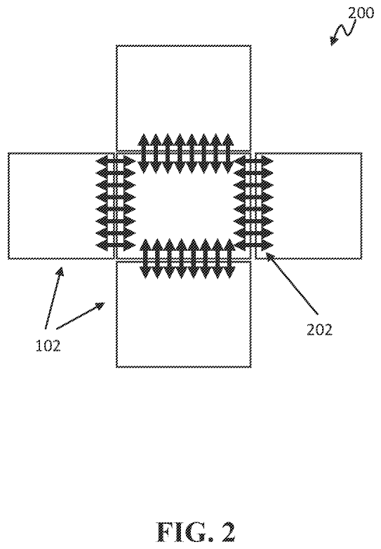

In some embodiments, transfer of light between subcircuits is multi-channel. One benefit of subcircuits that are closely spaced is that many light transfers can happen between the two subcircuits at the same time. As an example, a single subcircuits can transfer light to 10 or more other subcircuits with 100 light channels between each sub-chip. Other free-space components may be added in between the subcircuits and in between the optical path(s). FIG. 2 illustrates light transfer between subcircuits of assembly 200. The assembly 200 includes five (5) subcircuits 102, among which light is transferred and/or received. In the illustrated example, the subcircuits are butt-coupled, thereby making a large number of light transfer paths 202 feasible.

In some embodiments, some chips do not transmit light to a subcircuit and therefore be referred to as “non-photonic subcircuits” or “non-photonic subchips”. For instance, such non-photonic subchips may only transmit and/or receive electrical signals from a photonic assembly of subcircuits. Accordingly, these may not be considered a part of the integrated photonics assembly. However, in some embodiments, these non-photonic subchips are part of a standardized package around the integrated photonics assembly.

In various embodiments, light can be transmitted from the integrated photonics assembly to an external or remote device or system. In some cases, this light may eventually reach other optical chips, though these other chips may not be considered part of the optical assembly. Subcircuits may have light paths to an external system by, for example, a fiber, fiber array or free-space connection. There is no lower bound or upper bound on the number of subcircuits that need to be connected from the assembly to outside world (e.g., an external system or device) and no limitation on which method is used.

### Integrated Photonics Assemblies

As described above, subcircuits can be combined in many different assemblies and configurations. Subcircuits may be combined in a one-dimensional, two-dimensional, or three-dimensional assembly using any one or more of the techniques described herein.

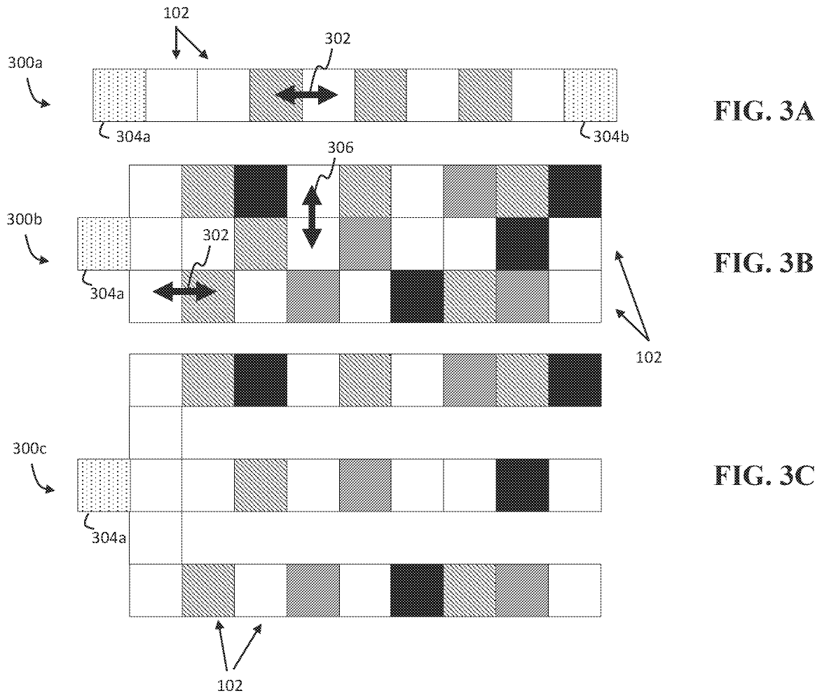

FIGS. 3A-3C provide examples of integrated photonics assemblies, which each include multiple subcircuits 102. In particular, FIGS. 3A-3C illustrate the modularity properties of the subcircuits, including how the subcircuits can be arranged (e.g., coupled, connected, stacked, etc.) and how the photonics assembly can be standardized. Note that, in these examples, the subcircuits are configured to be the same size (in at least two dimensions) and shape.

FIG. 3A illustrates a one-dimensional (1D) array 300a (also referred to as 1D-stacking). In this case, light can be transferred left or right (indicated by arrow 302 and may be referred to as west or east) between at least a subset of the subcircuits 102. The array 300a may begin with a subcircuit 304a and/or end with a subcircuit 304b. In some cases, subcircuits 304a and/or 304b may be able to transfer light to one other subcircuit and/or from one edge of the subcircuit. To enable efficient light transfer between two or more subcircuits 102, the position of the light path within the subcircuits can be standardized to increase assembly permutations, as discussed in more detail herein.

FIG. 3B illustrates an example two-dimensional (2D) array 300b of subcircuits, which includes subcircuits configured with light transfer paths oriented up and down (indicated by arrow 306 and referred to as north and south). FIG. 3C illustrates an example “pseudo” 2D array 300c, which can be considered an extension of the 1D array. The example array 300c enables multiple parallel circuits to be connected together without requiring north and south light transfer capability on most subcircuits.

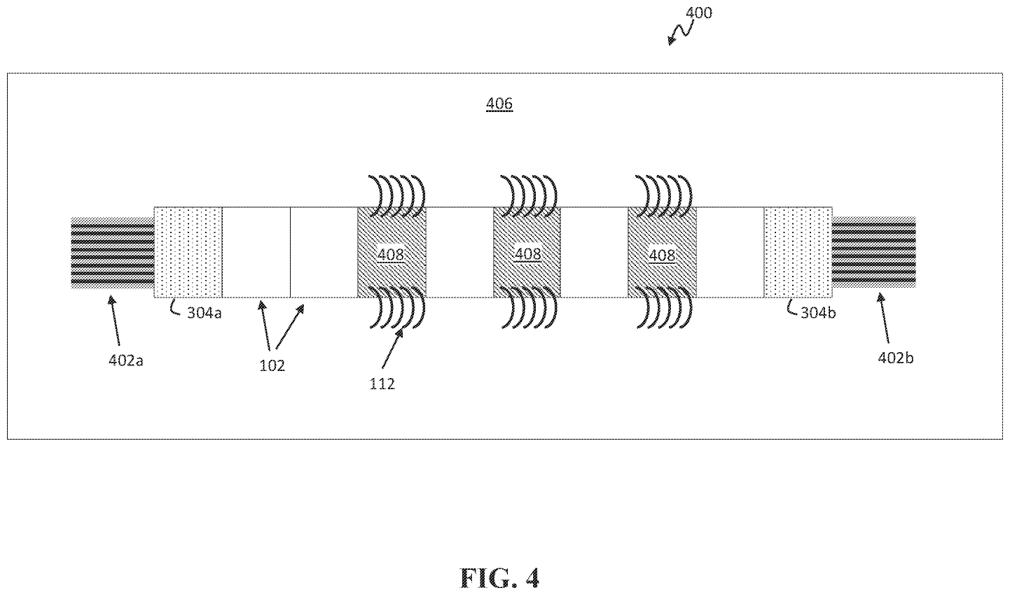

FIG. 4 illustrates an example of a packaged 1D integrated photonics assembly 400. The assembly 400 includes multiple subcircuits 102, a first fiber array 402a connected to the first subcircuit 304a, and a second fiber array 402b connected to the last subcircuit 304b. Note that a subset of the subcircuits are wirebonded via electrical conductors 112 to the printed circuit board (PCB) 406. Wirebonds 112 can be created during the fabrication and/or assembly process. The electrical wirebonds 112 may be standardized such that they can be connected to a particular type of subcircuit 408. Such subcircuits 408 may be configured to handle both light and electrical current.

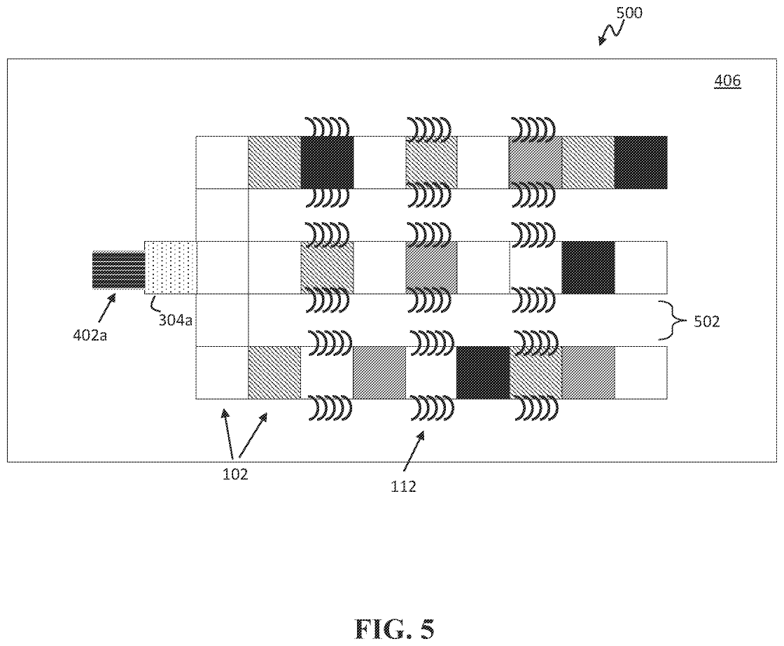

FIG. 5 shows an example of a packaged pseudo-2D integrated photonics assembly 500. A fiber array 402a is connected to the first subcircuit 304a. In this example, because there are empty spaces 502 between parallel rows of subcircuits, the subcircuits are accessibly wirebonded via wirebonds 404 to the PCB 406. Note that the empty spaces 502 can contribute to the standardization of the host PCB by providing space for electrical pads on the PCB via the empty spaces 502.

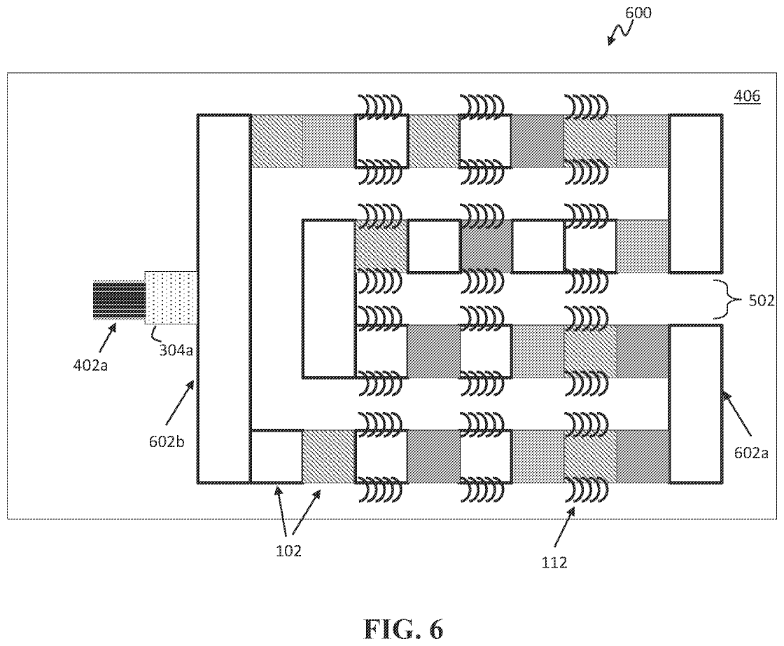

FIG. 6 shows an example of a packaged integrated photonics assembly 600 which is formed in the shape of a closed-loop “snake”. In other words, subcircuits can be connected to one another to form a snake shape. This type of assembly 600 may utilize at least two types of subcircuits, including some subcircuits 102 that connect left or right and some larger subcircuits 602a, 602b (collectively referred to as 602) that are larger than subcircuits 102. If the area of subcircuit 102 is taken as a single unit of measurement, larger subcircuits 602 may have an area equal to two units, three units (e.g., subcircuit 602a), four units, five units, six units, seven units (e.g., subcircuit 602b), and so on. In some embodiments, the larger subcircuits 602 have one or more dimensions that are 1.1 times, 1.2 times, 1.3 times, etc. the corresponding dimension of subcircuit 102. This type of assembly 600 can be beneficial when numerous subcircuits need to be cascaded, the footprint needs to be reduced, and/or occasional connections (e.g., via photonic wirebonds) need to be made. For example, cascading the subcircuits may be advantageous in some implementations and can include connecting one subcircuit to another in loops (instead of one long linear assembly) to reduce the overall footprint of the integrated photonics assembly. The empty spaces 502 between subcircuits 102 allow for ease of electrical wirebonding 112 to the underlying PCB 406.

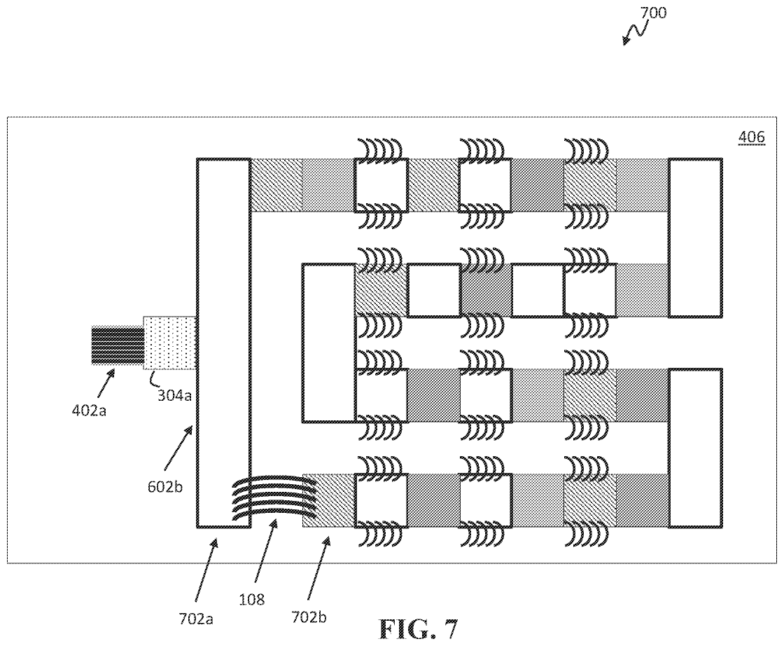

FIG. 7 shows an example of a packaged integrated photonics assembly 700 which is formed in the shape of an open-loop “snake”. This type of assembly 700 can be useful when subcircuits vary slightly in size, leading to a mismatch in size in at least one portion of the assembly 700. This can occur, for example, when the subcircuits are diced during fabrication. Accordingly, a subcircuit connection (e.g., the last connection) can be performed using one or more photonic wirebonds 108 to connect the light paths between subcircuit 702a and subcircuit 702b. This can be used instead of coupling techniques, e.g., butt-coupling.

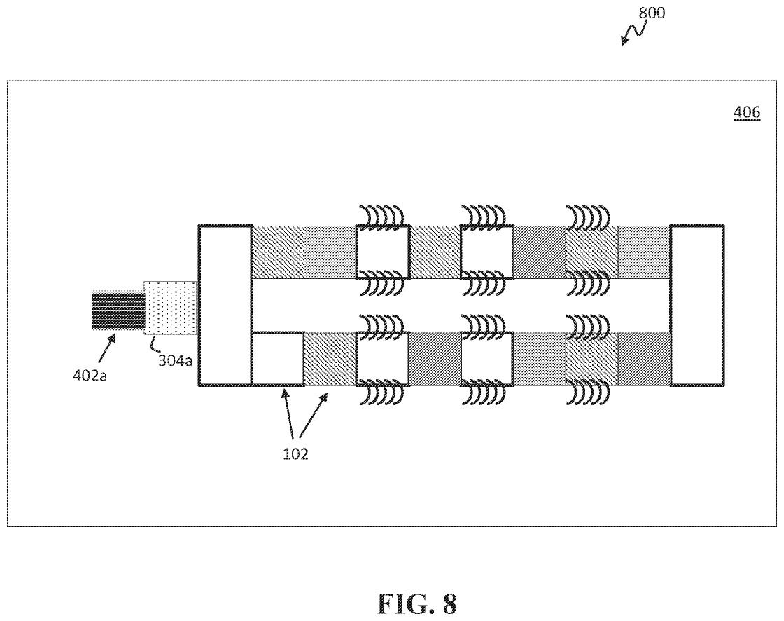

FIG. 8 shows an example of a packaged assembly 800, illustrating that the subcircuits can be standardized. In other words, the subcircuits 102 can be cut to a standard size (within a particular tolerance) such that they can form a closed loop when butt-coupled. For example, during dicing of the subcircuits during fabrication, a given dimension (e.g., width, length, height, etc.) of the subcircuits may vary +/−10 microns. In some embodiments, the resulting variation depends on the particular fabrication process or type of subcircuit produced.

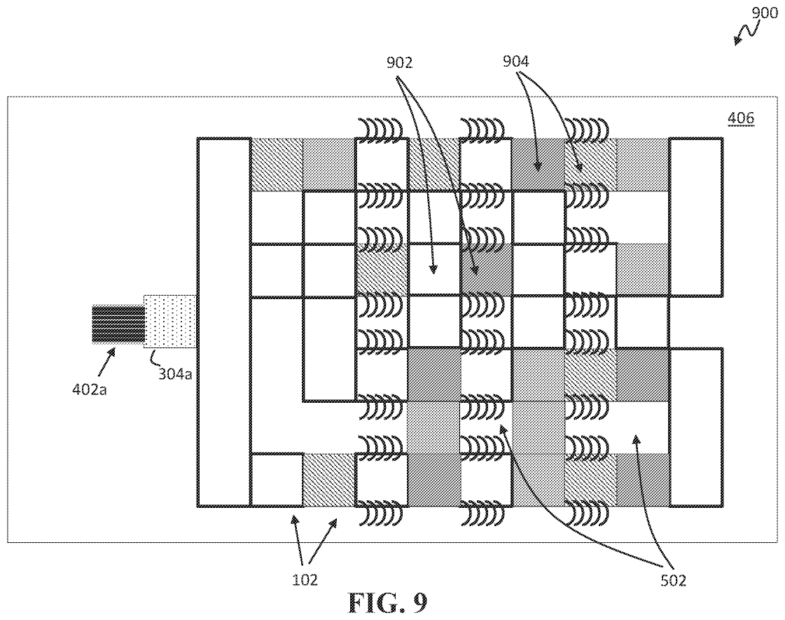

FIG. 9 shows an example of an integrated photonics assembly 900 that is formed into a “checker” type assembly. The checker-type assembly includes empty spaces or gaps 502 between subcircuits 102. These gaps 502 can permit the wirebonding of some or all subcircuits 102 to the host PCB 406 without needing to route electrical signals from the subcircuits (e.g., subcircuit 902) near the center of the assembly 900 to the outer subcircuits (e.g., subcircuits 904) and/or to external circuits.

### Light Transfer in Photonic Integrated Subcircuits

FIG. 10A depicts an example implementation of a 1D integrated photonics assembly 1000. Referring to the subcircuits from left to right, the example assembly 1000 includes:

(i) a subcircuit 1002a including a fiber spot-size convertors;

(ii) a subcircuit 1004a including tunable splitters;

(iii) a subcircuit 1006a including a waveguide crossing;

(iv) a subcircuit 1004b including tunable splitters;

(v) a subcircuit 1006b including a waveguide crossing;

(vi) a subcircuit 1004c including tunable splitters; and

(vii) a subcircuit 1008 including tap couplers and photodetectors 1009 configured to monitor the transmitted light. Subcircuit 1002a can be made from silicon nitride. Subcircuits 1002a, 1002b having fiber spot-size convertors can be made in a different platform which supports higher coupling efficiency to optical fibers. Subcircuit 102a may require a different oxide thickness in the interface 1001a (with fiber array 402a) than the oxide thickness in interface 1001b (with subcircuit 1004a) to efficiently couple light from the fiber array to subcircuit 1004a. Subcircuit 1004a (also referred to as subassembly 1010) can function as a 2×2 optical switch (in this case, including two 2×2 optical switches). Subassembly 1012 of assembly 1000 can function as a 4×4 optical switch. Portion 1014 of assembly 1000 can function as a non-blocking optical switch (e.g., a 4×4 non-blocking optical switch). Subcircuit 1008 can be used enable software control of the optical switch 1014.

Referring to FIGS. 10B-10C, in this example assembly 1000, a subset of the subcircuits is standardized such that these subcircuits (also referred to as standardized subcircuits 1016) have a standard width 1018a (e.g., 1 mm, 1.5 mm, 2 mm, etc.) and a standard length 1018b (e.g., 1 mm, 1.5 mm, 2 mm, etc.). For example, the standardized subcircuits 1016 includes subcircuits 1004a, 1006a, 1004b, 1006b, 1004c, and 1008. The standard subcircuit 1016 has optical and electrical ports are standardized to be in the same respective position for each standardized subcircuit 1016. For instance, in a given standardized subcircuit 1016, input ports 1020 are in the same position along one edge (e.g., the left edge) and output ports 1022 are in the same position along another edge (e.g., the right edge). In some cases, the standardized subcircuit can include electrical ports (e.g., pads) 1024 in the same positions along at least one edge (e.g., top and bottom edges), as indicated by the dashed-line box.

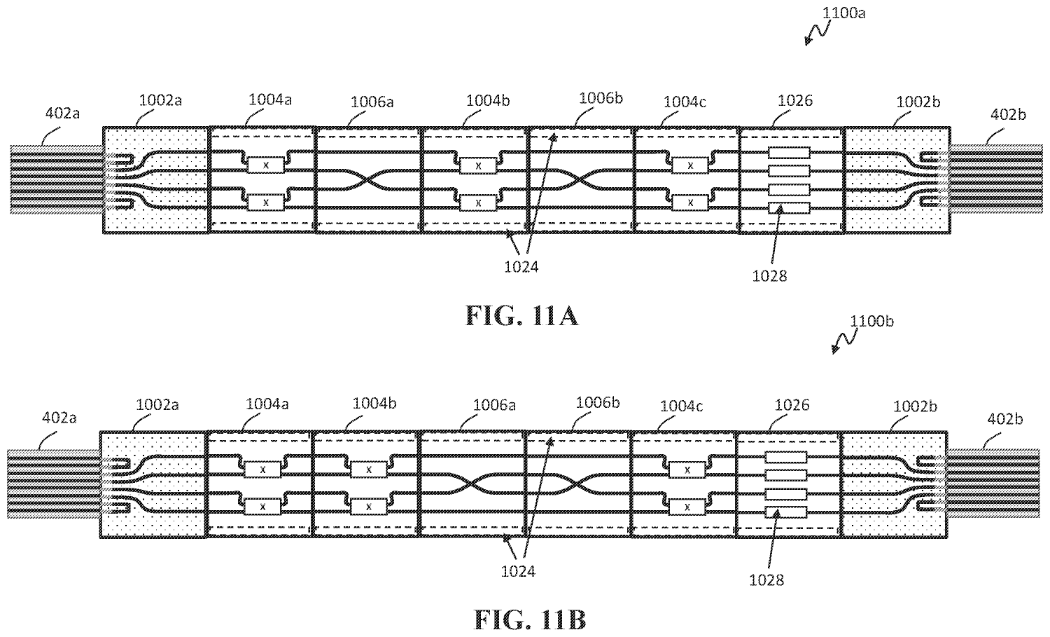

As previously discussed, a subcircuit can be swapped with another subcircuit in a given assembly. Accordingly, FIGS. 11A-11B provide alternative embodiments of the assembly 1000. FIG. 11A illustrates assembly 1100a in which subcircuit 1008 is swapped for subcircuit 1026. In effect, the monitor photodetectors (of subcircuit 1008) are interchanged for variable optical attenuators 1028 (of subcircuit 1026), thereby generating an assembly 1100a with a different functionality from assembly 1000.

In another example, FIG. 11B illustrates assembly 1100b in which subcircuits 1006a is swapped with subcircuit 1004b. This may be done to alter the functionality of the assembly. Alternatively, in example assembly 1100b, crossing-type subcircuit 1006a is swapped for a tunable splitter-type subcircuit and tunable splitter-type subcircuit 1004b is swapped for a crossing-type subcircuit, relative to the assembly 1100a. This may be helpful when subcircuit 1006a or 1004b is needs to be replaced (e.g., because it is faulty).

### Assembly Monitoring

Described herein are systems, devices, and methods monitoring the integrated photonics assemblies. In some implementations, monitoring can include testing the subcircuits and/or using the subcircuits as disposable components in a sensor or other circuit. The monitoring of the assembly may be performed during assembly or post-assembly. The monitoring may be performed one or more times, periodically, intermittently, or continuously.

It can be beneficial to monitor the subcircuits to ensure alignment between two or more subcircuits. The alignment between two or more subcircuits can influence the optical coupling efficiency between the subcircuits. Alignment may be performed using passively and/or actively. In active alignment, a feedback signal may be used to determine whether the subcircuits are aligned. In various embodiments, a monitoring circuit can be configured to be attached to and/or be part of a subcircuit. The monitoring circuit may monitor light that couples into the subcircuit. A light path can be configured such that at least a portion of the received light can travel through the monitoring circuit. The light may then be transmitted back out of subcircuit.

An example monitoring system (e.g., including the monitoring circuit) can include a laser and a photodetector to determine optical loss within a subcircuit and/or among subcircuits. This arrangement may permit measurement of the quality of the optical coupling between the subcircuits. The measurement can be used to determine how well the subcircuits are aligned. In some embodiments, once the subcircuits are aligned and fixed in position (e.g., in an assembly), a monitoring circuit is used to determine the coupling efficiency between the subcircuits at any time.

In various embodiments, two subcircuits can be aligned such that there is less than 1 dB, less than 0.5 dB, less than 0.1 dB, less than 0.5 dB, or less of optical loss in light transfer between the two subcircuits. In various embodiments, two subcircuits can be aligned such that there is greater than 75%, greater than 80%, greater than 85%, greater than 90%, greater than 95%, greater than 97%, greater than 99%, or more coupling efficiency.

Passive alignment techniques can include aligning the subcircuits by visual inspection and/or self-alignment techniques. A monitoring circuit may be used to determine the degree of alignment between subcircuits based on passive alignment.

In some embodiments, the monitoring circuit for each subcircuit is individually configured. The subcircuit may have a wavelength dependence and, based on this wavelength dependence, the monitoring circuit may monitor the response of the respective subcircuit. If, for example, the wavelength dependence of the subcircuit has changed, then the monitoring circuit may isolate the single subcircuit response to align or monitor the subcircuit further. In some embodiments, monitoring circuits include photodetectors to monitor light emitted by the subcircuits through grating couplers. Such a monitoring circuit may benefit from a detection method above the subcircuits, which can be used by a camera configured to detect light from photonic circuits to distinguish between the light emitted from the top of each subcircuit. In some embodiments, the monitoring circuit is configured to access the metal pads of each subcircuit to monitor the response of the respective subcircuit.

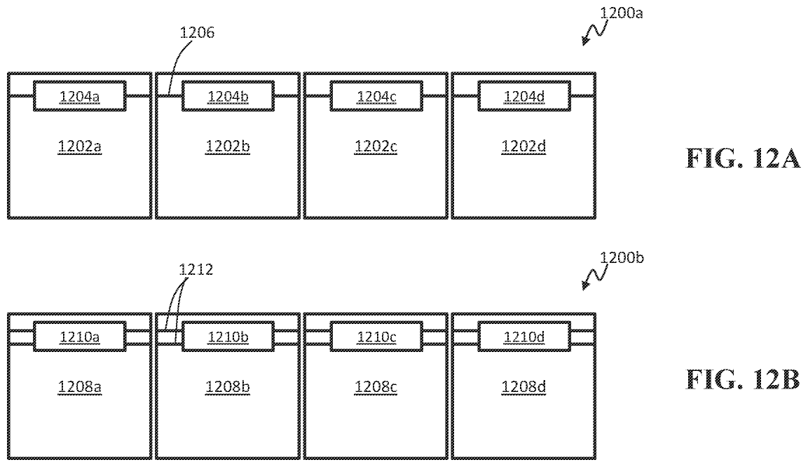

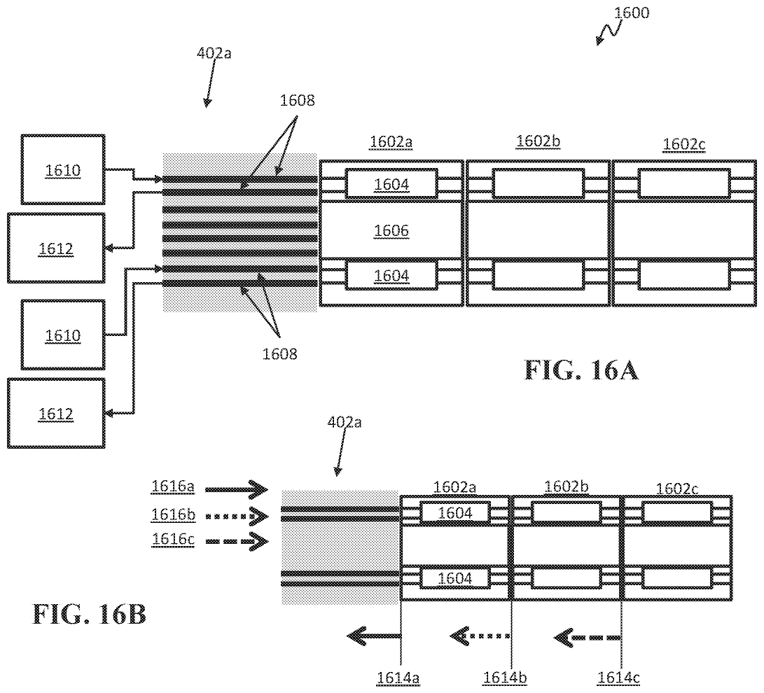

FIG. 12A depicts an assembly 1200a of four integrated photonic subcircuits 1202a, 1202b, 1202c, 1202d (collectively referred to as 1202), in which each subcircuit is configured to transfer light to an adjacent subcircuit. Each subcircuit 1202 is coupled to and/or includes a respective monitoring circuit 1204 (including circuits 1204a, 1204b, 1204c, 1204d). The monitoring circuit 1204 can determine (e.g., measure) the optical coupling efficiency between two subcircuits by monitoring the light traveling in the light path 1206. In some embodiments, these circuits are configured such that the coupling efficiency of a particular subcircuit-to-subcircuit interface may be distinguished from one another (refer to FIGS. 16A-16B for an illustrative example). The monitoring circuit may enable subcircuits to be added or optically coupled to a base subcircuit one-by-one while maintaining a high coupling efficiency.

In some cases, each monitoring circuit may include multiple input and/or output waveguides. For example, with two waveguides, light may be transmitted and received. This may reduce the need for additional external components and, in some cases, reduce ambiguity of where the light originates. Additionally or alternatively, a single light path or more than two light paths may be used. FIG. 12B shows four integrated photonic subcircuits 1208a, 1208b, 1208c, 1208d (collectively referred to as 1208), in which each subcircuit is configured to transfer light to an adjacent subcircuit. Each subcircuit 1208 is coupled to and/or includes a respective monitoring circuit 1210 (including circuits 1210a, 1210b, 1210c, 1210d). In this case, two light transfer paths 1212 are used between each subcircuit to determine respective optical coupling. The two light paths may be useful for determining optical coupling efficiency in both directions (e.g., the two opposite directions). In some embodiments, more than two light paths are monitored.

To enable facile alignment monitoring, two monitoring circuits may be placed on opposite sides of the subcircuits. This may increase angular alignment accuracy. For example, this double optical coupling monitoring may increase the rotation alignment accuracy for various optical coupling methods. As described below, in the space on a subcircuit between the two monitoring circuits (e.g., 1304a and 1304b), a “useful” circuit may be placed such that the monitoring circuits and useful circuit do not interfere with each other. The useful circuit may have independent functionality and/or purpose. For example, by bringing together the useful circuits may the function of the overall assembly be realized.

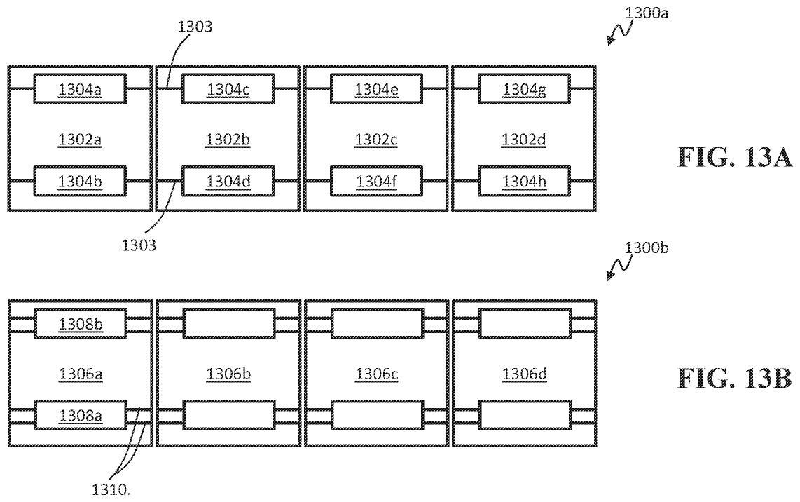

FIG. 13A shows four integrated photonic subcircuits 1302a, 1302b 1302c, 1302d (collectively referred to as 1302), in which each subcircuit is configured to transfer light to an adjacent subcircuit. In this case, for each subcircuit 1302, two respective monitoring circuits 1304 with light paths 1303 are used between each subcircuit to determine optical coupling. Therefore, subcircuit 1302a has monitoring circuits 1304a, 1304b; subcircuit 1302b has monitoring circuits 1304c, 1304d; subcircuits 1302c has monitoring circuits 1304e, 1304f; and subcircuit 1304g, 1304h. The two monitoring circuits may be positioned on opposite sides of a subcircuit. FIG. 13B illustrates a similar set of photonic subcircuits 1306a, 1306b 1306c, 1306d (collectively referred to as 1306), in which each subcircuit has two respective monitoring circuits. For example, subcircuit 1306a has monitoring circuits 1308a, 1308b and each monitoring circuit monitors a respective two light paths 1310.

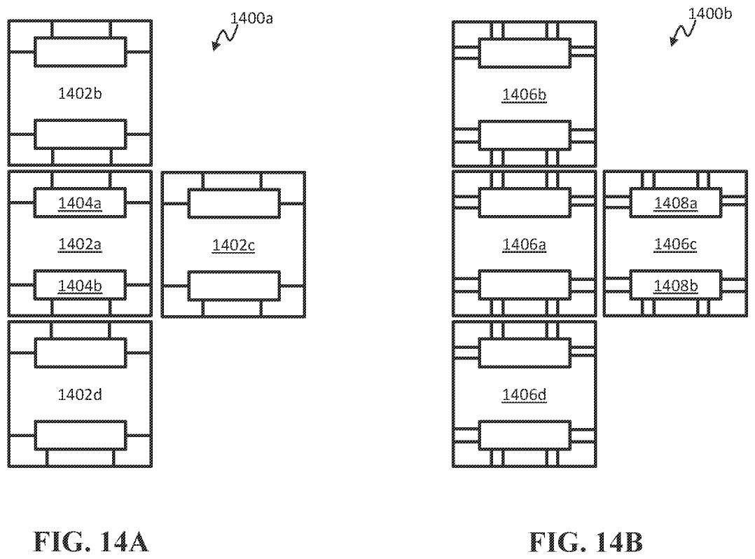

FIGS. 14A-14B illustrate example assemblies 1400a, 1400b of four subcircuits each. In this case, the subcircuits are assembled in two dimensions. For example, assembly 1400a includes subcircuit 1402a coupled to each of subcircuit 1402b, 1402c, and 1402d. Each subcircuit has a monitoring circuit configured to monitor light in two dimensions. For example, subcircuit 1402a has a first monitoring circuit 1404a and a second monitoring circuit 1404b. Assembly 1400b includes subcircuits 1406a, 1406b, 1406c, 1406d in which each subcircuit includes two respective monitoring circuits (e.g., 1408a, 1408b), in which each monitoring circuit has two respective light paths.

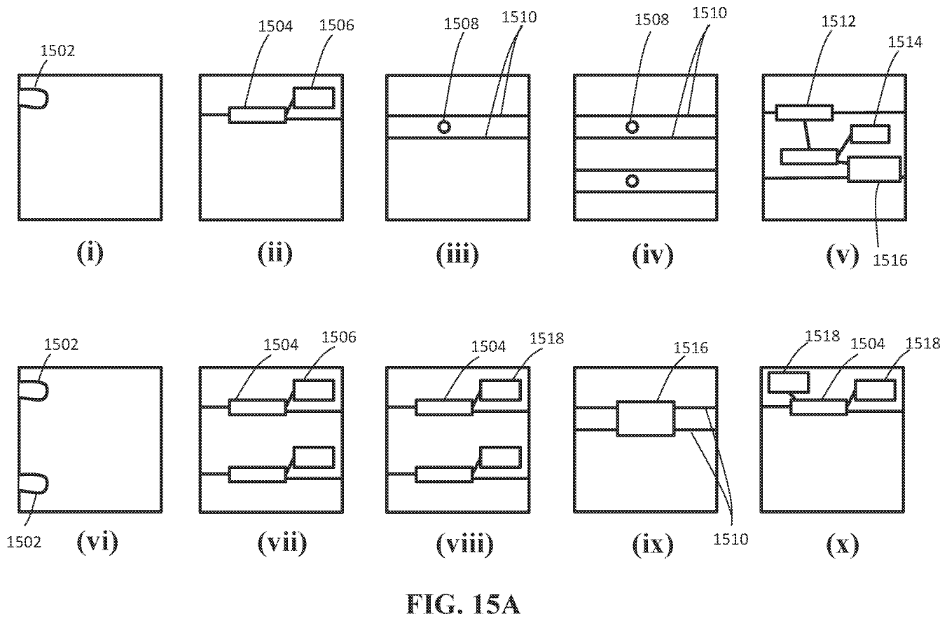

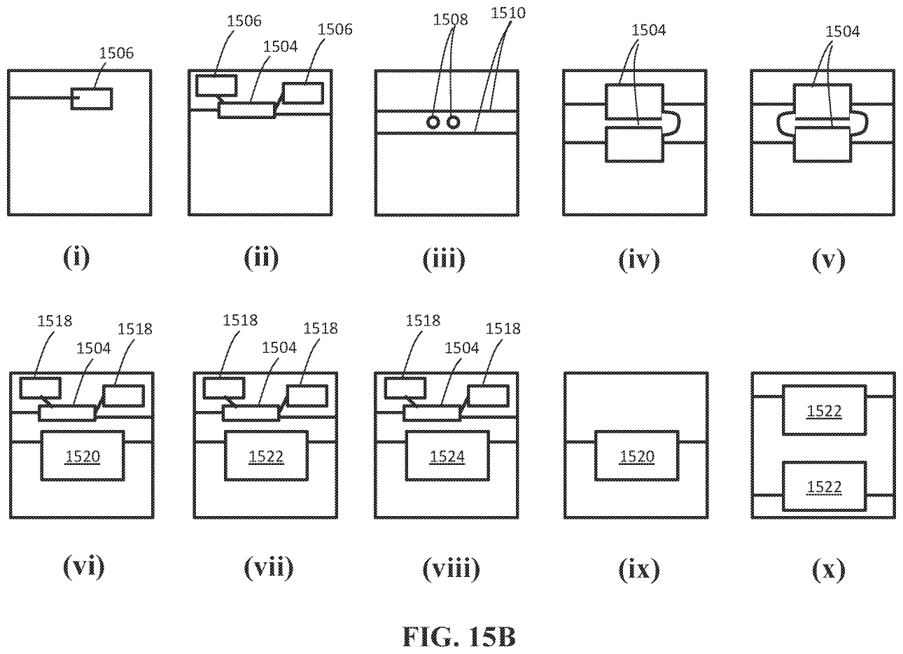

FIGS. 15A-15B provide several examples of photonic monitoring circuit implementations, e.g., configured to determine whether two or more subcircuits are aligned. FIG. 15A(i) depicts a waveguide loopback 1502. This waveguide 1502 receives and returns the light. A photodetector coupled directly or indirectly to this type of subcircuit can determine the degree of alignment (with an adjacent subcircuit) based on the determined optical loss in the returned light. FIG. 15A(ii) depicts a splitter 1504 coupled to a monitoring photodetector 1506. The splitter 1504 is configured to split the received light and send to the photodetector 1506 to determine how well light was received from an adjacent subcircuit.

FIG. 15A(iii) depicts an add-drop ring resonator 1508 which is positioned between two waveguides 1510 and configured to resonate based on the light wavelength in the waveguides 1510. The resonator 1508 may return one or more particular wavelengths. For example, if a given subcircuit has a slightly different add-drop ring, then the monitoring circuit may distinguish the coupling efficiencies for each subcircuit interface. FIG. 15A(iv) depicts a circuit similar to (iii) but with two ring resonators 1508 (each between two waveguides 1510), one situated towards the top and one towards the bottom of the subcircuit. FIG. 15A(v) depicts a double power splitter 1512, followed by a module 1514. The module 1514 can be a photodetector (PD) or out-of-plane coupler (e.g., a grating coupler (GC). The lower splitter (of the double power splitter 1512) can be coupled to a wavelength demultiplexer (WDM)) 1516.

FIG. 15A(vi) depicts a double waveguide loopback 1502. FIG. 15A(vii) depicts two replicas of the circuits of FIG. 15A(ii). FIG. 15A(viii) is similar to FIG. 15A(vii) but employs grating couplers 1518 instead of photodetectors 1506. In this circuit, the out-of-plane emitted light may be detected using a free-space photodetector, a lens system, or a fiber. FIG. 15A(ix) depicts a WDM 1516 coupled between two waveguides. Examples of such circuits include a ring resonator, a WDM having a flat top to make it temperature independent, or a contra-directional coupled Bragg grating reflector. The WDM can be configured to reflect back light at a particular wavelength. FIG. 15A(x) depicts a power splitter with grating couplers 1518 on both sides. Note that most if not all circuits in FIGS. 15A-15B may be configured to monitor light transferred from any side of the subcircuit.

FIG. 15B(i) depicts a waveguide ending in a photodetector 1506. FIG. 15B(ii) depicts a power splitter 1504 with photodetectors 1506. FIG. 15B(iii) depicts a double ring resonator 1508 (e.g., having a flat top), both between waveguides 1510. FIG. 15B(iv) depicts a power splitter 1504 followed by another power splitter 1504. FIG. 15B(v) depicts a circuit similar to FIG. 15B(iv) but useful in both directions. FIG. 15B(vi) depicts a circuit similar to FIG. 15A(viii) but including a separate channel with a wavelength dependent reflector 1520. This can helpful for subcircuits having wavelength-dependent properties, as described herein. FIG. 15B(vii) is similar to circuit of FIG. 15B(vi) but includes a Bragg reflector 1522. FIG. 15B(viii) is similar to the circuit of FIG. 15B(vi) but with a unique wavelength reflector 1524 configured for the particular subcircuit. FIG. 15B(ix) depicts a wavelength dependent reflector 1520 as the sole alignment circuit. FIG. 15B(x) depicts two Bragg reflectors 1522 to measure the alignment accuracy at two different points using the reflected light.

In the above-described monitoring circuits of FIGS. 15A-15B, the following features may be included. The splitters may have any splitting ratio or implementation. The grating couplers (GC) may emit light out-of-plane, configured at a specific angle. The monitoring circuit may utilize one or more GCs that emit at different angles to distinguish between subcircuits. The wavelength demultiplexer (WDM) may have any implementation including, e.g., ring resonators, echelle gratings, Bragg gratings, arrayed waveguide gratings, counter-directional coupling Bragg gratings, etc. In some embodiments, the WDM is configured such that its response is temperature independent, i.e., a flat-top response over a certain wavelength band. This can help ensure that the alignment accuracy monitoring does not change as a function of temperature but only as a function of misalignment. This may be important when monitoring the alignment accuracy during fabrication (e.g., during UV or thermal curing epoxy).

FIG. 16A shows an example one-dimensional assembly 1600 of three subcircuits 1602a, 1602b, 1602c (collectively 1602), in which each subcircuit has at least one monitoring circuit 1604 and a useful circuit 1606. Together, the useful circuits 1606 of two or more subcircuits 1602 may form a larger useful circuit. One of the subcircuits 1602 may be coupled to a fiber array 402a. The fiber array 402a can include multiple optical fiber. The outer fibers 1608 of the fiber array 402a may be used for monitoring the optical coupling efficiency between subcircuits 1602. A laser 1610 may be coupled to the fiber array to provide the light source, e.g., for monitoring the alignment between subcircuits. In some cases, a photodetector 1612 can be coupled into the fiber array and used to monitor light externally.

As discussed above, the subcircuits and/or their respective interfaces can be configured to be wavelength dependent. FIG. 16B provides a simplified representation of FIG. 16A to illustrate an example of wavelength dependence of the interfaces 1614a, 1614b, 1614c between the subcircuits. In this example, interface 1614a is between fiber array 402 and subcircuit 1602a and responds to light with wavelength 1616a; interface 1614b is between subcircuit 1602a and subcircuit 1602b and responds to light with wavelength 1616b; interface 1614c is between subcircuit 1602b and subcircuit 1602c and responds to light with wavelength 1616c. Based on the response from an interface, the photodetector(s) 1612 coupled to the front of the fiber array 402a is able to determine how well aligned two adjacent subcircuits are. In some embodiments, the laser 1610 is tunable to tune the wavelength of the inputted light to the specific WDM of the particular subcircuit (e.g., subcircuit 1602b and not 1602a) in the assembly 1600. In this example, each monitoring circuit can include a WDM to enable the PD 1612 to determine the coupling efficiency between subcircuit 1602a and 1602b, not between 1602b and 1602c.

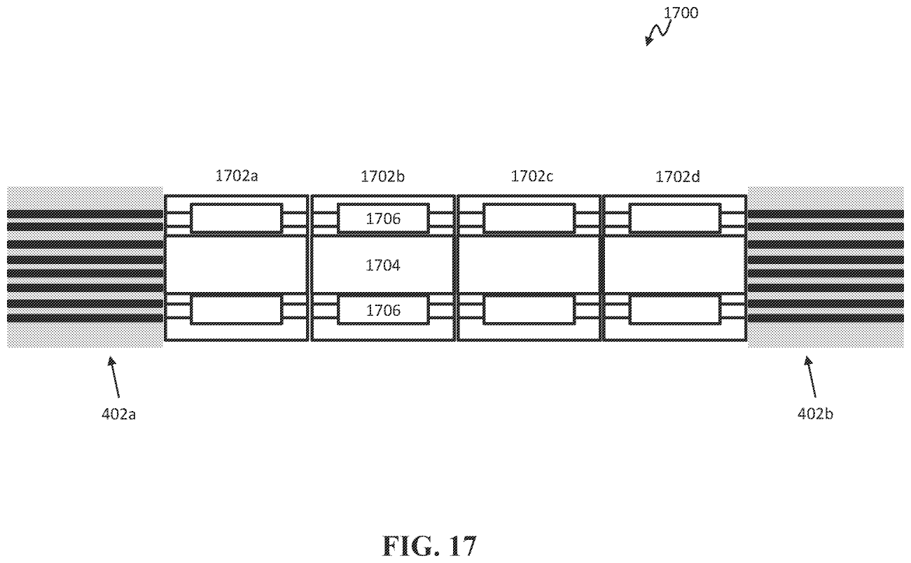

FIG. 17 illustrates a one-dimensional assembly 1700 of four subcircuits 1702a, 1702b, 1702c, 1702d (collectively referred to as 1702). In this case, light can be coupled to fibers on the left and/or right through a first fiber array 402a and a second fiber array 402b. It can be beneficial for monitoring circuits to monitor light bi-directionally. In particular, there are many ways to build this assembly 1700. For example, the assembly 1700 may be initiated from the left by coupling the fiber array 402a to subcircuit 1702a. Alternatively, the assembly may be initiated from the right by coupling fiber array 402b to subcircuit 1702d. In some embodiments, the assembly 1700 is constructed in two or more portions (e.g., partly from the left and partly from the right). In some embodiments, the subcircuits 1702 is assembled before adding the fiber arrays 402a, 402b. As subcircuits 1702 are added to the assembly, the monitor circuits are used as a feedback mechanism to monitor alignment.

### Assembly Alignment and Packaging

Described herein are example systems and methods for passive alignment and/or active alignment of subcircuits. In various embodiments described herein, the alignment systems and methods may feature a receptacle configured with complementary alignment features that can be used to assemble and optically connect many subcircuits at a given time. Further, the subcircuits may be configured to interact with the receptacles to achieve alignment.

As previously discussed, for some subcircuits, the transfer of light is in-plane and by butt-coupling the facet of one subcircuit is positioned adjacent to the facet of the other subcircuit. The input and output optical modes of the subcircuits are configured such that the output(s) match as closely as possible to the input(s) in order to enhance the coupling efficiency. In some embodiments, the mode at the output of the first subcircuit is configured to match the mode at the input of the second subcircuit, adjacent to the first. The modes may be configured even if the waveguide output and input cross-sections themselves are different sizes.

The mode can be configured to be significantly large in order to increase the alignment tolerance of the subcircuits with respect to each other. For example, a mode size can be 3 um, which translates into a 300 nm alignment accuracy for 0.2 dB insertion loss. One way to create such a large mode is to use an optical spot-size convertor on the subcircuits which adiabatically converts a small optical mode from a waveguide to a large mode at the edge of the subcircuit. For example, an implementation of a spot-size convertor is an inverted taper.

Furthermore, the input/output waveguide may be angled in-plane with respect to the facet of the subcircuit in order to reduce back reflections. Anti-reflection coatings may be applied to the subcircuit facets in order to reduce reflections further. In order to get efficient optical coupling between the subcircuits, it is beneficial for all six axes of the subcircuits to be optimized accurately. For instance, two subcircuits can be aligned in the x, y, z axes and all three angles (pitch, roll, and yaw) such that the optical input and output modes of the subcircuit travel along the same axis and to make sure that the subcircuits may be attached with a minimal gap in between.

One way to align subcircuits in six degrees of freedom is to use a hexapod and actively monitor the coupling efficiency between the subcircuits. This method is very cumbersome and slow because light needs to be coupled in and out of the subcircuits while aligning, or an infrared camera needs to be used, etc. It is also a serial process where one may only align one subcircuit at a time, which is not cost-effective when combining, for example, 10 or 20 subcircuits.

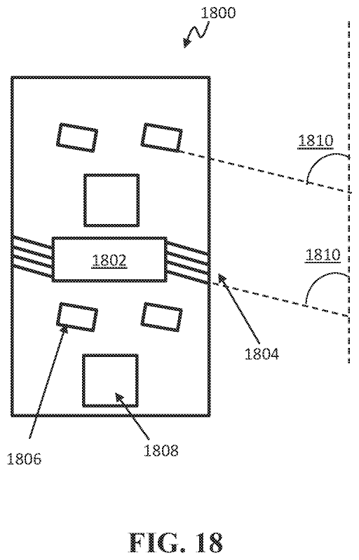

One aspect of the present disclosure is a method to align or pre-align optical subcircuits by passive alignment techniques. The subcircuits can be placed on a receptacle that is fabricated separately. FIG. 18 illustrates the top view of an example embodiment of a subcircuit 1800. The subcircuit 1800 includes a photonic circuit 1802, input and output waveguides 1804, and features 1806, 1808 for passive and/or semi-passive alignment. The deep trench features 1806 may be angled having the same angle 1810 as the waveguides 1804. The oxide open 1808 may be rectangular without a rotation relative to the subcircuit. These alignment features are configured to mate with the complementary features of the appropriate receptacle.

In FIG. 18, the alignment features can be formed by etching in the subcircuit a so-called oxide open 1808, which etches up to the core layer of the waveguide, and a deep trench 1806, which etches to more than 50 um deep. Other alignment features may be used including pyramids, inverted pyramids, v-grooves, features that 3D-printed of any shape, features that are formed using nano-imprint, features that are formed using photo-sensitive resist or polymer (SU8), etc. Each alignment feature is responsible for the passive alignment of at least one degree of freedom. Multiple alignment features may have the same functionality and be redundant or create an elastic averaging effect which increases the alignment accuracy.

The subcircuit can be fabricated on a wafer-scale. The wafer can then be diced to create the subcircuits. An important boundary condition is that the size of the subcircuits may vary since the dicing positional accuracy is typically +/−15 um. In some cases, this boundary condition can be compensated for in the alignment features.

It is beneficial for the edge of the subcircuit where light transfer occurs be in ideal or near ideal condition. The edge may have a side wall angle of 90 degrees. In some embodiments, the edge of the subcircuit has another angle such that two adjacent subcircuits have complementary angles or angles that are negative such that the input and output points of the waveguides may be aligned very close together in order to reduce the diffraction efficiency loss. The subcircuit facet may be smoothed using mechanical polishing or stealth dicing to create a smooth optical facet.

The degree of freedom along the x-direction, i.e., the direction along the width or along the direction of the input/output waveguides as in FIG. 18, is fixed by pushing the two subcircuits against each other until the two subcircuits physically touch. This can be important because the subcircuit dimensions may not be accurately fabricated due to dicing variations. One or more degrees of freedom may be aligned using the alignment features. In the alignment feature implementation of FIG. 18, the vertical alignment (z-axis) is fixed using an oxide etch feature. This etch removes the oxide from the top of the waveguide. The height reference is then the top of the waveguide which is close to the middle of the mode-size. The height reference may be anywhere in the subcircuit stack as long as it results in height matching of mode-sizes of the adjacent subcircuits. Not all subcircuits may be fabricated in the same process and have the same stack-up, so the height reference etch may be different.

When the subcircuits have the exact same distance from the core waveguide layer to the top of the subcircuit, then the top of the subcircuit may be used as height reference. However, this is may be atypical since even wafer-to-wafer or intra-wafer variations of the top layer may occur. FIG. 18 illustrates two oxide etches for the vertical alignment but typically at least three positions are needed with these height reference features which then constrains the height, tip and tilt at the same time. The y degree of freedom or the degree of freedom perpendicular to the waveguide direction can be fixed using the deep trench etch features. The x direction or waveguide direction is not constrained using alignment features because the chips may be pushed against each other and physically touch. The rotational degree of freedom can be constrained due to the fact that there is more than 1 lateral alignment feature.

In some embodiments, two or three lateral alignment features are used for a given subcircuit but more features may be in order to leverage elastic averaging. This is particularly true when the subcircuit and/or receptacle alignment features are made of a non-rigid material. Rotational alignment may be attained using the pick and place tool by referencing the edges of the subcircuit or by pushing the subcircuit edges to each other thereby constraining the rotation. Note that the deep trench etch in FIG. 18, which acting as a lateral alignment feature, can be rotated with respect to the subcircuit edge. In some embodiments, this angle of rotation is the same as the angle of the input and output waveguides relative to the edge of the subcircuit. The rotated lateral features thus creates a free degree of freedom along the waveguide direction.

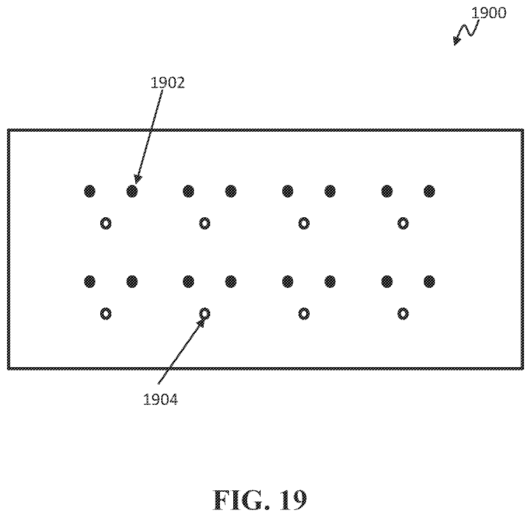

FIG. 19 illustrates the top view of a receptacle 1900 configured to be complementary to the subcircuit 1800. The receptacle includes alignment features with different heights that can mate with the subcircuit. Note that the alignment features can be used to align the subcircuits laterally or vertically. For example, lateral alignment features 1902 can be used to align a subcircuit 1800 laterally relative to the receptacle 1900 and/or to adjacent subcircuits. The lateral alignment features 1902 may be any shape as long as they fit in the deep trench etch hole of the subcircuit 1800 and do not touch the bottom of the deep trench (which would constrain the vertical direction). Vertical alignment features 1904 can be used to align a subcircuit 1800 vertically relative to the receptacle 1900 and/or to adjacent subcircuits. The vertical alignment feature may be any shape as long as it does not touch the edges of the oxide etch of the subcircuit. For example, the lateral or vertical features may have a circular, semi-circular, elliptical, rectangular, or other shape.

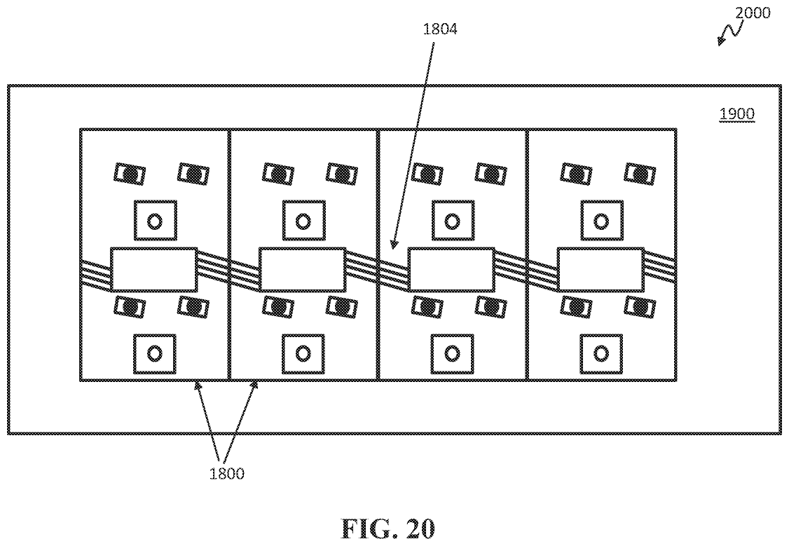

FIG. 20 illustrates the top view of multiple subcircuits 1800 positioned on the receptacle 1900. The complementary alignment features of the subcircuits 1802 and receptacle 1900 are configured such that the waveguides 1804 line up perfectly or near perfectly. This can be true even when the width of the subcircuit varies due to dicing.

In some embodiments, between the facets of the subcircuits, an index matching epoxy (e.g., ultraviolet epoxy, thermal epoxy, two-part epoxy, etc.) are added to glue the two subcircuits together. One issue with attaching subcircuits with epoxy is that it takes time to cure the epoxy. Therefore, it may be beneficial if first all or most of the subcircuits are aligned, epoxy is added, and the epoxy between the facets of the subcircuits is cured all at once outside of the pick and place machine. For this, the chips may need to be mechanically held in place in order to not lose alignment. The alignment features contribute to the mechanical stability of the subcircuits relative to the receptacle. However, further reinforcement may be used, e.g., mechanical clamps or vacuum using vacuum holes or lines in the receptacle. After epoxy curing, the epoxy may glue the subcircuits to the receptacle. The subcircuits may be removed from the receptacle by for example treating the receptacle with and anti-adhesive layer before use. The receptacle may then be used multiple times, thereby decreasing assembly cost. One beneficial factor of using a receptacle temporarily and not permanently is that the top of the subcircuit assembly is now accessible and the subcircuits assembly may be packaged (e.g., by wirebonding, fiber array attachment, PCB board mounting, etc.) in a regular fashion with the top side face up.

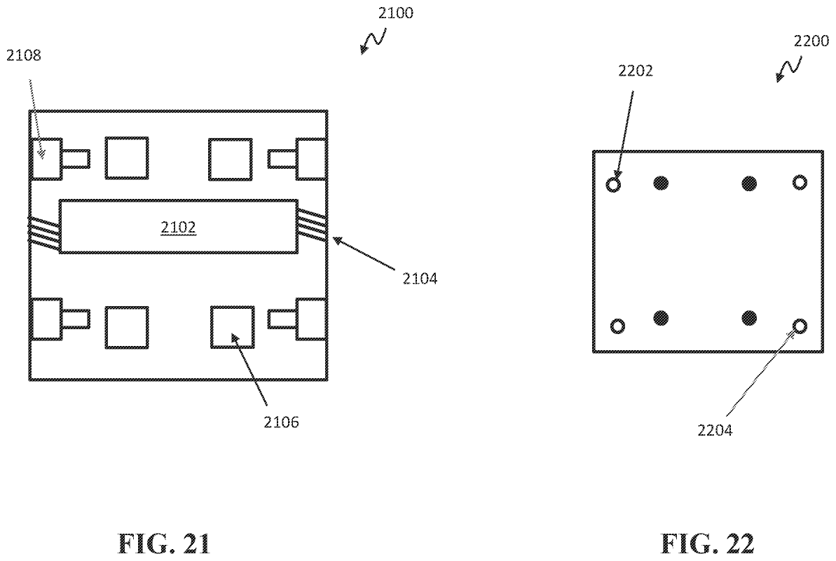

FIG. 21 shows the top view of an example subcircuit 2100 including photonic circuit 2102 and input and output waveguides 2104. The subcircuit 2100 is configured with two types of etches, a shallow-type etch (e.g., oxide open) 2106 and a deep-type etch (e.g., deep trench) 2108. In this case, the waveguides are straight, e.g., the angle of the lateral alignment features is zero. The alignment features may have a specific shape such as a funneling shape to guide the alignment process. In this case, many receptacles are used with each receptacle aligning two subcircuits. This has the benefit of having more versality in terms of chip sizes and process differences. Furthermore, the receptacle does not to be removed since one has access to the top of subcircuits in regions where there is no receptacle.

FIG. 22 illustrates a top view of an example connector chip 2200 that may be used in assembling two subcircuits 2100. The connector chip 2200 can be configured with lateral alignment features 2202 and/or vertical alignment features 2204.

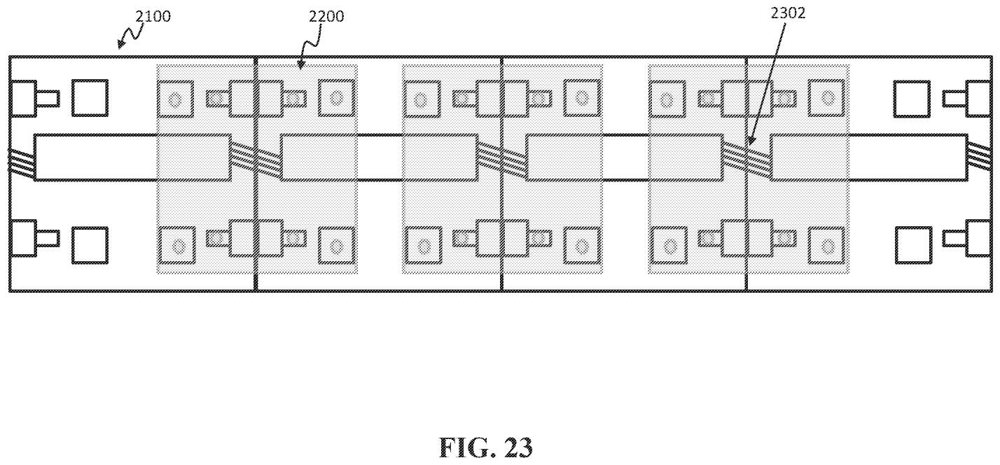

FIG. 23 depicts a top view of an example assembly of subcircuits 2100. The subcircuits 2100 are assembled using connector chips 2200. Each connector chip 2200 combines two subcircuits 2100 such that the input waveguides 2104 of one subcircuit are aligned to the output waveguides 2104 of the other subcircuit (at position 2302).

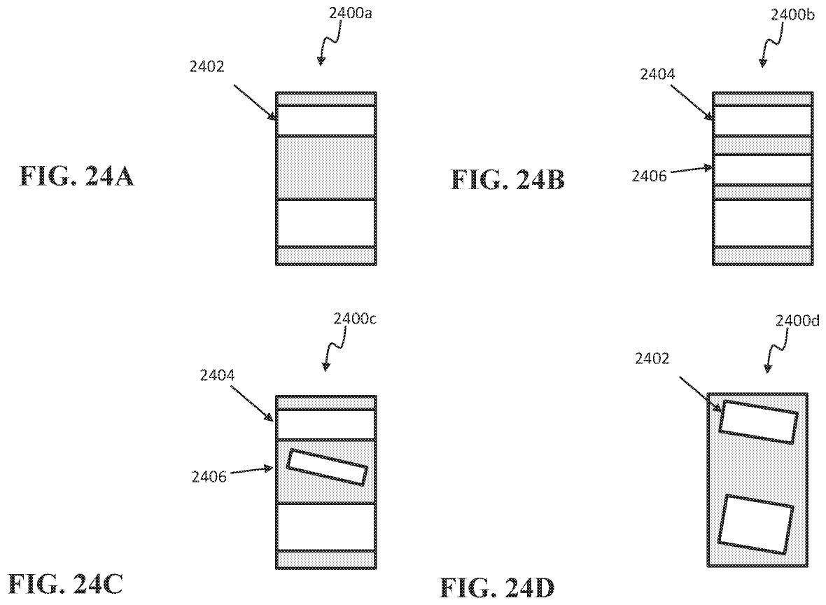

FIGS. 24A-24D shows top views of example variations for subcircuits 2400a, 2400b, 2400c, 2400d (collectively referred to as 2400). The subcircuits 2400 are configured with etches 2402 that may extend or not extend to the edge of the subcircuit. The etches can include oxide open 2404 or a deep trench 2406. The etches 2402 may be non-angled or angled (relative to the subcircuit 2400). The etches 2402 may be used for either vertical or lateral alignment or both.

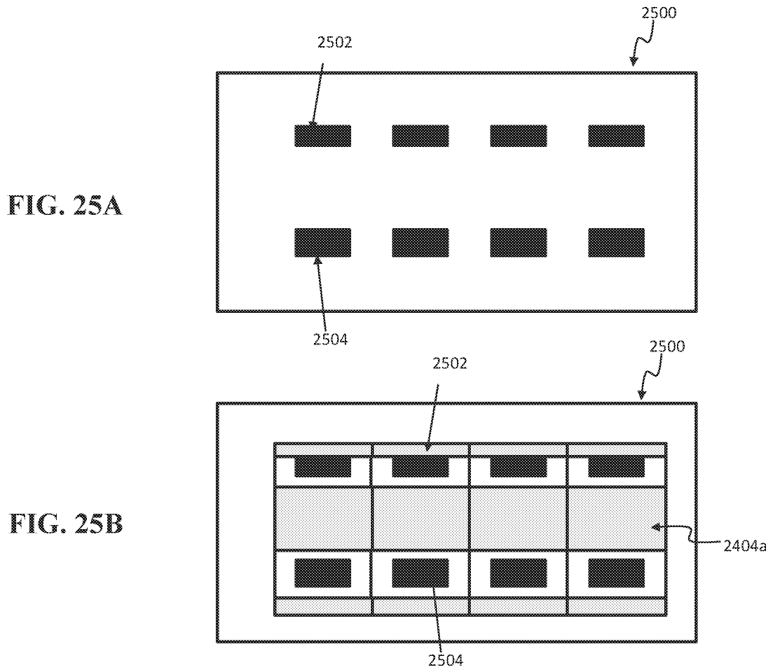

FIG. 25A illustrates a top view of a receptacle 2500 configured to receive subcircuits 2400a, 2400b, and/or 2400c. The receptacle 2500 includes vertical and/or lateral alignment feature 2502 and a vertical alignment feature 2504. FIG. 25B illustrates the top view of the receptacle 2500 connected to four subcircuits 2400a. In this case, the alignment features are more rectangular and the receptacle alignment features are also rectangular, touching with a plane of points instead of a vertical line (compare to FIGS. 18-20). The oxide open etch can be used for both vertical and lateral alignment features. The edge of the northmost alignment feature can be used for lateral and rotational alignment.

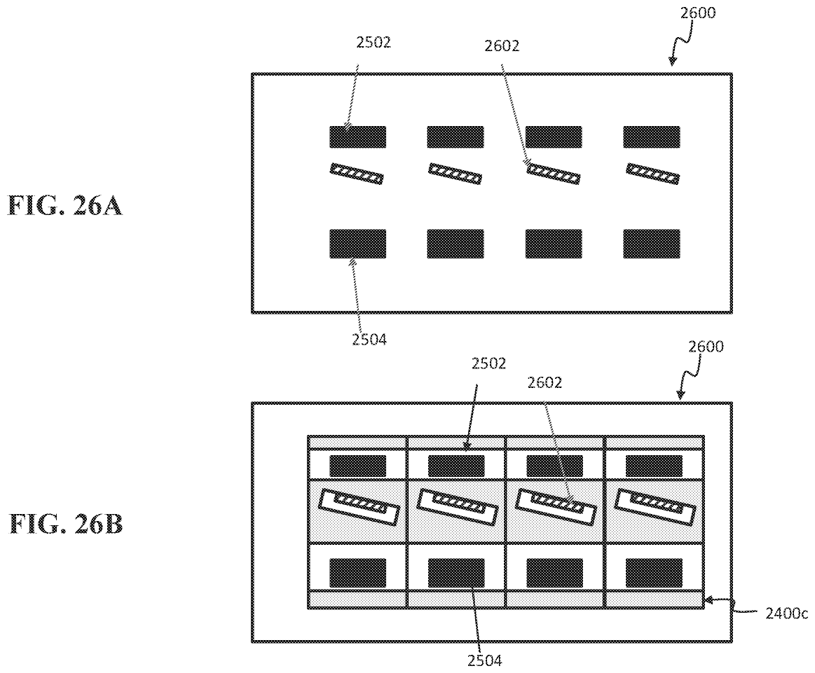

FIG. 26A illustrates a top view of receptacle 2600 configured to receive subcircuit 2400c. In receptacle 2600, the lateral alignment feature 2602 is angled and, once mated with the subcircuit 2400c, only touches one side or edge of subcircuit 2400c. FIG. 26B illustrates the top view of the receptacle 2600 connection to four subcircuits 2400c. The receptacle 2600 features angled lateral alignment features that are rectangular in shape. In this case, the middle alignment features constrain the chip alignment in the lateral and rotational dimensions.

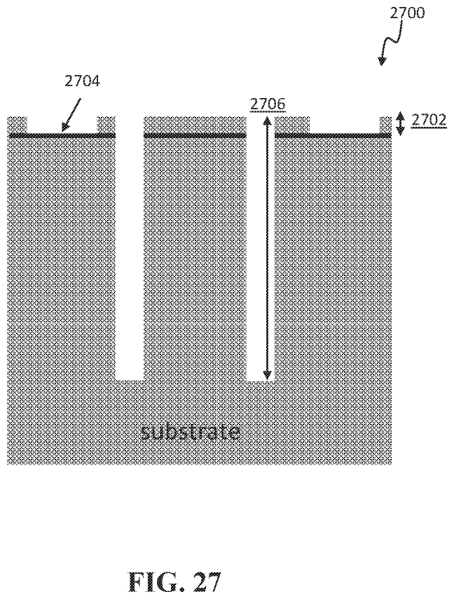

FIG. 27 is a cross-sectional view of an example subcircuit 2700. The subcircuit 2700 has a shallow etch 2702 (e.g., oxide open) of 5 um which stops at or is close to the waveguide layer 2704 and a deep trench etch 2706 of 80 um. The subcircuit 2700 has a waveguide layer 2704 which guides light and may be used to form input and output couplers and photonic circuits. In some embodiments, the generation of alignment features for subcircuit 2700 takes advantage of processes available in every or most of the fabs. Therefore, the deep trench etch and oxide etch can be useful because they are both options that are available in many fabs and may in some cases be fabricated on the same wafer.

The deep trench is typically used for creating a smooth facet for horizontal fiber coupling. Since a standard single mode cleaved fiber has a 125 um diameter, the deep trench is typically more than 62.5 um deep (half of the fiber diameter). As long as the lateral alignment features on the receptacle (blue in FIG. 9) are not taller than 62.5 um they will not touch the bottom of the deep trench and thus not confine the subcircuit in the vertical direction. This is desirable since the depth of a deep trench is typically difficult to accurately control. The oxide open on the other hand may be controlled with nanometer precision. Another benefit of using the deep trench is that the area that is used for lateral alignment is comparatively large and thus pretty robust to mechanical damage and wear and tear.

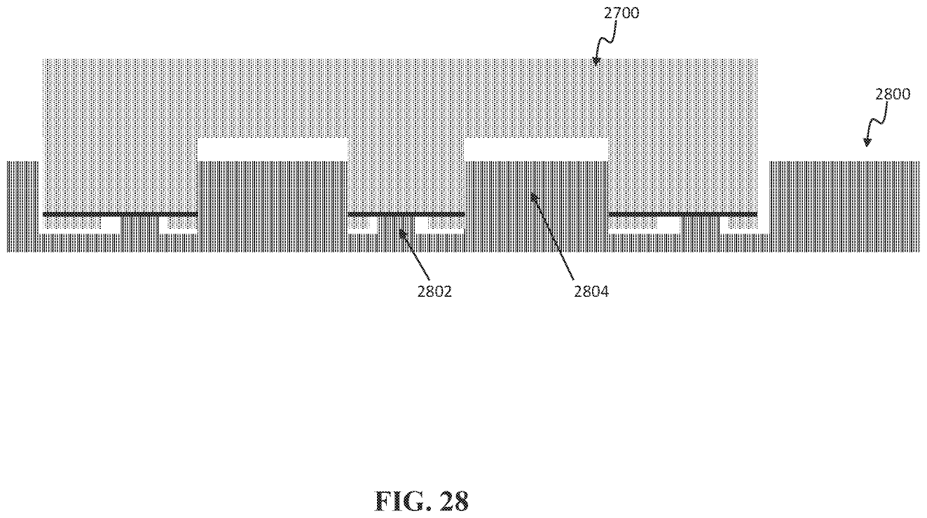

FIG. 28 is a cross-sectional view of the subcircuit 2700 in combination with the receptacle 2800. The example receptable 2800 includes vertical alignment features 2802 configured to mate with the shallow etch 2702 of the subcircuit 2700 and lateral alignment features 2804 configured to make with the deep features 2706.

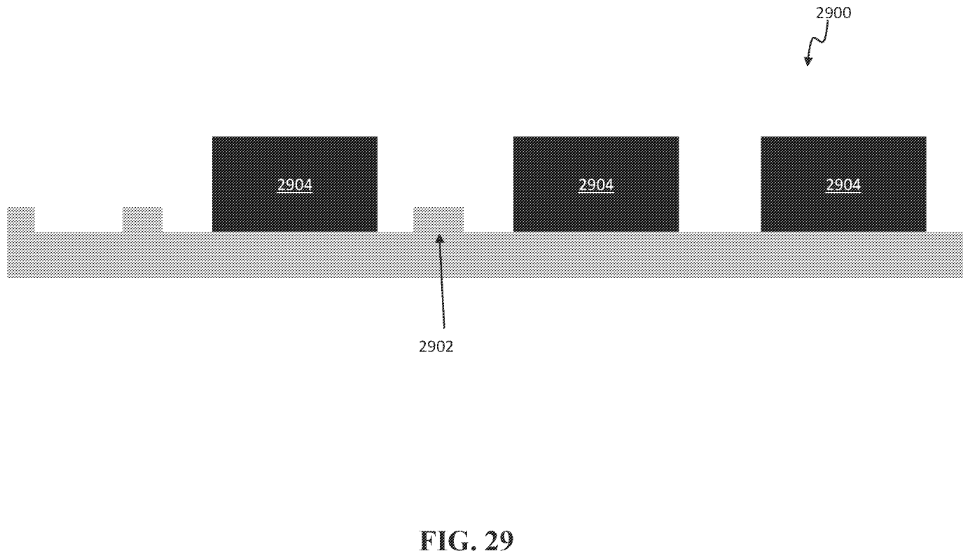

FIG. 29 is a cross-sectional view of an example implementation of a receptacle 2900. The lower profile alignment features 2902 are in glass and are used for vertical alignment. The higher profile alignment features are made of a polymer 2904 and used for lateral alignment.

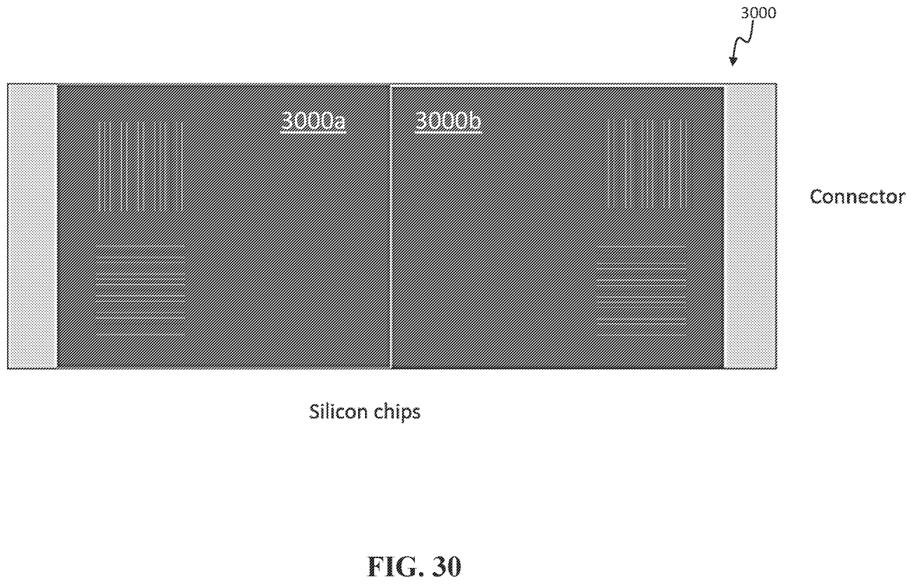

FIG. 30 shows a top view example subcircuit(s) 3000a, 3000b aligned to a receptacle 3002. In this case, the alignment features are designed to be a grating of several slits. Note also that the subcircuit(s) 3100a, 3100b are aligned in mirror-image positions relative to one another. In this case, the alignment features are configured as gratings (e.g., repetitive structure) which may give more freedom to configure elastic averaging for the combination.

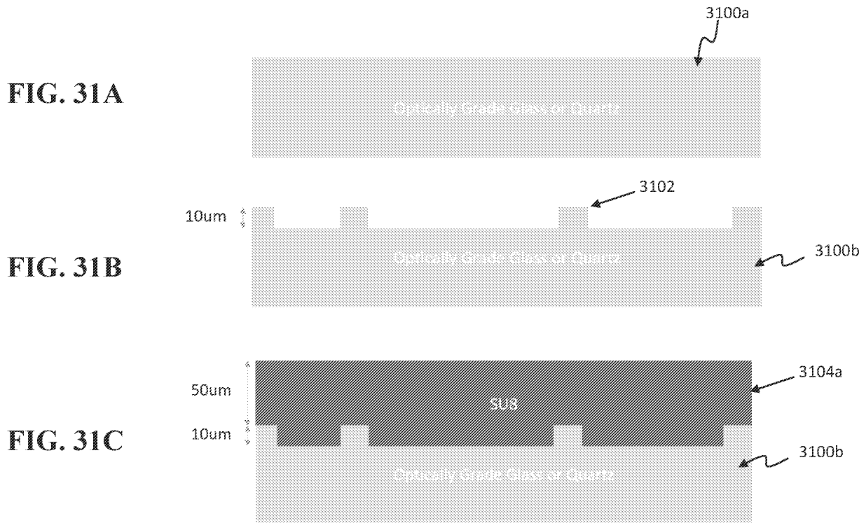

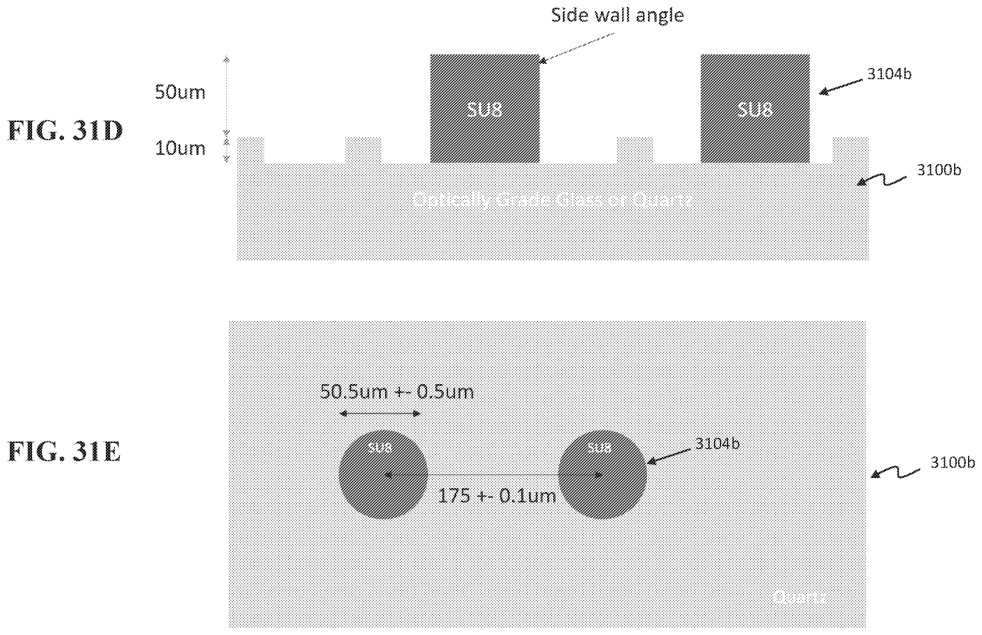

FIGS. 31A-31E illustrate example fabrication steps for fabricating a receptacle wafer. FIGS. 31A-31D provide a cross-sectional view while FIG. 31E provides a top view. Referring to FIG. 31A, optical-grade glass or quartz can be used as a starting substrate 3100a. A flat, transparent substrate can make it easy to visually inspect the alignment. Referring to FIG. 31B, a shallow etch (e.g., of 10 um) is performed to define vertical alignment features 3102 in etched substrate 3100b. The vertical alignment features can be etched (for example, a 10 um etch) with an etch that is deeper than the oxide open etch on the subcircuit (typically ranging from 2 um to 9 um). The top of the glass substrate 3100b now acts as the vertical alignment reference point. This may be beneficial since the glass was mechanically polished to be completely flat (e.g., optically grade flat).

In FIG. 31C, the lateral alignment features can be formed in an epoxy or polymer (which is elastic). For instance, a polymer (e.g., SU8) 3104a is spin coated onto the substrate 3100b. In FIG. 31D, the SU8 3104b is patterned to define lateral alignment features. In FIG. 31E, the lateral alignment features are provided in a top view. In this example, each lateral alignment feature is substantially circular with a diameter of 50.5 um+/−0.5 um. These features are separate by 175 um+/−0.1 um.

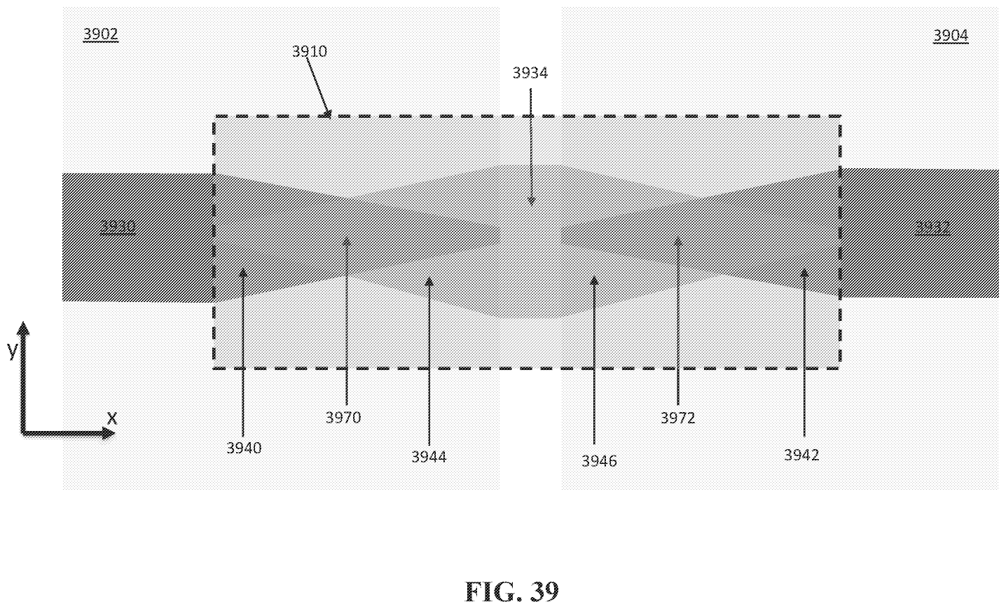

The side wall angle of these features may be configured for easy insert (positive angle) or for better mechanical stability (negative angle). The width of the lateral alignment feature 3104b may be either the same size, a bit narrower or a bit wider than the pit in the subcircuit. Exactly the same size may be ideal but may not be perfectly achieved. If the lateral alignment feature is a bit wider on the receptacle, then it may need to compress a bit to match the trench width in the subcircuit. Another strategy is to make the receptacle features a bit narrower and offset them from the center position. The latter is shown in FIG. 39 in which the left alignment feature touches the right edge of the sidewall of the subcircuit trench and the right alignment feature touches left edge of the sidewall of the subcircuit. More complex elastic averaging strategies may be implemented. In some embodiments, instead of a quartz or glass substrate, a silicon substrate is used. Other materials and substrates may be used for the substrate. In one example, the receptacles may be 3D printed, given the printer has sufficient accuracy.

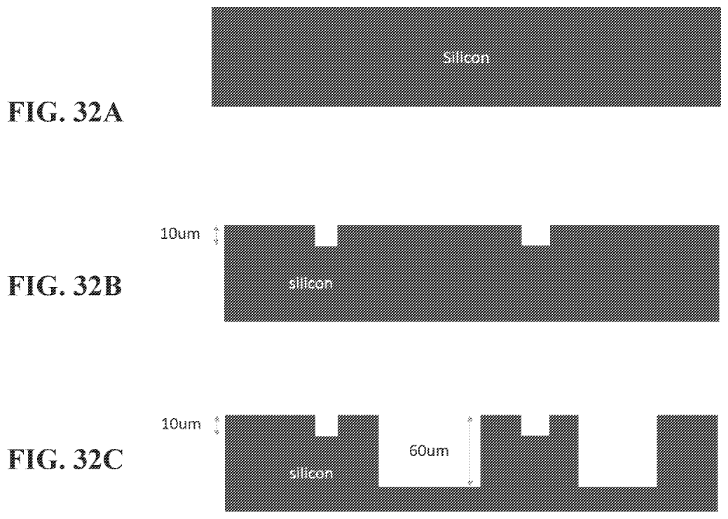

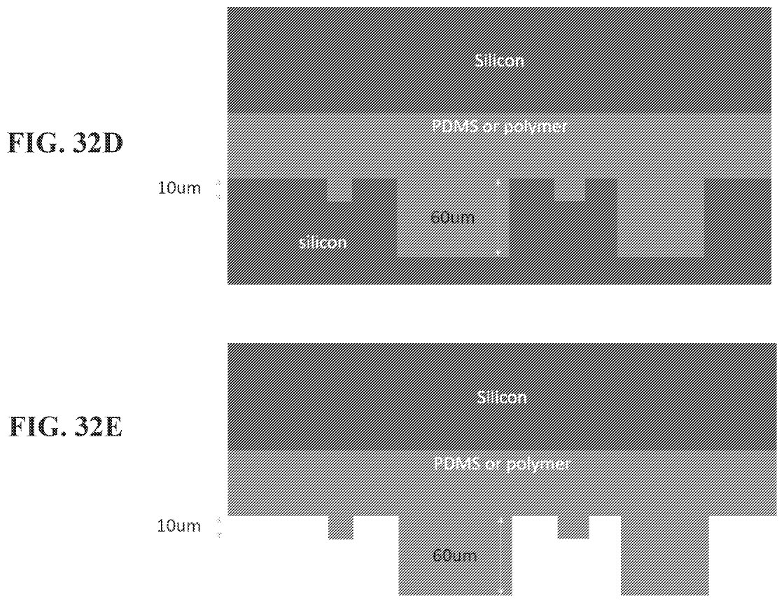

FIGS. 32A-32E illustrate an example alternative method to fabricate a receptacle. FIGS. 32A-32D provide a cross-sectional view while FIG. 32E provides a top view. In FIGS. 32B-32C, the inverse (or mold) is first patterned in a silicon substrate using two etch steps. In FIGS. 32D-32E, using a nanoimprint method, the receptacle is fabricated using the silicon as a mold in PDMS or polymer. One benefit of this approach is that it may reduce the cost of the receptacle itself.

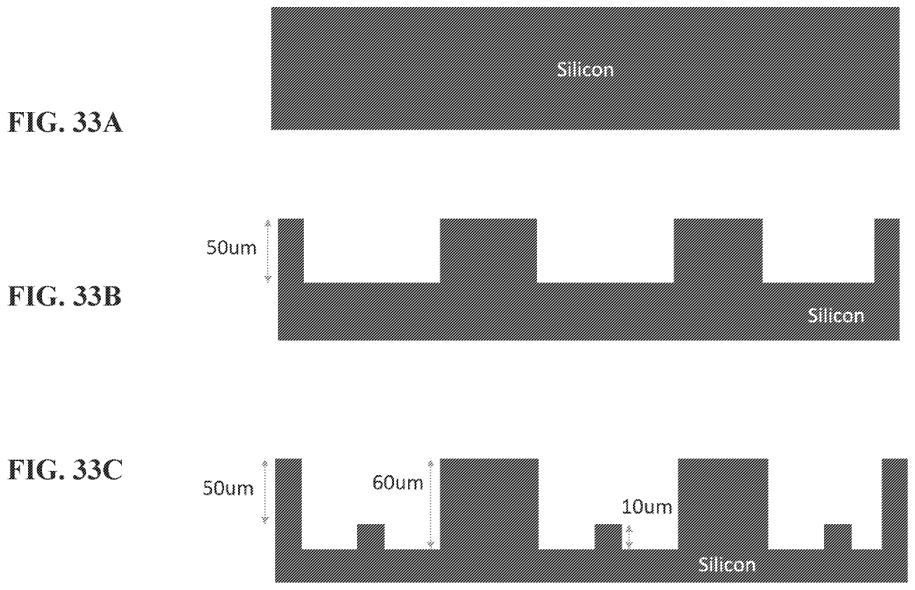

FIGS. 33A-33C illustrate an example method to fabricate the receptacle directly on a silicon wafer. The first etch is then the deepest etch and a second etch is performed to define the vertical alignment features. In FIG. 33B, a deep etch (e.g., of 50 um) is performed. In FIG. 33C, a shallow etch (e.g., of 10 um) is performed into the deep etched pits.

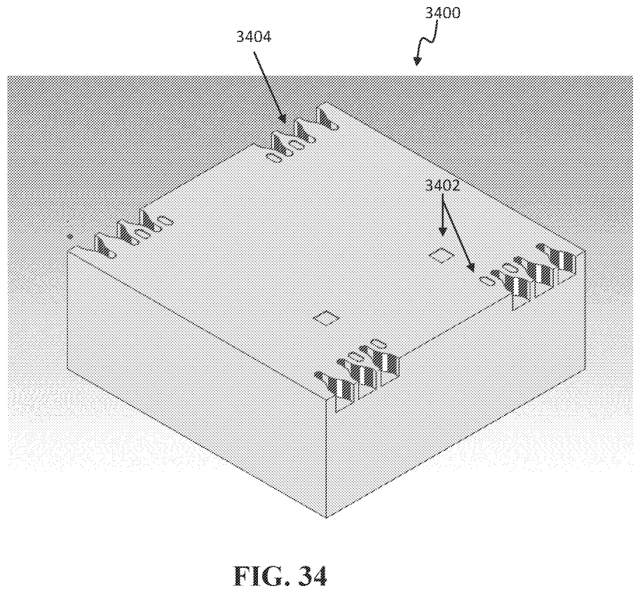

FIG. 34 illustrates an example 3D drawing of a subcircuit 3400 having shallow-etched vertical alignment features 3402 and deep-etched lateral alignment features 3404. The example subcircuit is 2 mm×2 mm with 790 um in thickness. The 3D rendering better illustrates the aspect ratio of the alignment features (deep versus shallow) and the etch depths with respect to the subcircuit thickness.

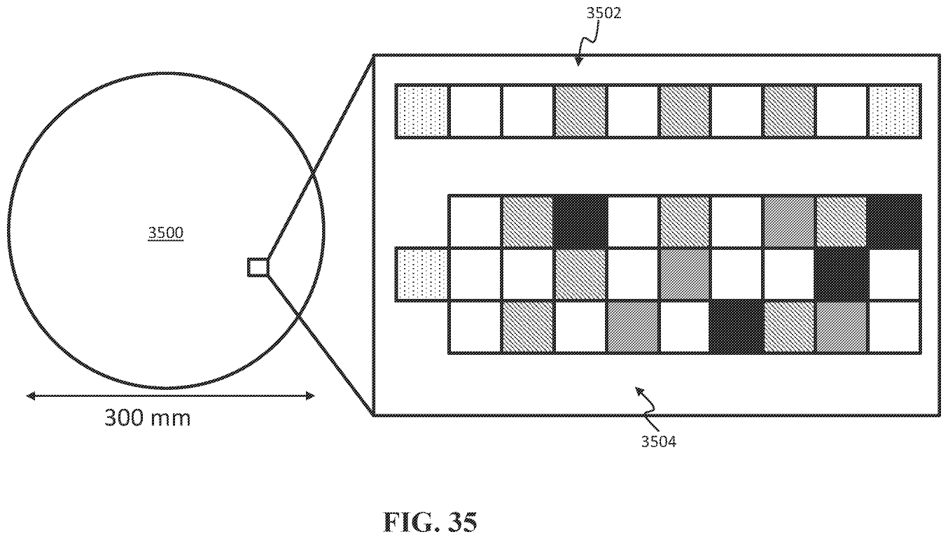

FIG. 35 illustrates the assemblies 3502, 3504 of subcircuits on a receptacle silicon wafer 3500 which may be either 1-dimensional, 2-dimensional, or 1.5-dimensional. The wafer has a approximately 300 mm diameter. The subcircuits have different colors indicating subcircuits from different processes or technologies.

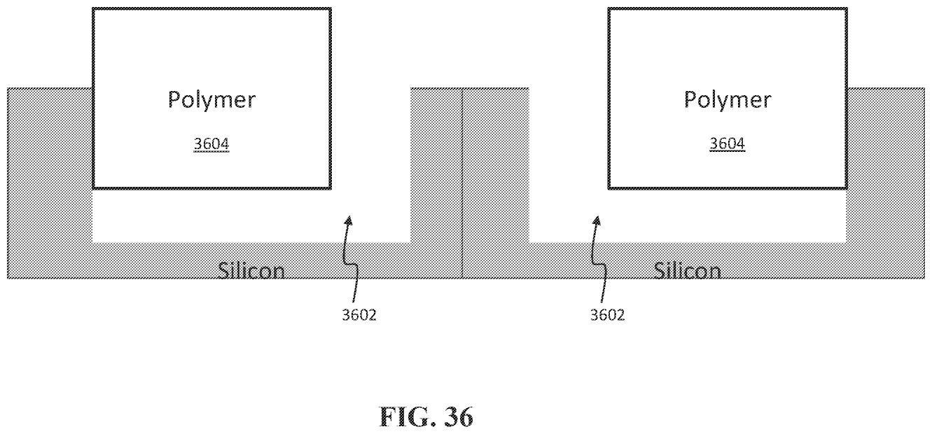

FIG. 36 illustrates a method for aligning two or more subcircuits by using elastic averaging. As described above, subcircuits and receptacles may have lateral alignment features. For instance, in FIG. 36, the receptacle may have cavities 3602 for receiving lateral alignment features 3604 of subcircuits. For example, the use of a polymer for a lateral alignment feature may be beneficial for elastic averaging. By making the lateral alignment features slightly offset, high lateral alignment accuracy may be achieved. In some embodiments, the subcircuits and receptacles each have multiple (e.g., 10 or less, 20 or less, 30 or less, 50 or less, 100 or less) alignment features, which when offset relative to one another, can create accurate positioning and/or connections by averaging the error inherent to the lateral alignment features.

In some embodiments, the coarse alignment is performed passively while the fine final alignment may be performed actively in one or more degrees of freedom, using either optical feedback or vision feedback using alignment marks. One such implementation is to perform a quick final alignment of one of the lateral axes while the height, tip and tilt are passively constrained. The benefit of this is that alignment stage only needs to be able to move in one of the degrees of freedom and does need to be a hexapod type of device.

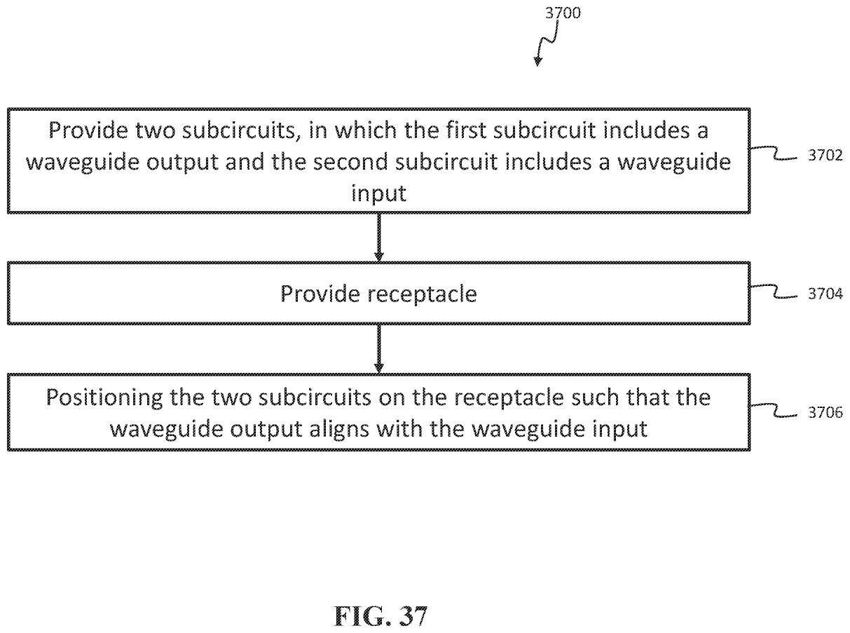

FIG. 37 is a flowchart of an example method 3700 for aligning two or more photonic integrated subcircuits. In step 3702 of method 3700, two or more subcircuits are provided. A first subcircuit may include a waveguide output (e.g., along a first edge) and the second subcircuit can include a waveguide input (e.g., along a second edge). The subcircuit may include at least one subcircuit vertical alignment feature and/or at least one subcircuit lateral alignment feature. In step 3704, at least one receptacle is provided. In some cases, one receptacle is provided for two or more subcircuits. The receptacle may include at least one receptacle vertical alignment feature and/or at least one receptacle lateral alignment feature. The subcircuit vertical alignment feature can be configured to be complementary to the receptacle vertical alignment feature. The subcircuit lateral alignment feature can be configured to be complementary to the receptacle lateral alignment feature. In step 3706, the two subcircuits can be positioned on the receptacle (or the receptacle can be positioned on the two subcircuits) such that the waveguide output of the first subcircuit matches the waveguide input of the second subcircuit. It is understood that the example 3700 method may leverage any embodiment or feature described herein. The subcircuits may be any example embodiment of a subcircuit described herein and/or may include one or more subcircuit features described herein.

### Adiabatic Photonic Integrated Subcircuit Coupling

Described herein are example systems and methods for adiabatic optical coupling of photonic integrated subcircuits to provide a low-loss optical path between subcircuits. In various embodiments described herein, the systems can include photonic integrated subcircuits coupled together by an optical waveguide, e.g., an adiabatic optical waveguide, to form an integrated photonics assembly. In some embodiments, the optical waveguide can include one or more features to form a low-loss optical path between one photonic integrated subcircuit and another photonic integrated subcircuit.

To achieve this low-loss optical path, the waveguide coupler can include one or more of the following example features. In some examples, an adiabatic optical waveguide and/or an interposer can be used. In some examples, the waveguide coupler and photonic integrated subcircuit can be positioned parallel to each other. In some examples, a coupling gap can be located between at least one photonic integrated subcircuit and an optical waveguide. In some examples, a coupling gap between subcircuits that includes a vacuum, air, and/or include an inert gas can be used. In some examples, the optical waveguide can be backfilled with an optical index-matching material. In one example, the optical waveguide can include a material selected from silicon, silicon dioxide, silicon nitride, compound semiconductors and oxides, optical glass, engineered polymers, photoresists, diamond, garnet, sapphire and/or any other type of optical material. One benefit of at least one example system described herein is that, in contrast to conventional optical waveguide devices, the system may not require or use free-space optical components such as lenses or mirrors to transfer light between a photonic integrated subcircuit and an optical waveguide.

In some embodiments, the systems and methods preserve optical waveguide behavior throughout the system, including coupling between photonic integrated subcircuits and optical waveguides. In some embodiments, the systems and methods described herein provide for low loss optical coupling and/or preserve optical polarization throughout the system.

Exemplary optical waveguides can include an interposer. In some examples, the interposer can be inserted between at least two photonic integrated subcircuits. In some examples, an exemplary waveguide can include a customized, circuit-specific interposer which can provide for monolithically fabricated couplers for two or more photonic integrated subcircuits in an integrated photonic assembly. In some examples, a functional photonic integrated subcircuit can be flipped upside down and coupled to one or more photonic integrated subcircuits to act as an optical waveguide between subcircuits. In some examples, any other photonic integrated subcircuit capable of implementing a vertical adiabatic coupling into its waveguide layers between photonic integrated subcircuits can be used.

In some embodiments, to implement the lowest cost and highest throughput assembly of multiple photonic integrated subcircuits into integrated photonic assemblies, as described in the “Assembly Alignment and Packaging” section above, it can be valuable to minimize assembly or fabrication steps which are unique or custom for each joint, such as active alignment, robotic pick-and-place, or customized sub-microscopic 3-D printing.

In some embodiments, adiabatic coupling can be used to couple or split light confined in an optical waveguide structure into one or more adjacent waveguides in a smooth transition with very low loss. In some embodiments, waveguides within a photonic integrated subcircuit are configured in close proximity, in-plane (to implement same-layer splitters and couplers) or out-of-plane (to implement escalators transferring light between waveguide layers within a subcircuit). A variant on this technique includes coupling light between a chiplet (e.g., one or more photonic integrated subcircuits) and a photonic wirebond, such that one portion of an adiabatic coupler can be fabricated within the chiplet and the other portion can be 3-D printed (e.g., customized) during the process of creating the photonic wirebond. In some embodiments, another variant of this technique can include coupling light between an integrated photonics assembly and a photonic wirebond.

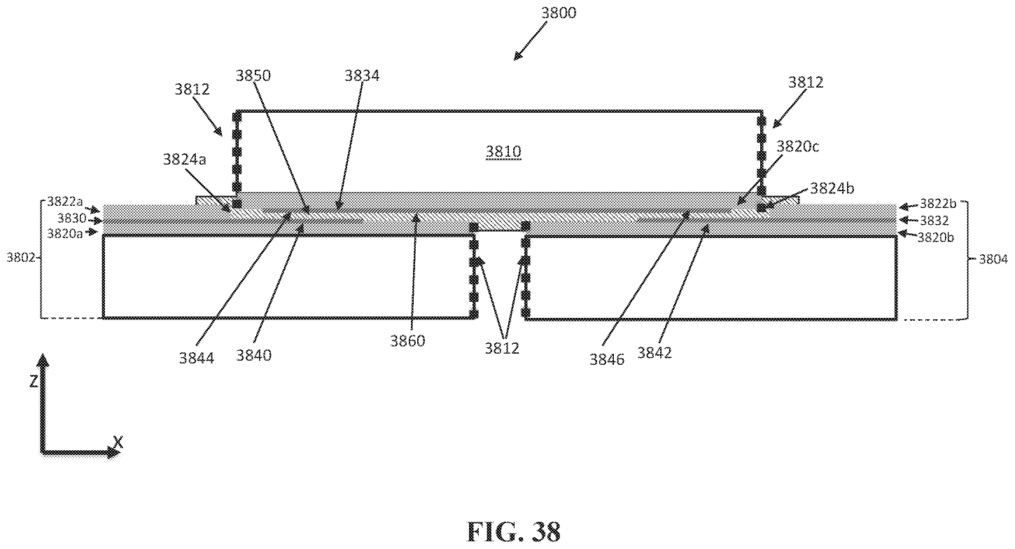

Referring to FIG. 38, an X-Z axis cross-sectional view of an example subcircuit-interposer-subcircuit coupling is presented. In some embodiments, the subcircuit-interposer-subcircuit coupling 3800 includes a first photonic integrated subcircuit 3802, an interposer 3810, and a second photonic integrated subcircuit 3804. In some embodiments, the interposer 3810 can be disposed over the first and second subcircuits 3802, 3804. In some examples, the interposer 3810 can be disposed over a portion of the first subcircuit 3802 and/or a portion of second subcircuit 3804 (e.g., the interposer 3810 may partially cover the first and/or second subcircuits 3802, 3804) as shown in FIG. 38.

In some embodiments, first subcircuit 3802 can include a first oxide layer 3820a, a first waveguide 3830, and a second oxide layer 3822a disposed over the first waveguide 3830. In some embodiments, second subcircuit 3804 can include the a first oxide layer 3820b, a second waveguide 3832 and a second oxide layer 3822b disposed over the second waveguide 3832. The first oxide layers 3820a, 3820b (collectively referred to as 3820) may be referred to as a “bottom oxide layer”. The second oxide layers 3822a, 3822b (collectively referred to as 3822) may be referred to as a “top oxide layer”. As shown, in some embodiments, a top oxide opening 3824a can be disposed between the second oxide layer 3822a of the first subcircuit 3802 and the first oxide layer 3820c of the interposer 3810. In some embodiments, a top oxide opening 3824b can be disposed between the second oxide layer 3822b of the second subcircuit 3804 and the first oxide layer 3820c of the interposer 3810.

Referring still to FIG. 38, in some embodiments, the interposer 3810 can include the first oxide layer 3820c and an interposer waveguide 3834. In some embodiments, the interposer 3810 can include a third photonic integrated subcircuit. For example, this third subcircuit can be flipped relative to the first and second subcircuits 3802, 3804. In some embodiments, an adhesive layer 3860 can be disposed in a gap 3850 (e.g., a coupling gap) between (i) the interposer 3810 and (ii) the first subcircuit 3802 and/or second subcircuit 3804. In some embodiments, the adhesive layer 3860 can be disposed between the interposer waveguide 3834 and the first and second waveguides 3830, 3832. In some examples, the adhesive layer 3860 can include an index-matching adhesive fill.

In some embodiments, the first waveguide 3830 can include a first tapered portion 3840, the second waveguide 3832 can include a second tapered portion 3842 and the interposer waveguide 3834 can include a third and fourth tapered portion 3844, 3846.

Referring again to FIG. 38, in some embodiments, the first and second subcircuits 3802, 3804 and/or the interposer 3810 can include cut portions 3812. In an example, the first and second subcircuits 3802, 3804 and the interposer 3810 can be cut and/or singulated from a larger structure (e.g., at a wafer level) and the cut portions 3812 can be a result from a dicing and/or singulation process which formed the first and second subcircuits 3802, 3804 and/or the interposer 3810.

In some examples, guided light can be transferred from the first waveguide 3830 of the first subcircuit 3802 to the interposer waveguide 3834 in the interposer 3810. Light from the interposer 3810 may be transferred from the interposer waveguide 3834 to the second waveguide 3832 of the second subcircuit 3804 with minimal power loss. For example, loss for light transfer can be as low as −0.1 dB or lower. In some embodiments, acceptable levels of power loss can include 3 dB or lower, 2 dB or lower, 1 dB or lower, etc. In some examples, alignment of the components can be performed via lithographically-defined microstructures on each component (e.g., the first and second subcircuit 3802, 3804 and the interposer 3810), irrespective of the roughness or inaccuracy of the coarse cuts defining the sides of the components.

Referring again to FIG. 38, in some embodiments, an exemplary adiabatic coupling structure can include two portions (e.g., halves) of an adiabatic optical waveguide coupler (e.g., the interposer 3810). Each portion of the coupler can be fabricated within a separate substrate (e.g., within a separate photonic integrated subcircuit, interposer, or any other component) parallel to an outside surface, and the two substrates can be brought together in a face-to-face orientation and fixed together (e.g., permanently or semi-permanently). In some embodiments, the mated pair can form a low-loss optical path from component to component, enabling efficient assembly of modular photonic circuits such as those described in the “Assembly Alignment and Packaging” section above. In this configuration, a coupling gap 3850 between the waveguides 3802, 3804, 3810 can be formed from the interface between the flat component pair surfaces. In some examples, this gap 3850 may be open (e.g., vacuum, air, or inert gas) or backfilled with an optical index-matching material (e.g., referring to the gap 3850 shown FIG. 38). In one example, the configuration of each portion of the coupler (e.g., interposer 3810) may be tailored for different optical material systems including but not limited to silicon, silicon dioxide, silicon nitride, compound semiconductors and oxides, optical glass, engineered polymers, photoresists, diamond, garnet, or sapphire. In some examples, in contrast to existing photonic interposer configurations (also referred to as “photonic circuit boards”), the example configurations presented herein may not necessarily employ free-space optical components such as lenses or mirrors to transfer light between a photonic chip (e.g., photonic integrated subcircuit) and an interposer. Instead, some embodiments presented herein can preserve optical waveguide behavior throughout the system, including couplings between photonic chips 3802, 3804 and interposers 3810. In some embodiments, this can provide a lower optical loss coupling and/or provide the advantage of preserving optical polarization throughout the total system (e.g., an integrated photonic assembly 3800). In some embodiments, one portion of the optical coupler can include an optical chiplet (e.g., photonic integrated subcircuits 3802, 3804, 3810) as described in the “Assembly Alignment and Packaging” section above. In some embodiments, a second portion of the optical coupler may include (a) a standardized mass-produced interposer, where one interposer can be inserted between every photonic integrated subcircuit pair; (b) a custom circuit-specific interposer which can provide monolithically fabricated couplers for all photonic integrated subcircuits in an integrated photonics assembly; (c) a functional photonic integrated subcircuit flipped upside down (e.g., interposer 3810 of FIG. 38); and/or (d) any other photonic integrated subcircuit capable of implementing a vertical adiabatic coupling into its waveguide layer(s).

FIG. 39 shows a top view schematic of the example subcircuit-interposer-subcircuit coupling illustrated in FIG. 38. Referring to FIG. 39, a X-Y axis cross-sectional view of the subcircuit-interposer-subcircuit in FIG. 38 is presented, according to some embodiments. FIG. 39 shows an example optical waveguide configuration for light transfer for a subcircuit-interposer-subcircuit coupling. As shown, structures described in FIG. 38 can correspond to similar or the same structures described in FIG. 39. For example, first and second subcircuits 3902, 3904 can correspond to first and second subcircuits 3802, 3804 of FIG. 38. As shown, in some embodiments, the first subcircuit 3902 can include the first waveguide 3930 and the second subcircuit 3904 can include the second waveguide 3932. In some embodiments, the first waveguide 3930 can include a first taper 3940 (also referred to as a “transition”) and the second waveguide 3932 can include a second taper 3940. In some embodiments, as shown, the interposer 3910 can be disposed between and/or overlapping the first and second waveguides 3930, 3932, where the interposer 3910 can include the interposer waveguide 3934. In some embodiments, the interposer waveguide 3934 can include third and fourth tapers 3944, 3946. In some embodiments, the first taper 3940 can overlap the third taper 3944 and the second taper 3942 can overlap the fourth taper 3946. In some embodiments, the overlap between the first taper 3940 and the third taper 3944 can correspond a first adiabatic transition 3970 (e.g., an adiabatic transition between the first subcircuit 3902 and the interposer 3910). In some embodiments, the overlap between the second taper 3942 and the fourth taper 3946 can correspond to a second adiabatic transition 3972 (e.g., an adiabatic transition between the second subcircuit 3904 and the interposer 3910). The optical configuration of FIG. 39 can be an example of ideal subcircuit-interposer-subcircuit coupling. In some embodiments, the tapered waveguide structures shown in FIG. 39 can be optimized to smoothly transition guided light to the overlapping taper with minimal loss and high tolerance to lateral misalignment.

Referring to FIGS. 38 and 39, in some embodiments, alignment of between two or more components (e.g., photonic integrated subcircuits and/or interposers) can be performed with respect to microstructures which can be lithographically defined in one or more dimensions. In some embodiments, so long as most or all features are placed with sufficient margin from the design reticle edge, the technique may not require adjustments for inaccurate placement of a die edge during singulation of photonic integrated subcircuits, nor for roughness in the die edge due to standard die-sawing processes. In an example, a typical dicing accuracy can be approximately +/−10 microns. Thus, in some embodiments, passive mechanical alignment is performed using fixed features defined between each optical component, without requiring any sliding mates and/or additional sliding features. In some embodiments, tapered waveguides can be formed with sufficient width to reduce sensitivity to in-plane (e.g., x-y) misalignments, reducing the tolerance required of in-plane passive alignment structures compared with typical butt-coupling or as in edge-coupled chip-to-fiber systems.

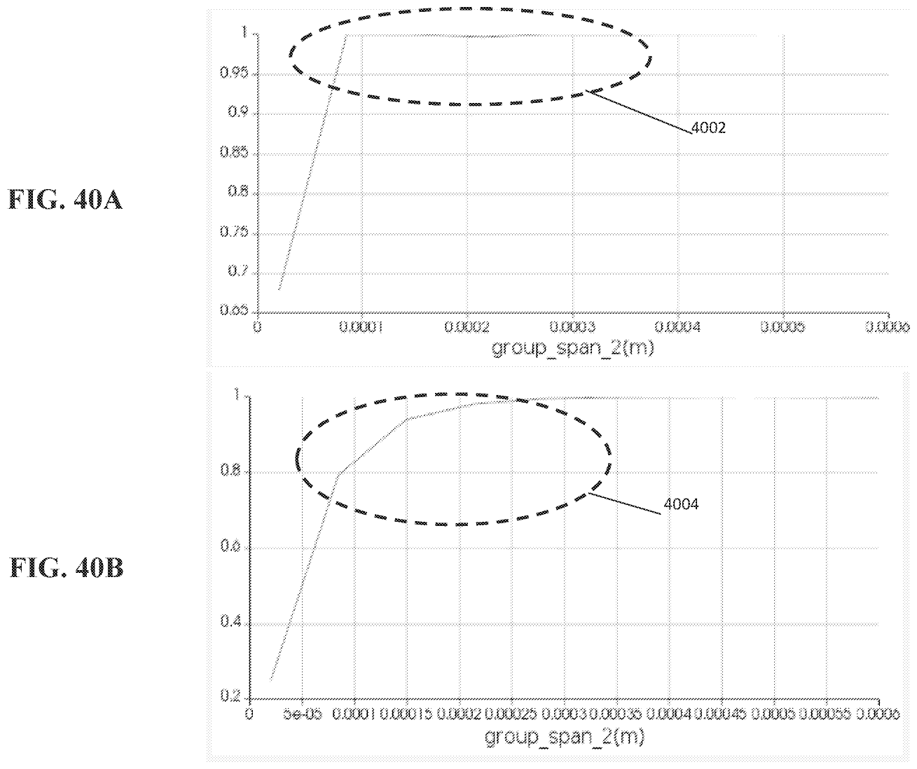

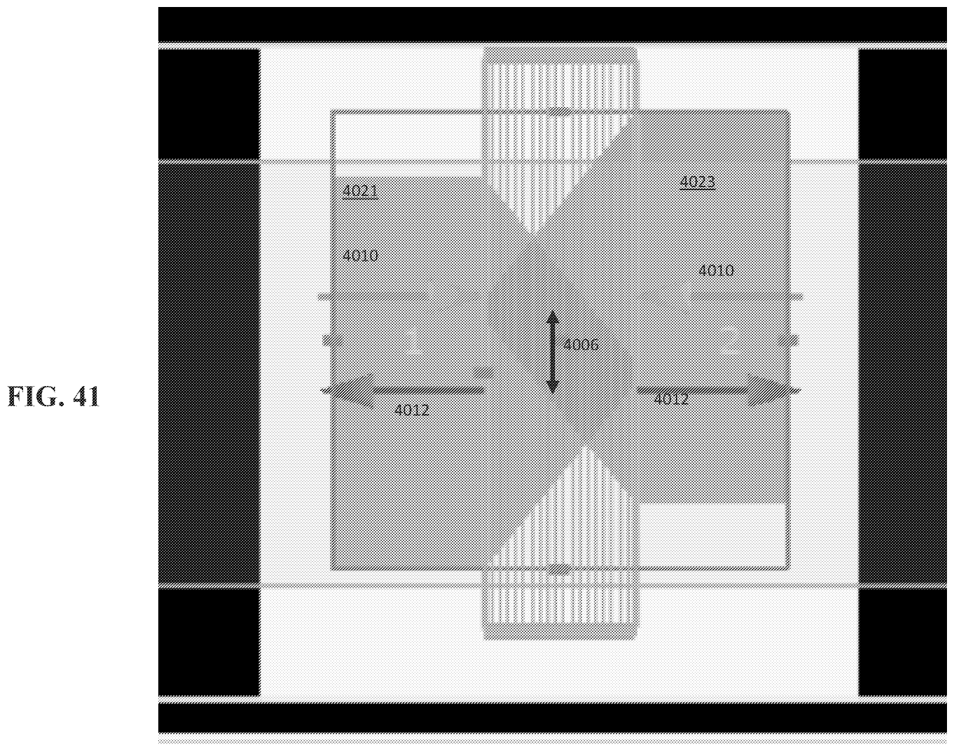

FIGS. 40A-40B provide exemplary data for an ideal configuration, as shown in FIG. 39, and a non-ideal case (e.g., misaligned waveguide), as show in FIG. 41. Referring to FIG. 40A-41, exemplary data and representation of an ideal and non-ideal waveguide alignment configuration are presented, according to some embodiments. FIG. 40A shows a graph depicting a first light transmission 4002 for a subcircuit-interposer-subcircuit having ideal alignment, for 100% coupling for a 100-micron waveguide taper length. FIG. 40B shows a graph depicting light transmission 4004 for a subcircuit-interposer-subcircuit having 0.5 micron misalignment, for 100% coupling for a 300-micron waveguide taper length. FIG. 40A shows the coupling efficiency as a function of taper length in the case of no misalignment while FIG. 40B shows a similar case but with misalignment. In both cases, 100% of the optical power can be transferred if the taper length is 300 microns long. A shorter taper length of 100 microns would give 1 dB coupling loss at 0.5 micron die misalignment. In some embodiments, therefore, there may be no disadvantage of making a taper length 300 microns long other than a need to add more subcircuit footprint (e.g., area or volume). In an example, referring to FIG. 40B, the x-axis shows a taper length of 0.0003 m (e.g., 300 microns) and that the optical transmission reaches 1 (e.g., 100%) on the y-axis for 0.0003 on the x-axis corresponding (e.g., corresponding to the 300 micron taper length). Referring to FIG. 41, an exemplary diagram for misaligned and/or offset waveguides 4006 is shown. As shown in FIG. 40A, the first light transmission 4002 is optimized. As shown in FIG. 40B, the second light transmission 4004 includes power losses as compared to the first transmission 4002. Referring to FIG. 41, light coming into the taper (as indicated by arrow 4010) and leaving the taper (as indicated by arrow 4012) between a first waveguide 4021 and a second waveguide 4023 is shown, where the misaligned portion 4006 represents the 0.5 micron misalignment (the result of which is illustrated in FIG. 40B).

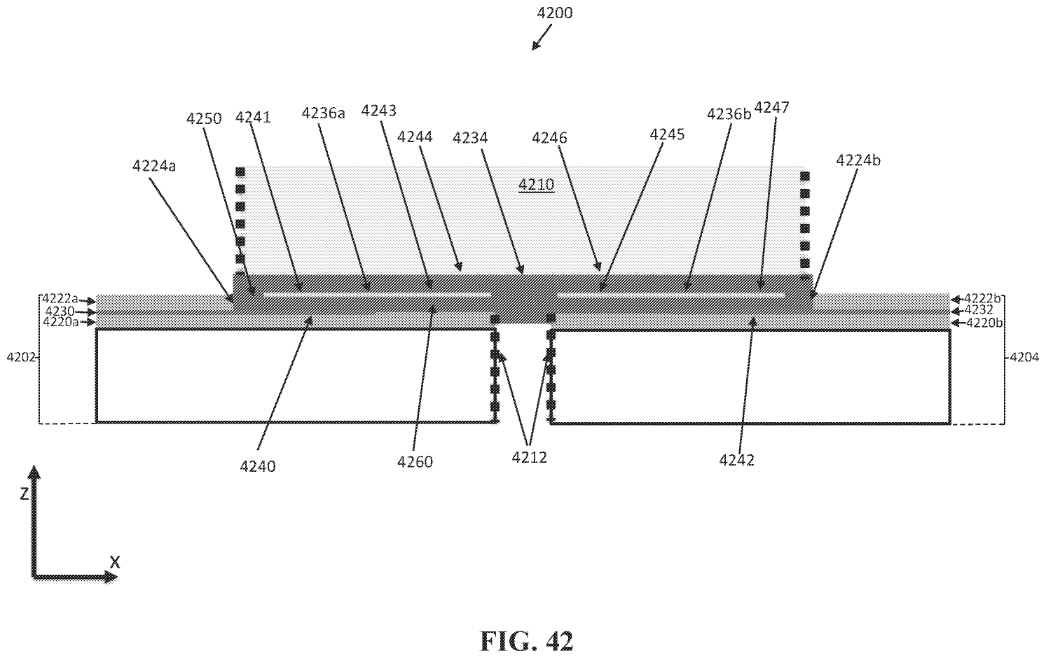

Referring to FIG. 42, a X-Z axis cross-sectional view of a subcircuit-interposer-subcircuit coupling having an intermediate waveguide is presented, according to some embodiments. In some embodiments, the subcircuit-interposer-subcircuit coupling 4200 can include a first photonic integrated subcircuit 4202, an interposer 4210, and a second photonic integrated subcircuit 4204. In some embodiments, the interposer 4210 can be disposed over the first and second subcircuits 4202, 4204. In some examples, the interposer 4210 can be disposed over a portion of the first and/or second subcircuits 4202, 4204 as shown in FIG. 42.

Referring again to FIG. 42, in some embodiments, first subcircuit 4202 can include a first oxide layer 4220a, a first waveguide 4230 and a second oxide layer 4222a disposed over the first waveguide 4230. In some embodiments, second subcircuit 4204 can include the first oxide layer 4220b, a second waveguide 4232, and the second oxide layer 4222b disposed over the second waveguide 4232. In some embodiments, the first oxide layers 4220a, 4220b (collectively referred to as 4220) can each be referred to as a “bottom oxide layer” and the second oxide layers 4222a, 4222b (collectively referred to as 4222) can each be referred to as a “top oxide layer”. As shown, in some embodiments, a top oxide opening 4224a can be disposed between the second oxide layer 4222a of the first subcircuit 4202 and the interposer 4210. In some embodiments, a top oxide opening 4224b can be disposed between the second oxide layer 4222b of the second subcircuit 4204 and the interposer 4210.

Referring still to FIG. 42, in some embodiments, the interposer 4210 can an interposer waveguide 4234 and intermediate waveguides 4236a, 4236b (collectively referred to as 4236). In some embodiments, the interposer 4210 can include a transparent interposer. In some embodiments, an adhesive layer 4260 can be disposed in a gap 4250 (e.g., a coupling gap) between the interposer 4210 and the first and second subcircuits 4202, 4204. In some embodiments, the adhesive layer 4260 can be disposed between the interposer waveguide 4234 and the first and second waveguides 4230, 4232. In some examples, the adhesive layer 4260 can include an index matching adhesive fill.

In the illustrated embodiment, the first waveguide 4230 can include a first tapered portion 4240, the second waveguide 4232 can include a second tapered portion 4242 and the interposer waveguide 4234 can include a third and fourth tapered portion 4244, 4246. The intermediate waveguide 4236a has a fifth taper 4241 and sixth taper 4243 and intermediate waveguide 4236b has a seventh taper 4245 and eighth taper 4247. In some embodiments, the first and second subcircuits 4202, 4204 and the interposer 4210 can include cut portions 4212.

Referring again to FIG. 42, in an example, for a silicon-silicon vertical coupler, a vertical (z-axis) coupling gap 4250 can be in a range of approximately 200-500 nm. In one example, an alternative to directly fabricating a joint including sub-micron gaps can be to incorporate an intermediate “escalator” waveguide in a thicker interface layer as shown. In some embodiments, the escalator waveguide structure of the interposer 4210 can be fabricated atop an interposer prior to assembly. In some examples, the escalator waveguide structure of the interposer 4210 can be patterned after assembly, for example, by performing two-photon 3-D printing through a transparent interposer into a primed photopolymer filler. In some embodiments, the subcircuit-interposer-subcircuit coupling can also be referred to as a variant coupler. In some embodiments, the intermediate waveguides 4236 can be microfabricated within a polymer optical adhesive layer. In some examples, the microfabricated within a polymer optical adhesive layer can serve to guide light between the subcircuits 4202, 4204 and the interposer 4210 when the interface material is thicker than an ideal optical coupling gap.

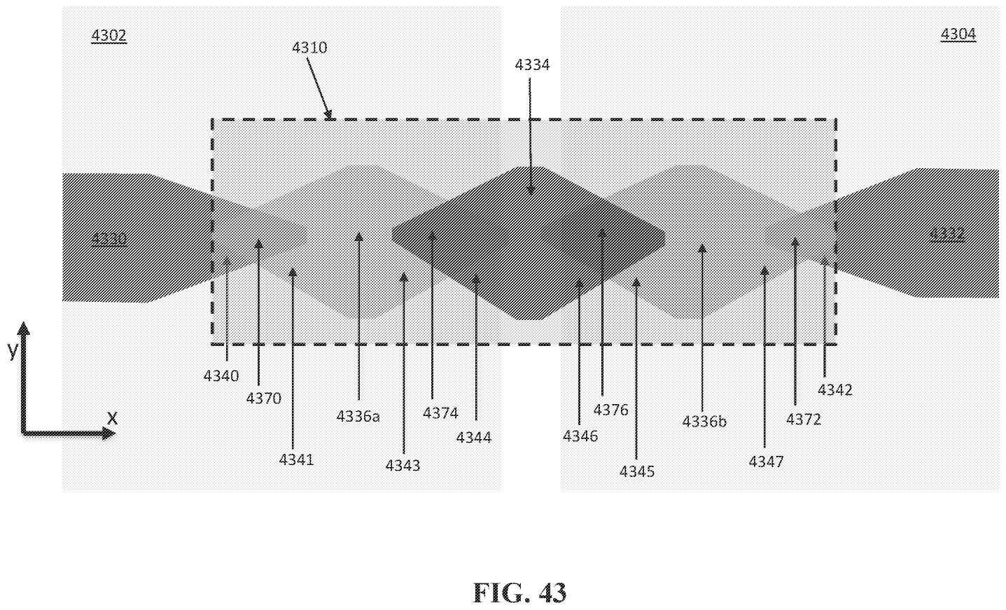

Referring to FIG. 43, a X-Y axis cross-sectional view of the subcircuit-interposer-subcircuit in FIG. 42 is presented, according to some embodiments. FIG. 43 shows an optical waveguide configuration for light transfer for a subcircuit-interposer-subcircuit coupling having an intermediate waveguide. As shown, structures described in FIG. 42 can correspond to similar or the same structures described in FIG. 43. For example, first and second subcircuits 4302, 4304 can correspond to first and second subcircuits 4202, 4204 of FIG. 42. As shown, in some embodiments, the first subcircuit 4302 can include the first waveguide 4330 and the second subcircuit 4304 can include the second waveguide 4332. In some embodiments, the first waveguide 4330 can include a first taper 4340 and the second waveguide 4332 can include a second taper 4342. In some embodiments, as shown, the interposer 4310 can be disposed between the first and second waveguides 4330, 4332, where the interposer 4310 includes the interposer waveguide 4334 and intermediate waveguides 4336a, 4336b (collectively referred to as 4336). In some embodiments, the interposer waveguide 4334 can include a third and fourth taper 4344, 4346. In some embodiments, the intermediate waveguide 4336a can include a fifth and sixth taper 4341, 4343. In some embodiments, the intermediate waveguide 4336b can include a seventh and eighth taper 4345, 4347. In some embodiments, the first taper 4340 can overlap the fifth taper 4341 and the second taper 4342 can overlap the eighth taper 4347. The sixth taper 4343 can overlap with the third taper 4344. The fourth taper 4346 can overlap with the seventh taper 4345. In some embodiments, the overlap between the first taper 4340 and the fifth taper 4341 can correspond a first adiabatic transition 4370 (e.g., the adiabatic transition between the first subcircuit 4302 and the interposer 4310). In some embodiments, the overlap between the second taper 4342 and the eighth taper 4347 can correspond a second adiabatic transition 4372 (e.g., an adiabatic transition between the second subcircuit 4304 and the interposer 4310). In some embodiments, the overlap between the sixth taper 4343 and the third taper 4344 can correspond to an adiabatic transition 4374. In some embodiments, the overlap between the fourth taper 4346 and the seventh taper 4345 can correspond to an adiabatic transition 4376.

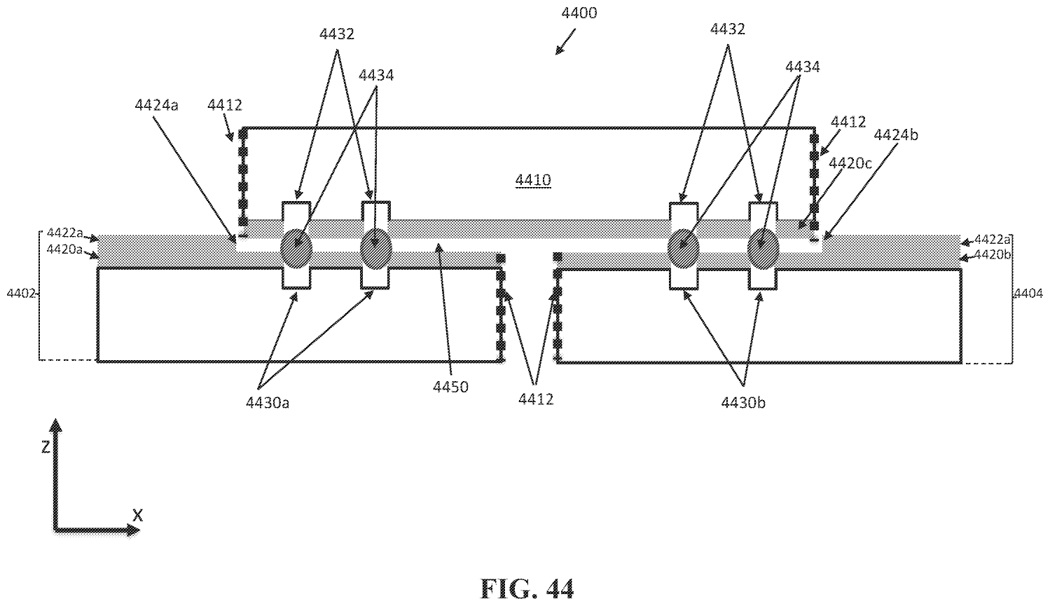

Referring to FIG. 44, a X-Z axis cross-sectional view of a subcircuit-interposer-subcircuit coupling having passive mechanical coupling is presented, according to some embodiments. In some embodiments, the subcircuit-interposer-subcircuit coupling 4400 can include a first photonic integrated subcircuit 4402, an interposer 4410 and a second photonic integrated subcircuit 4404. In some embodiments, the interposer 4410 can be disposed over the first and second subcircuits 4402, 4404. In some examples, the interposer 4410 can be disposed over a portion of the first and/or second subcircuits 4402, 4404 as shown in FIG. 44.

Referring again to FIG. 44, in some embodiments, first subcircuit 4402 can include a first oxide layer 4420a and a second oxide layer 4422a disposed over the first subcircuit 4402. In some embodiments, second subcircuit 4404 can include the first oxide layer 4420b and the second oxide layer 4422b disposed over the second subcircuit 4404. In some embodiments, the first oxide layers 4420a, 4420b (collectively referred to as 4420) can also be referred to as a “bottom oxide layer”. In some embodiments, the second oxide layers 4422a, 4422b (collectively referred to as 4422) can also be referred to as a “top oxide layer”. As shown, in some embodiments, a top oxide opening 4424a can be disposed between the second oxide layer 4422a of the first subcircuit 4402 and the interposer 4410. In some embodiments, a top oxide opening 4424b can be disposed between the second oxide layer 4422b of the second subcircuit 4404 and the interposer 4410. In some embodiments, the first subcircuit 4402 can include first trench structures 4330a. In some embodiments, the second subcircuit 4404 can include first trench structures 4330b. The first trench structures 4430a, 4430b, can collectively be referred to as first trench structures 4430.

Referring yet again to FIG. 44, in some embodiments, the interposer 4410 can include a first oxide layer 4420c and second trench structures 4432. In some embodiments, the interposer 4410 can include a third photonic integrated subcircuit which has been flipped relative to the first and second subcircuits. In some embodiments, an adhesive layer can be disposed in a gap 4450 (e.g., a coupling gap) between the interposer 4410 and the first and second subcircuits 4402, 4404. In some embodiments, the first and second subcircuits 4402, 4404 and the interposer 4410 can include cut portions 4412.

Referring yet again to FIG. 44, in some embodiments, the first and second trench structures 4430, 4432 can be formed using a lithography process. In some embodiments, the first and second trench structures 4430, 4432 can have a cylindrical shape, ovoid shape, pyramidal shape, or other shape. In some embodiments, beads 4434 (e.g., micro-beads) can be used as spacers within the first and second trench structures 4430, 4432. In some embodiments, beads 4434 can be aligned to and/or placed in the first and second trench structures 4430, 4432. In some embodiments, the beads 4434 can be any shape (e.g., not limited to a bead shape). In some embodiments, the beads 4434 can be in a cylindrical shape, cone shape, tube shape, and/or other shape. In some embodiments, the trench structures 4430, 4432 can have a diameter which is smaller than a diameter of the beads 4434. In some embodiments, the first and second trench structures 4430, 4432 can also be referred to as trench features. In some embodiments, the beads 4434 can also be referred to as micro-structures. In some embodiments, the beads 4434 can provide for a Z-axial alignment of the interposer 4310, where the beads 4434 can stop and/or provide a stand and/or Z-axis stopper for the interposer 4310.

Referring again to FIG. 44, in some embodiments, one of several systems and methods that can accomplish a direct mechanical alignment of photonic integrated subcircuits to adiabatic interposers is shown. In some embodiments, trenches or pits 4430, 4432 can be fabricated in one or both components (e.g., both of the photonic integrated subcircuits 4402, 4404 and interposer 4410/adiabatic interposer), such as by etching or drilling. In some embodiments, precision beads 4434 can be placed in the trench structures 4430, 4432 (e.g., holes). In some examples, the beads 4434 can be placed by precision pick-and-place, stochastic distribution, electrostatic affinity, or other by means. In some embodiments, a second component (e.g., interposer 4410) can be placed atop the beads 4434 providing for a built-in an alignment system. In some embodiments, the alignment system can be a kinematic system. In some examples, the alignment system can include (i) rigid balls placed in a v-grooves including six constraints per mate; (ii) may include an elastic averaging system, where a larger number of more flexible beads can jointly deform to align the system; or (iii) may include a hybrid of these embodiments. In some embodiments, a clamping force can be applied and adhesive can be introduced to a coupling gap 4350 to form a permanent or semi-permanent bond. In one example, the six axes of alignment (x, y, z, roll, pitch, yaw) can be defined by the geometry and mechanics of the subcircuit-micro-bead-subcircuit system. In some embodiments, a passive mechanical coupling scheme which may be used to achieve six-axis alignment between the subcircuits 4402, 4404 and interposer 4410.

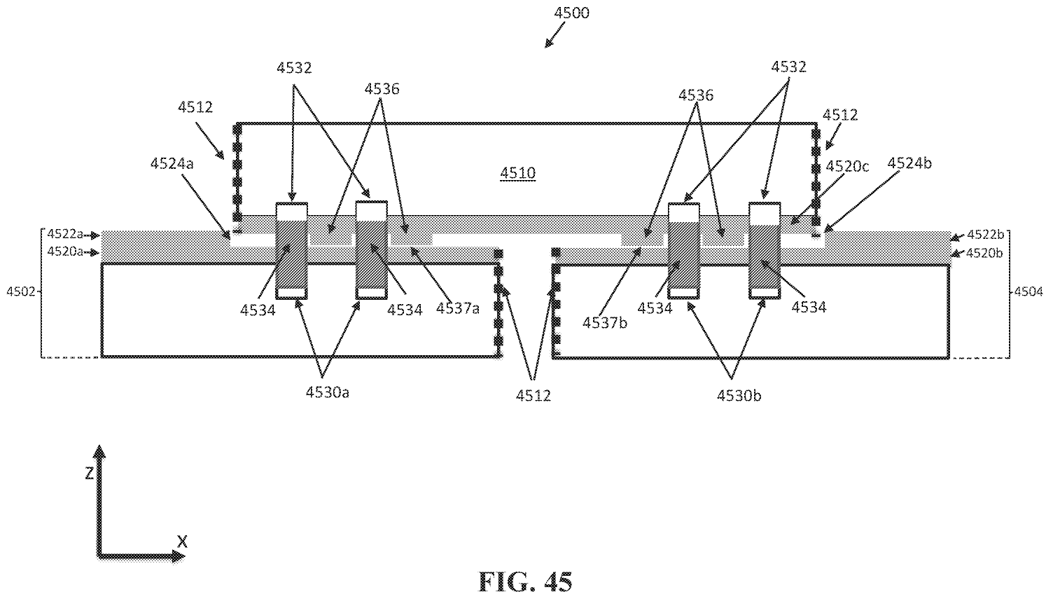

Referring to FIG. 45, a X-Z axis cross-sectional view of a subcircuit-interposer-subcircuit coupling having passive mechanical coupling is presented, according to some embodiments. In some embodiments, the subcircuit-interposer-subcircuit coupling 4500 can include a first photonic integrated subcircuit 4502, an interposer 4510 and a second photonic integrated subcircuit 4504. In some embodiments, the interposer 4510 can be disposed over the first and second subcircuits 4502, 4504. In some examples, the interposer 4510 can be disposed over a portion of the first and/or second subcircuits 4502, 4504 as shown in FIG. 45.

Referring again to FIG. 45, in some embodiments, first subcircuit 4502 can include a first oxide layer 4520a and a second oxide layer 4522a disposed over the first subcircuit 4502. In some embodiments, second subcircuit 4504 can include the first oxide layer 4520b and the second oxide layer 4522b disposed over the second subcircuit 4504. In some embodiments, the first oxide layers 4520a, 4520b (referred collectively as 4520) can also be referred to as a “bottom oxide layer”. In some embodiments, the second oxide layer 4522a, 4522b (referred collectively as 4522) can also be referred to as a “top oxide layer”. For example, the bottom oxide layer can be thermal oxide fabricated using a silicon-on-insulator (SOI) smart cut process. The top oxide layer can be deposited in the CMOS fab during wafer fabrication. As shown, in some embodiments, a top oxide opening 4524a can be disposed between the second oxide layer 4522a of the first subcircuit 4502 and the interposer 4510. In some embodiments, a top oxide opening 4524b can be disposed between the second oxide layer 4522b of the second subcircuit 4504 and the interposer 4510. In some embodiments, the first subcircuit 4502 can include first trench structures 4530a. In some embodiments, the second subcircuit 4504 can include first trench structures 4530b. In some embodiments, the first trench structures 4530a, 4530b can be collectively referred to as first trench structures 4530.

Referring yet again to FIG. 45, in some embodiments, the interposer 4510 can include a first oxide layer 4520c and second trench structures 4532. In some embodiments, the interposer 4510 can include a third photonic integrated subcircuit which has been flipped relative to the first and second subcircuits. In some embodiments, an adhesive layer can be disposed in a gap 4550 (e.g., a coupling gap) between the interposer 4510 and the first and second subcircuits 4502, 4504. In some embodiments, the first and second subcircuits 4502, 4504 and the interposer 4510 can include cut portions 4512.

Referring yet again to FIG. 45, in some embodiments, the first and second trench structures 4530, 4532 can be formed using a lithography process. In some embodiments, the first and second trench structures 4530, 4432 can have a cylindrical shape, ovoid shape, pyramidal shape, or among other shapes. In some embodiments, rods 4434 can be used as spacers within the first and second trench structures 4430, 4432. In some embodiments, rods 4434 can be aligned to and/or placed in the first and second trench structures 4430, 4432. In some embodiments, the rods 4434 can be any shape (e.g., not limited to a rod shape). In some embodiments, the rods 4434 can be in a cylindrical shape, tube shape, rectangular shape, a shape of a fiber, and/or other shape. In some embodiments, the rods 4434 can include a fiber. In some embodiments, the rods 4434 can be in any shape that does not constrain a translational symmetry in the z-direction. In some embodiments, the rods 4434 can also be referred to as trench alignment structures. In some embodiments, the interposer 4510 can include pedestals 4534 configured to provide a z-axial distance and/or alignment from the first and second subcircuits 4502, 4504.

Referring again to FIG. 45, in some embodiments, another system and/or method to enable mechanical alignment of photonic integrated subcircuits to adiabatic interposers is shown. In some embodiments, trenches or pits 4530, 4532 can be fabricated in the photonic integrated subcircuits 4502, 4504, and complementary mating rods/pillars 4534 and vertical stops 4536 can be fabricated atop the coupler (e.g., interposer 4510) dies. In some embodiments, the rods/mating pillars 4534 can be formed from a comparatively compliant polymer, and can be fabricated using photolithography and/or micro-imprint processing during a wafer-scale process flow similar to as performed for a standardized interposer die. In some embodiments, vertical stop features and/or pedestals 4536 can be formed from selective deposition and etching of an the first oxide layer 4520 (e.g., first oxide layer 4520c), by exposure of bare silicon or other waveguide layer, or any other microfabrication process flow. In some embodiments, the trenches/hole features 4530, 4532, and the rod/pillar features 4534 can provide in-plane (e.g., x-y axis) alignment using the principle of elastic averaging, while the vertical stops and/or pedestals 4536 can include a flat-flat contact and provide an out-of-plane (e.g., z-axis) alignment. FIG. 45 shows a passive mechanical coupling scheme which may be used to achieve six-axis alignment between the subcircuits 4502, 4504 and the interposer 4510. In some embodiments, trench features 4530, 4532 can be lithographically defined within the subcircuits 4502, 4504, and a set of mating pegs, pedestals and/or flats 4536 can be lithographically defined in the complementary interposer 4510. In some embodiments, the first subcircuit 4502 can include an exposed reference surface 4537a. In some embodiments, the second subcircuit 4504 can include an exposed reference surface 4537b. In some embodiments, the exposed reference surfaces 4537a, 4537b can collectively be referred to as exposed reference surfaces 4537. In some embodiments, the rods/pegs 4534 can mate with first and second trench features 4530, 4532 to provide horizontal alignment, while the pedestals/flats 4536 can mate and/or come into contact with the exposed reference surfaces 4537 to provide vertical alignment.

### Precision Mechanical Alignment for Optical Coupling

Example methods and systems for the alignment and/or coupling of photonic integrated subcircuits to enable the formation of integrated photonic assemblies are described. In some examples, methods and systems including surface coupling (e.g., edge coupling and top coupling) of photonic integrated subcircuits are presented. In one example, edge coupling can include coupling vertical surfaces (also referred to as side surfaces) and/or edges of two photonic integrated subcircuits together (e.g., coupling in a horizontal configuration). In some examples, top coupling can include coupling a top and a bottom surface of two photonic integrated subcircuits (e.g., coupling in a vertical or stacked configuration). In some embodiments, the coupling of photonic integrated subcircuits can include optically coupling the photonic integrated subcircuits. In an example, a first light path (e.g., first waveguide) of a first photonic subcircuit can be aligned and/or optically coupled to a second light path (e.g., second waveguide) of a second photonic integrated subcircuit. In some examples, optically coupling the photonic integrated subcircuits can include aligning together a first photonic integrated subcircuit to a second photonic integrated subcircuit, where the first light path of the first photonic integrated subcircuit is optically coupled (e.g., aligned) to the second light path of the second photonic integrated subcircuit.

Coupling (e.g., edge coupling, butt coupling, and/or top/bottom coupling) of photonic integrated subcircuits can include aligning light emitted from a surface of one photonic integrated subcircuit for collection into a corresponding surface of an adjoining photonic integrated subcircuit. In some embodiments, such a coupling technique can require that the alignment between photonic integrated subcircuits account for uncertainty and/or the precision in the position and/or angle of the photonic integrated subcircuit surfaces with respect to the optical structures (e.g., light paths and/or waveguides) contained within the photonic integrated subcircuits. In some examples, uncertainty of and/or the precision of the position and/or angle of the photonic integrated subcircuit surfaces can be due to potential inaccuracies in fabrication processes during fabrication (e.g., such as die singulation processes, die-sawing of the photonic integrated subcircuits and/or integrated photonic assemblies). In some examples, the uncertainty of and/or the precision of the position and/or angle of the photonic integrated subcircuit surfaces can increase the complexity and potentially reduce the efficacy of alignment techniques for forming integrated photonic assemblies.

As described herein, examples of coupling subcircuits (e.g., first and second subcircuits) via respective cartridge structures (e.g., first and second cartridges) are presented, where each cartridge structure can include a corresponding alignment feature (e.g., first and second alignment features). In some examples, a first alignment feature of a first cartridge and a second alignment feature of a second cartridge can be configured to enable alignment between a first photonic integrated subcircuit and second photonic integrated subcircuit. In the same example, when the first photonic integrated subcircuit is aligned to the second photonic integrated subcircuit, a first light path of the first photonic integrated subcircuit can be optically coupled to a second light path of the second photonic integrated subcircuit.

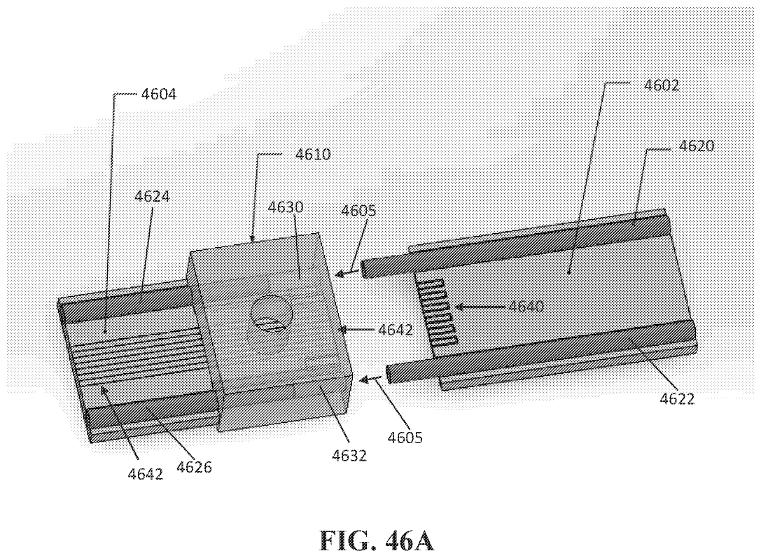

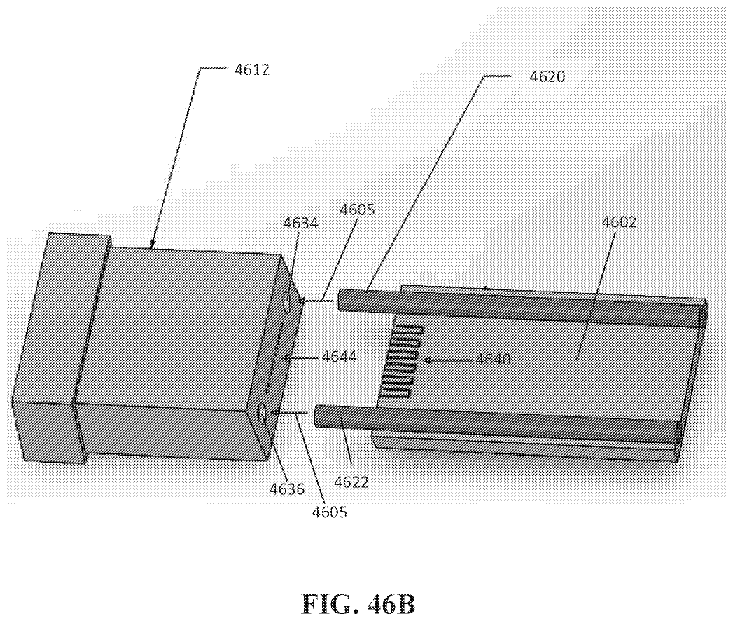

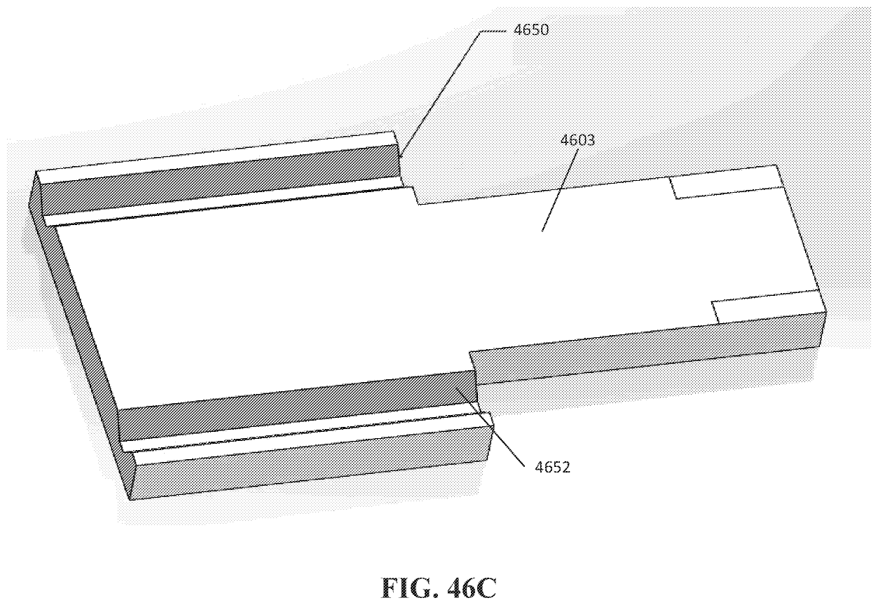

Referring to FIGS. 46A-46C, exemplary structures for coupling photonic integrated subcircuits together via a subcircuit coupling structure, ferrule, and/or an adapter are presented, according to some embodiments. In some embodiments, FIG. 46A shows a first cartridge and a second cartridge to be coupled together via a subcircuit coupling structure. Each cartridge can include a corresponding photonic integrated subcircuit. In one example, the first cartridge can include a first photonic integrated subcircuit and the second cartridge can include a second photonic integrated subcircuit. FIG. 46B shows a first cartridge to be coupled with a ferrule. FIG. 46C shows a first cartridge prior to installation of alignment features. As shown, FIGS. 46A-46C present exemplary structures for edge-to-edge and/or surface-to-surface coupling of a cartridge including photonic integrated subcircuits, in which the coupled cartridges form integrated photonic assemblies.

Referring to FIG. 46A, a first cartridge and a second cartridge to be coupled together via a subcircuit coupling structure is presented, according to some embodiments. In some examples, the first cartridge 4602 can be coupled (as indicated by arrow 4605) to the second cartridge 4604 via a subcircuit coupling structure 4610, where the subcircuit coupling structure 4610 can include alignment features 4624, 4626 configured to receive the alignment features 4620, 4622, 4624, 2626 of the first and second cartridges 4602, 4604. In one example, the first and second cartridges 4602, 4604 are mechanical structures configured to hold and/or house at least one photonic integrated subcircuit and at least one alignment feature. In some examples, the first and/or second cartridges 4602, 4604 can be referred to as carriers or mechanical carriers.

Referring again to FIG. 46A, in some embodiments, the first cartridge 4602 can include a first alignment feature 4620 and a second alignment feature 4622. In some embodiments, the second cartridge 4604 can include a third alignment feature 4624 and a fourth alignment feature 4626. In some examples, the first and second cartridges 4602, 4604 each can include one or more alignment features. In some embodiments, the alignment features 4620, 4622, 4624, 4626 can include one or more rods. In some embodiments, the alignment features 4620, 4622, 4624, 4626 can be formed in, but not necessarily limited to, a shape of a rod, as shown in FIG. 46A. In some examples, the alignment features 4620, 4622, 4624, 4626 can be in a rod shape, a cylindrical shape, a cuboid shape, etc.

Referring again to FIG. 46A, in some embodiments, the subcircuit coupling structure 4610 can include corresponding fifth and sixth alignment features 4630, 4632. In some embodiments, the fifth alignment feature 4630 can include a receiving feature configured to receive the alignment features 4620 of the first cartridge 4602 and/or alignment feature 4624 of the second cartridge 4602. In some embodiments, the sixth alignment feature 4632 can include a receiving feature configured to receive the alignment features 4622 of the first cartridge 4602 and/or alignment feature 4626 of the second cartridge 4602. In some examples, the fifth and/or sixth alignment features 4630, 4632 can include a groove, a hole, receptacle, and/or a cavity. In some embodiments, the alignment features 4620, 4622, 4624, 4626 of the first and second cartridges 4602, 4604 and/or the alignment features 4630, 4632 of the subcircuit coupling structure 4610 can be configured to enable alignment between the first photonic integrated subcircuit of the first cartridge 4602 and the second photonic integrated subcircuit of the second cartridge 4604. In some embodiments, the subcircuit coupling structure 4610 can be referred to as a subcircuit coupling adapter. In some embodiments, the subcircuit coupling structure 4610 can include metal and/or plastic material. In some embodiments, the subcircuit coupling structure 4610 can include a plastic material with low coefficient of thermal expansion that may be manufactured using injection molding. In some examples, the subcircuit coupling structure 4610 can include a steel alloy, among other metals. Although the subcircuit coupling structure 4610 is shown to include two alignment features 4630, 4632, in some embodiments, the subcircuit coupling structure 4610 can include a single alignment feature. In other embodiments, the subcircuit coupling structure 4610 can include three or more alignment features. In some examples, the subcircuit coupling structure 4610 can couple the first and second photonic integrated subcircuits to a fiberoptic array housed within the subcircuit coupling structure 4610.

Referring still again to FIG. 46A, the first and second cartridges 4602, 4604 can be coupled together via the subcircuit coupling structure 4610 to optically couple a first light path 4640 (e.g., first waveguide) of the first photonic integrated subcircuit with a second light path 4642 (e.g., second waveguide) of the second photonic integrated subcircuit. In some embodiments, a port (e.g., input, output, etc.) of the first light path 4640 can be within a side edge of the first photonic integrated subcircuit. In some embodiments, a port (e.g., input, output, etc.) of the second light path 4642 can be within a side edge of the second photonic integrated subcircuit. In some embodiments, a port (e.g., input, output, etc.) of the first light path 4640 can be within a top surface of the first photonic integrated subcircuit and a port (e.g., input, output, etc.) of the second light path 4604 can be within a bottom surface of the second photonic integrated subcircuit.

Referring to FIG. 46B, a first cartridge coupled with a ferrule is presented, according to some embodiments. Coupling 4605 the first cartridge 4602 to the ferrule 4612, or any other type of external adapter, can enable coupling of the first photonic integrated subcircuit to another photonic integrated subcircuit and/or to an integrated photonic assembly via the ferrule adapter (also referred to as “external adapter”). As shown, the first cartridge 4602 can include one or more alignment features 4620, 4622. Although the first cartridge 4602 is shown to include two alignment features 4620, 4622, in some embodiments, the first cartridge 4602 can include a single alignment feature. In other embodiments, first cartridge 4602 can include three or more alignment features. In one example, the first cartridge can include a first alignment feature 4620 and a second alignment feature 4622. In some embodiments, the first cartridge 4602 and/or the first photonic integrated subcircuit can include a first optical path 4640 (e.g., a first waveguide).

Referring again to FIG. 46B, in some embodiments, the ferrule 4612 can include a corresponding third and fourth alignment features 4634, 4636. In some embodiments, the third and/or fourth alignment features 4634, 4636 can include receiving features. In an example, the third and/or fourth alignment features 4634, 4636 can include a hole and/or cavity as shown in FIG. 46B. In some embodiments, the third and/or fourth alignment features 4634, 4636, can be configured to receive the first and second alignment features 4620, 4622 (e.g., the first and second alignment features 4620, 4622 can be inserted into the third and/or fourth alignment features 4634, 4636). In some embodiments, the ferrule 4612 can be referred to as mechanical transfer (MT) ferrule, among other terms. In some embodiments, the ferrule 4612 can include metal and/or plastic material. In some examples, the ferrule 4612 can include plastic manufactured using injection molding. In some examples, the ferrule 4612 can include a steel alloy, among other metals. Although the ferrule 4612 is shown to include two alignment features 4634, 4636, in some embodiments, the ferrule 4612 can include a single alignment feature. In other embodiments, the ferrule 4612 can include three or more alignment features. As shown, the ferrule can include a second optical path 4644 (e.g., a second waveguide). In some examples, the ferrule 4612 can couple the first photonic integrated subcircuit of the first cartridge 4602 to a fiberoptic array (e.g., the second optical path 4644).

Referring to FIG. 46C, a first cartridge prior to installation of one or more alignment features is presented, according to some embodiments. In some embodiments, the first cartridge 4603 can include a first receiving feature 4650 and/or a second receiving feature 4652 for receiving a first alignment feature and/or a second alignment feature. In some examples, the receiving features 4650, 4652 can include a groove, a hole and/or a receptacle. In one example, the receiving features 4650, 4652 can include a v-groove, e.g., as shown in FIG. 46C. In some embodiments, the v-groove can help locate the alignment features to the receiving features 4650, 4652, e.g., help locate a cylindrical rod and/or pin to the first cartridge 4602. In some examples, the receiving features 4650, 4652 can include a triangular groove, rectangular groove, a cylindrical groove, among other grooves and/or shapes.

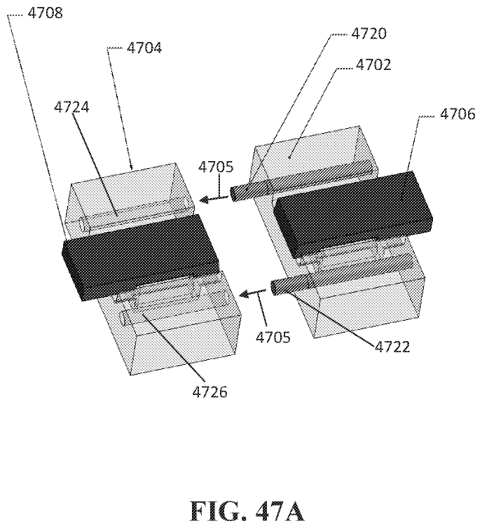

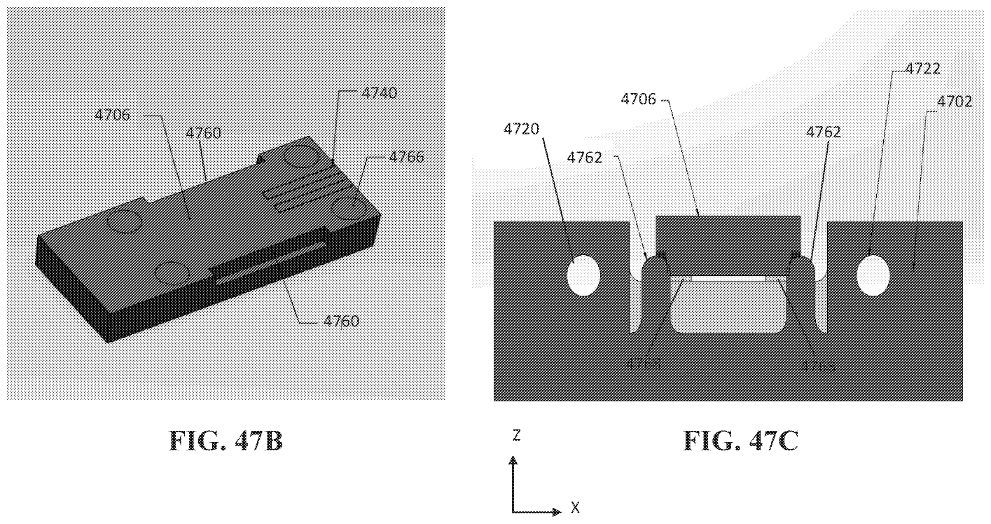

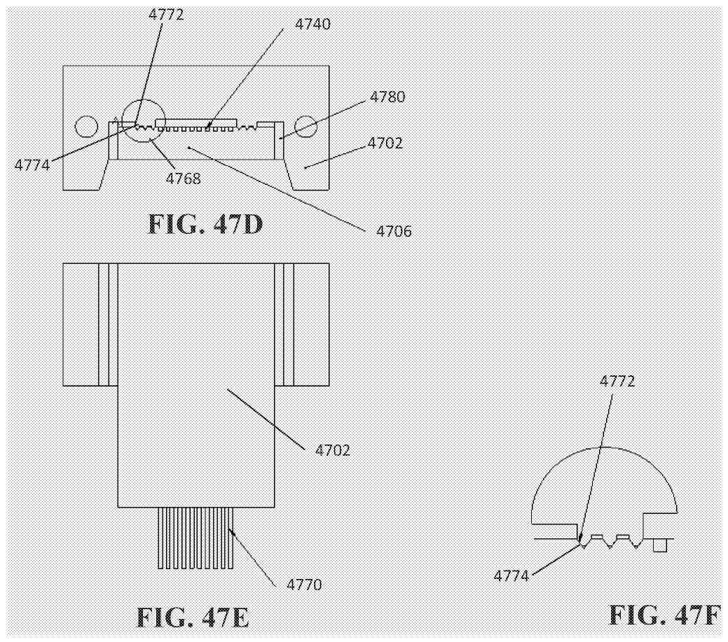

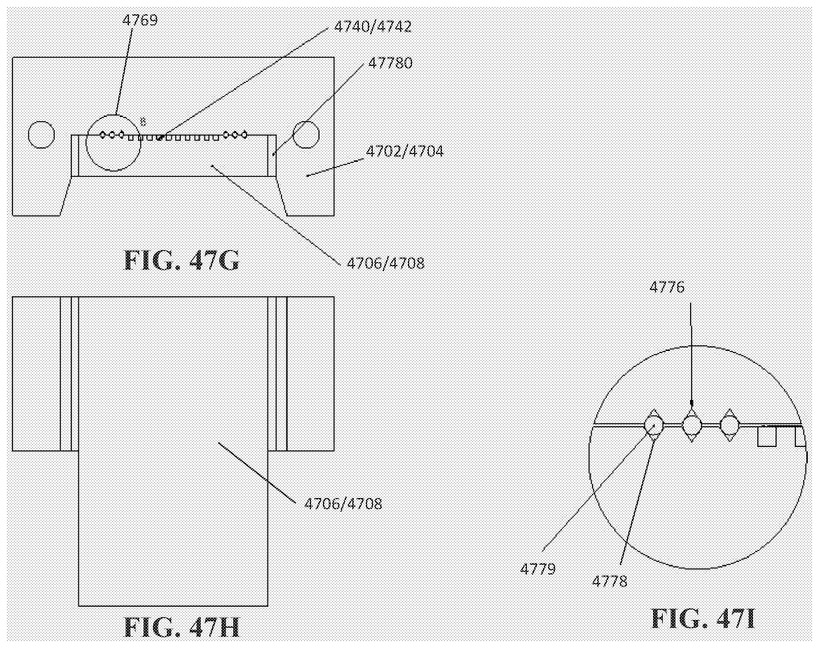

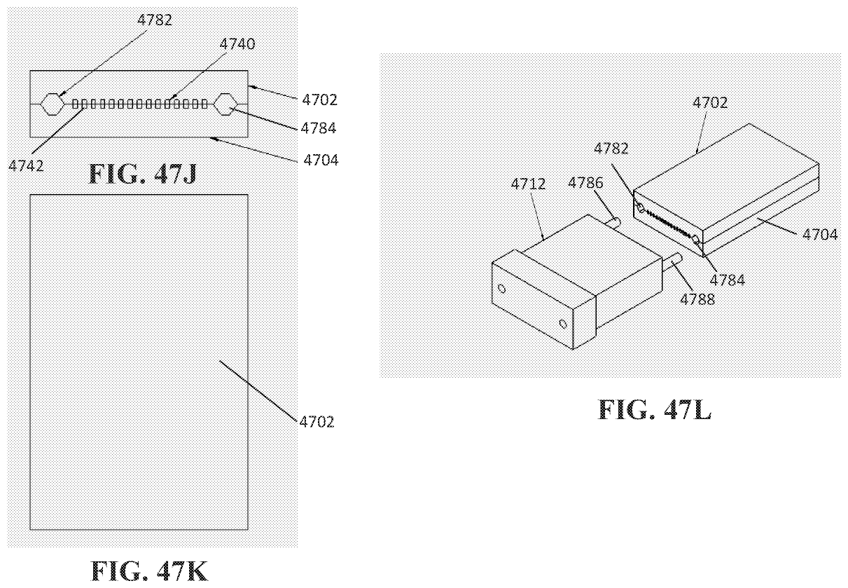

Referring again to FIGS. 46A-46C, in some examples, the first cartridge described above may be coupled to a second cartridge via a subcircuit coupling structure as shown in FIG. 46A. In another example, the first cartridge can be coupled to a ferrule as shown in FIG. 46B. In still another embodiment, a first cartridge (e.g., a male cartridge) can be coupled to a second cartridge (e.g., a female cartridge) as shown and described in FIG. 47 and described below. As described herein, in some embodiments, a photonic integrated subcircuit can be included within and/or part of a cartridge as shown in FIGS. 46A-46C. In some embodiments, the cartridges described in FIGS. 46A-46C can instead be a separate device coupled to a photonic integrated subcircuit, e.g., examples of which are shown in FIG. 47 and described below.

Referring to FIGS. 47A-47C, exemplary structures for coupling photonic integrated subcircuits directly together are presented according to some embodiments. FIG. 47A shows a first cartridge and a second cartridge to be coupled together directly using alignment features. FIG. 47B shows an exemplary photonic integrated subcircuit including trench features configured to enable coupling with corresponding extruded features (shown in FIG. 47C) of a cartridge. FIG. 47C shows a photonic integrated subcircuit coupled to a cartridge via trench features of the photonic integrated subcircuit and extruded features of the cartridge. As shown, FIGS. 47A-47C present exemplary structures for edge-to-edge and/or surface-to-surface coupling of cartridges directly together, each cartridge including a photonic integrated subcircuit, in which the coupled cartridges form integrated photonic assemblies.

Referring to FIG. 47A, a first cartridge and a second cartridge to be coupled together directly using alignment features is presented, according to some embodiments. In contrast to the embodiments shown in FIGS. 46A-46C, FIG. 47A shows the coupling 4705 a first cartridge 4702 to a second cartridge 4704 via alignment features 4720, 4722, 4724, 4726, e.g., the coupling of the first and second cartridges 4702, 4704 directly to each other without the use of an intermediary subcircuit coupling structure (e.g., ferrule). Similar to the cartridges described in FIGS. 46A-46C, the first cartridge 4702 can include and/or carry a first photonic integrated subcircuit 4706 and the second cartridge 4704 can include and/or carry a second photonic integrated subcircuit 4708. As shown, the first cartridge 4702 can include one or more alignment features 4720, 4722. Although the first cartridge 4702 is shown to include two alignment features 4720, 4722, in some embodiments, the first cartridge 4702 can include a single alignment feature. In other embodiments, first cartridge 4702 can include three or more alignment features. In one example, the first cartridge 4702 can include a first alignment feature 4720 and a second alignment feature 4722. In some embodiments, the first cartridge 4702 and/or the first photonic integrated subcircuit 4706 can include a first optical path (e.g., a first waveguide).

Referring again to FIG. 47A, in some embodiments, the second cartridge 4704 can include a corresponding third and fourth alignment features 4724, 4726. In some embodiments, the third and/or fourth alignment features 4724, 4726 can include receiving features. In an example, the third and/or fourth alignment features 4724, 4726 can include a hole and/or cavity as shown in FIG. 47A. In some embodiments, the third and/or fourth alignment features 4724, 4726, can be configured to receive the first and second alignment features 4720, 4722 (e.g., the first and second alignment features 4720, 4722 can be inserted into the third and/or fourth alignment features 4724, 4726). Although the second cartridge 4702 is shown to include two alignment features 4724, 4726, in some embodiments, the second cartridge 4704 can include a single alignment feature. In other embodiments, the second cartridge 4704 can include three or more alignment features. In some embodiments, the second cartridge 4704 and/or the second photonic integrated subcircuit 4708 can include a second optical path (e.g., a second waveguide).

Referring to FIG. 47B, an exemplary photonic integrated subcircuit including trench features configured to enable coupling with corresponding extruded features of a cartridge is presented, according to some embodiments. In some embodiments, the photonic integrated subcircuit shown in FIG. 47B can represent the first photonic integrated subcircuit 4706 and/or the second photonic integrated subcircuit 4708 shown in FIGS. 47A and 47C. In some embodiments, the example first photonic integrated subcircuit 4706 can include trench features 4760, as shown in FIG. 47B. In some embodiments, the trench features 4760 can include a groove, a hole, receptacle and/or a cavity among other configurations. As described above, the trench features 4760 can be configured to receive and/or couple to corresponding extruded features of a cartridge, e.g., the first cartridge 4702 described in more detail in FIG. 47C below. In some embodiments, the first photonic integrated subcircuit 4706 (e.g., mating faces or locating faces) can include a first optical path 4740 (e.g., a first waveguide, similar to that described in FIGS. 46A-46C). In some embodiments, the first photonic integrated subcircuit 4706 can include mating portions and/or locating portions 4766 corresponding to pedestal features of a cartridge (e.g., the first cartridge 4702 in FIG. 47C and/or the first and second cartridges 4702, 4706 of FIG. 47A). Note that the second photonic subcircuit 4708 may have structures similar to those described for the first subcircuit 4706.

Referring to FIG. 47C, shows a photonic integrated subcircuit coupled to a first cartridge via trench features of the first photonic integrated subcircuit and extruded features of the first cartridge is presented, according to some embodiments. In some embodiments, the trench features 4760 can center the first photonic integrated subcircuit 4706 to the first cartridge 4702 (e.g., through elastic averaging), as shown in FIG. 47C. In the same example, the trench features 4760 can constrain the photonic integrated subcircuit 4706 in the X, Y and rotational orientation of the photonic integrated subcircuit and constrain and/or limit process variation which can be a substantial cause for variability in the dimensions of a photonic integrated subcircuit. In some embodiments, the photonic integrated subcircuit 4706 can have surfaces manufactured at a repeatable, precise depth for alignment in the z-axis. In one example, the first cartridge 4702 can include precise protrusions and/or extruded features 4762 which can make contact with the trench features 4760 and a surface of the pockets of the trench features 4760 (e.g., as shown in FIG. 47C). In some examples, this can establish the location and/or orientation of the first photonic integrated subcircuit 4706 within a respective cartridge in six degrees of freedom. Additionally, in some embodiments, the first cartridge can include pedestal features 4768 can also adjust the Z-axis alignment. Also shown are the alignment features 4720, 4722 of the first cartridge 4702 (e.g., corresponding the same alignment features described in FIG. 47C). Note that the first cartridge 4704 may have similar features to those described for cartridge 4702 and that the second photonic subcircuit 4708 may have structures similar to those described for the first subcircuit 4706.

Referring again to FIGS. 47A-47C, in some embodiments, as described and shown in FIGS. 47A-47C, alignment of one cartridge to another cartridge can be performed through one or more techniques, including the alignment using two or more precision alignment features such as rods and/or pins.

Referring to FIGS. 47D-47L, exemplary structures for optical alignment between cartridges including photonic integrated subcircuits are presented, according to some embodiments. FIG. 47D shows a cross-sectional view of a cartridge including a mechanical alignment feature configured for aligning an optical alignment structure. FIG. 47E shows a top view of the cartridge from FIG. 47D. FIG. 47F shows a zoomed-in view of the mechanical alignment feature described and shown in FIG. 47D. FIG. 47G shows a cross-sectional view of a cartridge including a mechanical alignment feature. FIG. 47H shows a top view of the cartridge from FIG. 47G. FIG. 47I shows a zoomed-in view of the mechanical alignment feature described and shown in FIG. 47G. FIG. 47J shows a cross-sectional view of a first and a second cartridge including a mechanical alignment feature. FIG. 47K shows a top view of the cartridge from FIG. 47J. FIG. 47L shows the first and second cartridges of FIG. 47J to be coupled with a ferrule.

Referring to FIGS. 47D-47F, a first cartridge including a mechanical alignment feature configured for aligning an optical alignment structure is presented, according to some embodiments. As shown, the first cartridge 4702 can include a first photonic integrated subcircuit 4706. Referring to FIG. 47D, a zoomed-in view 4768 of a first mechanical alignment feature 4772 of the first cartridge 4702 and a second mechanical alignment feature of the first photonic integrated subcircuit 4706 is shown in FIG. 47F. In some examples, the first and second mechanical alignment features 4772, 4774 can include a sawtooth configuration, where a series of v-grooves can mate with a series of protrusions that can have a corresponding triangular cross section. In some examples, the first and second mechanical alignment features 4772, 4774 (e.g., mating features) can have a cylindrical shape. In some embodiments, the second mechanical alignment feature 4774 can be configured to receive the first optical alignment feature 4772. In some examples, the first and second mechanical alignment features 4772, 4774 can include a sawtooth configuration. Also shown are optical alignment structures 4770 and locations 4780 where adhesive can be placed, the adhesive configured to bond the first photonic integrated subcircuit 4706 to the first cartridge 4702. In some examples, the optical alignment structures 4770 can include optical fibers. Note that the second cartridge 4704 has similar features to those described for cartridge 4702 and that the second photonic subcircuit 4708 may have structures similar to those described for the first subcircuit 4706.

Referring to FIGS. 47D-47F, a first cartridge including a first mechanical alignment feature configured to optically align the first cartridge to a photonic integrated subcircuit is presented, according to some embodiments. As shown, the first cartridge 4702 can include a first photonic integrated subcircuit 4706. Referring to FIG. 47F, a zoomed-in view 4768 of the first mechanical alignment feature 4772 is shown in FIG. 47D. In some embodiments, the first cartridge 4702 can include a first mechanical alignment feature 4772 configured to align the first photonic integrated subcircuit 4706 to the first cartridge 4702. In some embodiments, the first mechanical alignment feature 4772 can include an extruded sawtooth configuration, among other configurations. In some embodiments, the first photonic integrated subcircuit 4706 can include a corresponding second mechanical alignment feature 4774. In some embodiments, the second mechanical alignment feature 4774 can be configured to receive the first mechanical alignment feature 4772. In one example, the second mechanical alignment feature 4774 can include a v-groove (e.g., include a shape in the opposite/negative of the first mechanical alignment feature 4772). In some examples, the second mechanical alignment feature 4774 can include a groove, a hole, receptacle and/or a cavity, among other configurations. In some embodiments, the first cartridge 4702 and/or first photonic integrated subcircuit can include a first light path 4740 (e.g., first waveguide). In some embodiments, as shown, the first cartridge 4702 can include locations 4780 where an adhesive can be placed, where the adhesive can be configured to bond the first photonic integrated subcircuit 4706 to the first cartridge 4702. In some embodiments, the first cartridge 4702 can include an optical fiber array 4770 as shown in FIG. 47E. Note that the second cartridge 4704 has similar features to those described for cartridge 4702 and that the second photonic subcircuit 4708 may have structures similar to those described for the first subcircuit 4706.

Referring to FIGS. 47G-47I, a first cartridge including a third mechanical alignment feature configured to align the cartridge to a photonic integrated subcircuit is presented, according to some embodiments. As shown, the first cartridge 4702 can include a first photonic integrated subcircuit 4706. Similar to that described in FIGS. 47D-47F, the first photonic integrated subcircuit 4706 and the first cartridge 4702 can represent the first and/or second photonic integrated subcircuits and first and/or second cartridge described in the preceding figures.

Referring to FIG. 47G, a zoomed-in view 4769 of the mechanical alignment feature 4772 is shown in FIG. 47I. In some embodiments, the first cartridge 4702 can include a third mechanical alignment feature 4776 configured to align the first photonic integrated subcircuit 4706 to the first cartridge 4702. In some examples, the third mechanical alignment feature 4776 can include a sawtooth configuration. In some examples, first photonic integrated subcircuit 4706 can include a corresponding fourth mechanical alignment feature 4778. In some embodiments, the third alignment feature 4776 and the fourth alignment feature 4778 can both be configured to receive a fifth alignment feature 4779. In some examples, the fifth alignment feature 4779 can include a rod and/or fiber, among other alignment features. In some examples, the third and fourth alignment features 4776, 4778 can be configured to receive a rod and/or fiber. In some embodiments, the first cartridge 4702 and/or first photonic integrated subcircuit 4706 can include a light path, e.g., a first light path 4740 (e.g., first waveguide). Similar to that described in FIGS. 47D-47F, the first cartridge 4702 can include an adhesive 4780. Note that the second cartridge 4704 has similar features to those described for cartridge 4702 and that the second photonic subcircuit 4708 may have structures similar to those described for the first subcircuit 4706.

Referring to FIGS. 47J-47L, a first and second cartridge including a third mechanical alignment feature configured to align the cartridges to a ferrule is presented, according to some embodiments. FIG. 47J shows a cross-sectional view of a first and a second cartridge including another mechanical alignment feature. FIG. 47K shows a top view of the cartridge from FIG. 47J. FIG. 47L shows the first and second cartridges of FIG. 47J to be coupled with a ferrule.

Referring to FIGS. 47J and 47K, a first cartridge and a second cartridge to be coupled together directly using a top and bottom alignment features is presented, according to some embodiments. In some embodiments, FIGS. 47J and 47K show the coupling of a first cartridge 4702 to a second cartridge 4704 via a top alignment feature 4782 of the first cartridge 4702 and a bottom alignment feature 4784 of the second cartridge 4704. In an example, the first cartridge 4702 can be disposed over the second cartridge 4704. In some embodiments, similar to that described above, the first cartridge 4702 can include a first photonic integrated subcircuit and the second cartridge 4704 can include a second photonic integrated subcircuit. In some embodiments, the first cartridge 4702 and/or the first photonic integrated subcircuit can include a first optical path 4740 (e.g., a first waveguide). In some embodiments, the second cartridge 4704 and/or the second photonic integrated subcircuit can include a second optical path 4742 (e.g., a second waveguide).

Referring to FIG. 47L, the first and second cartridges 4702, 4704 of FIG. 47J to be coupled with a ferrule is presented, according to some embodiments. In some embodiments, the ferrule 4712 can include a corresponding sixth and seventh mechanical alignment features 4786, 4788. In some embodiments, the sixth and seventh mechanical alignment features 4786,4788 can include a rod and/or pin. In an example, the top and bottom alignment features 4782, 4784 together can be configured to receive the sixth and seventh alignment features 4786, 4787 (e.g., the sixth and seventh alignment features 4786, 4788 can be inserted into the top and bottom alignment features 4782, 4784). In some examples, the ferrule 4712 can couple the first and second cartridges 4702, 4704 to a fiberoptic array (e.g., a third optical path).

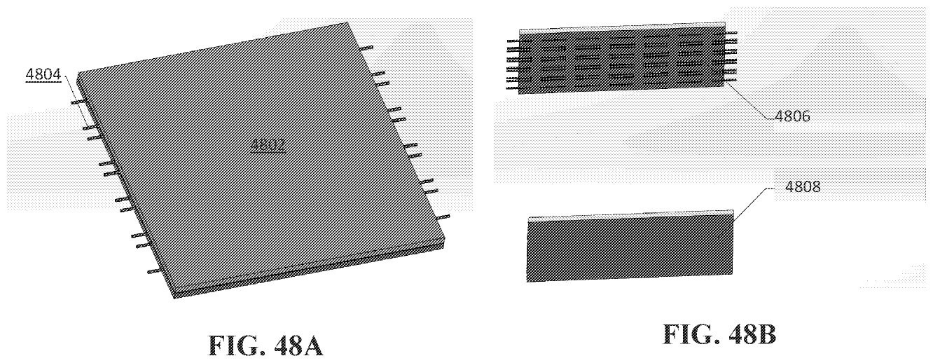

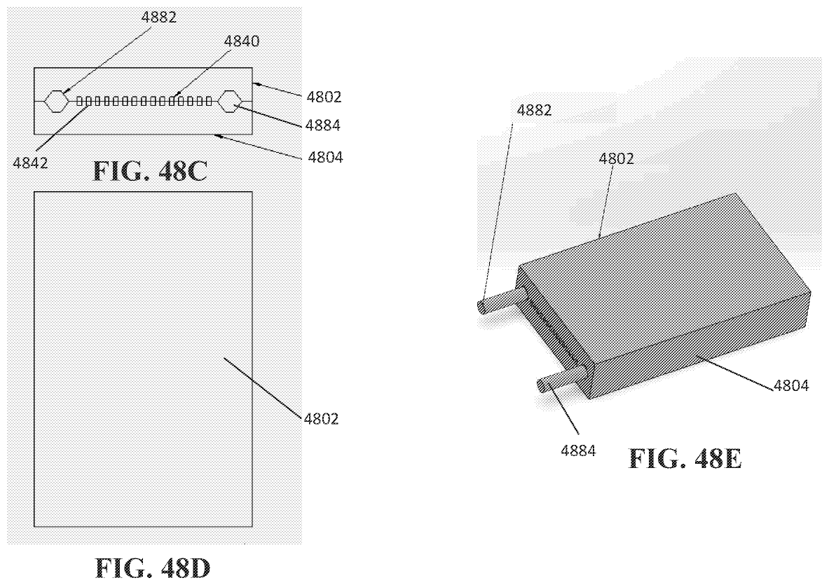

Referring to FIGS. 48A-48E, exemplary structures for the wafer-level fabrication of photonic integrated subcircuits are presented, according to some embodiments. FIG. 48A shows a wafer scale configuration for photonic integrated subcircuits prior to singulation and/or dicing. FIG. 48B shows separate portions for the wafer scale configuration of FIG. 48A. FIG. 48C shows a cross-sectional view of a cartridge subsequent to singulation and/or dicing. FIG. 48D shows a top view of the cartridge from FIG. 48C. FIG. 48E shows the first and second cartridges of FIG. 48D.

Referring to FIGS. 48A and 48B, exemplary wafer scale configuration for photonic integrated subcircuits prior to singulation and/or dicing are presented, according to some embodiments. As shown in FIG. 48A, a wafer scale configuration 4802 can represent a wafer scale configuration for one or more cartridges described herein. In an example, the wafer scale configuration 4802 can include one or more cartridges prior to the singulation and/or dicing of the wafer scale configuration 4802. In some examples, the wafer scale configuration 4802 can include one or more alignment features 4804 (e.g., including rods and/or pins). In some embodiments, the wafer scale configuration 4802 (e.g., plurality of uncut/diced cartridges) can include one or more photonic integrated subcircuits. Thus, using a wafer scale configuration can enable a precise alignment between cartridges due to the alignment and/or singulation between cartridges happening on the wafer level. Referring to FIG. 48B, in one example, starting from a first wafer 4806 including alignment features 4804 and a second wafer 4808, the first wafer 4806 can be aligned to the second wafer 4808 and subsequently bonded. In some examples, optical coupling wafer 4806 using features in the second wafer 4808 may allow for active alignment of one wafer with respect to the other before bonding. In some embodiments, this technique can be advantageous as a process control for inter-wafer variability in the location and/or dimensions of alignment features. Although a wafer scale representation is shown, other manufacturing scale configurations can be used. In some examples, after the wafer has been diced, individual photonic subcircuits (e.g., chiplets) and cartridges can be assembled together using automated manufacturing techniques.

Referring to FIGS. 48C-48E, exemplary sample cartridges subsequent to the singulation/dicing described in FIGS. 48A and 48B are presented, according to some embodiments. In some embodiments, the dicing/singulation process can enable precise alignment between cartridges since the alignment was already performed at the wafer level prior to the dicing (e.g., referring to FIGS. 48A and 48B). In an example, FIGS. 48C and 48D show the alignment and coupling of a first cartridge 4802 to a second cartridge 4804 which were formed subsequent to the dicing/singulation process described above. In some examples, the first cartridge 4802 can include a first alignment feature 4882 and the second cartridge 4804 can include a second alignment feature 4884. In some embodiments, the first and second alignment features 4882, 4884 can include a rod and/or alignment pin. In an example, the first cartridge 4802 can be disposed over the second cartridge 4804. In some embodiments, similar to that described above, the first cartridge 4802 can include a first photonic integrated subcircuit and the second cartridge 4804 can include a second photonic integrated subcircuit. In some embodiments, the first cartridge 4802 and/or the first photonic integrated subcircuit can include a first optical path 4840 (e.g., a first waveguide). In some embodiments, the second cartridge 4804 and/or the second photonic integrated subcircuit can include a second optical path 4842 (e.g., a second waveguide).

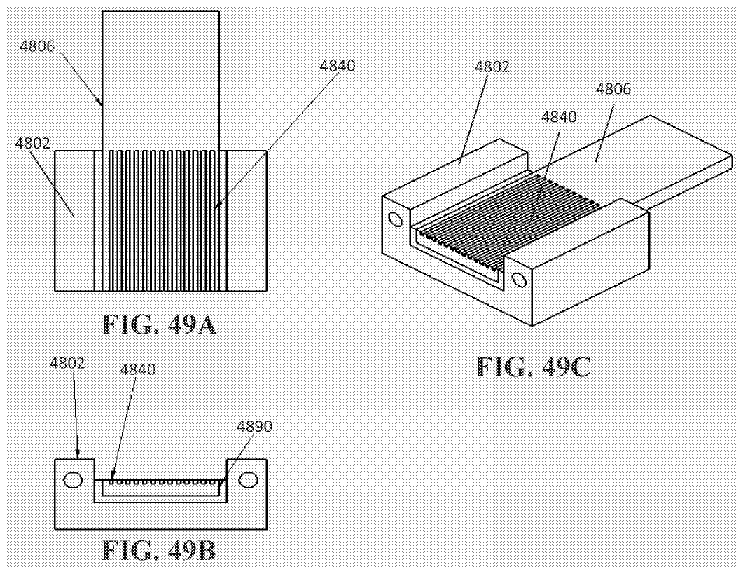

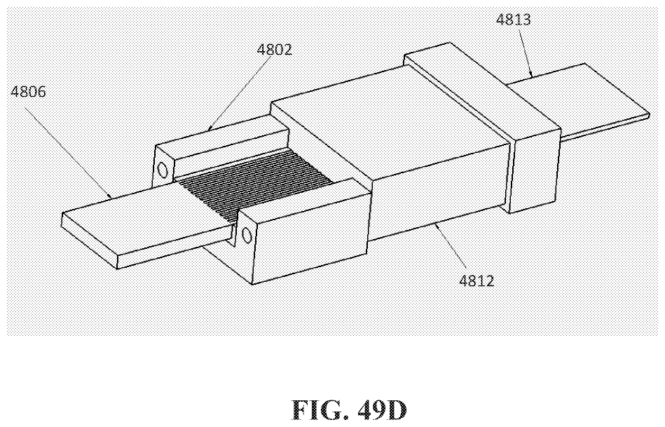

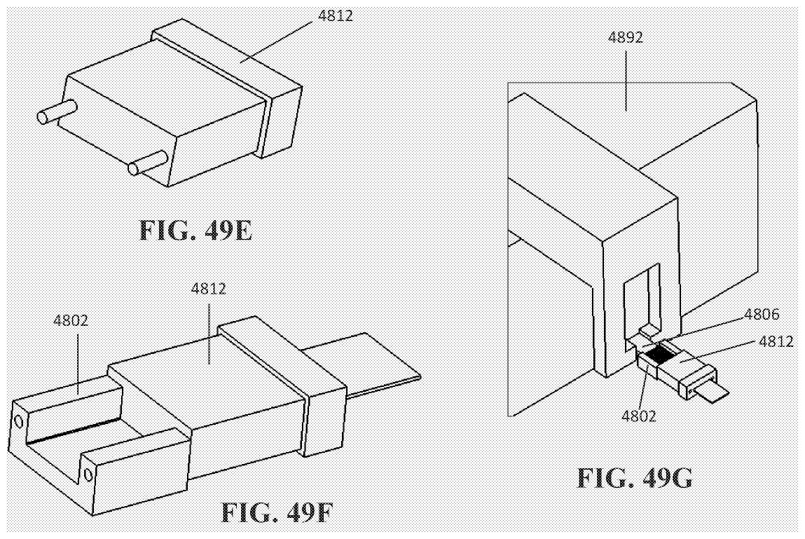

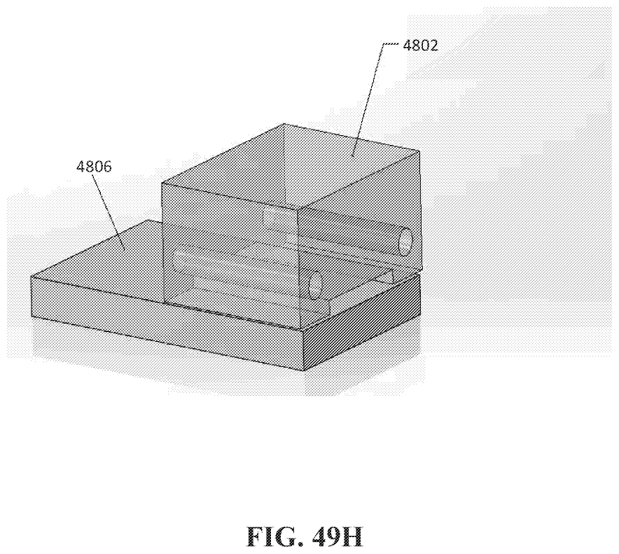

Referring to FIGS. 49A-49H, exemplary structures for aligning a first cartridge to a photonic integrated subcircuit are presented according to some embodiments. FIG. 49A shows a top view of a cartridge optically aligned to a photonic integrated subcircuit. FIG. 49B shows a plan view of the cartridge optically aligned to the photonic integrated subcircuit. FIG. 49C shows a side view of the cartridge optically aligned to the photonic integrated subcircuit. FIG. 49D shows the cartridge of FIG. 49C coupled to a ferrule. FIG. 49E shows another view of the ferrule of FIG. 49D. FIG. 49F shows the cartridge without a photonic integrated subcircuit coupled to the ferrule. FIG. 49G shows the cartridge coupled to the ferrule and a positioning stage. FIG. 49H shows another cartridge coupled to a photonic integrated subcircuit.

Referring to FIGS. 49A-49C, a cartridge including a photonic integrated subcircuit is presented, according to some embodiments. In some embodiments, a first cartridge 4802 can include a first photonic integrated subcircuit 4806 as shown. In some embodiments, the first photonic integrated subcircuit 4806 can be bonded 4890 to the first cartridge 4802. In some embodiments, a layer of adhesive 4890 can be used to bond the first photonic integrated subcircuit 4806 to the first cartridge 4802. In some embodiments, the first cartridge 4802 and/or the first photonic integrated subcircuit 4806 can include a first optical path 4840 (e.g., a first waveguide). As described in detail below, a ferrule can be used to optically align the first cartridge 4802 to the first photonic integrated subcircuit 4806 (e.g., to provide alignment prior to and/or during a bonding process).

Referring to FIG. 49D-49F, a first cartridge coupled with a ferrule is presented, according to some embodiments. Similar to that described above, the first cartridge 4802 can include a first photonic integrated subcircuit 4806. In some embodiments, an optical feedback process can be used to couple the first cartridge 4802 to first photonic integrated subcircuit 4806 using the ferrule 4812, or any other type of external adapter that can be used to perform an optical alignment and/or optical feedback process. In some embodiments, as shown, the ferrule 4812 can include an external connector 4813 (e.g., a fiber ribbon cable). Another view of the ferrule 4812 is shown in FIG. 49E. Additionally, another view of the first cartridge 4802 coupled with the ferrule 4812 but prior to the alignment and/or placement of the first photonic integrated subcircuit is shown in FIG. 49F.

Referring to FIG. 49G, a first cartridge being aligned with a first photonic integrated subcircuit using optical alignment via ferrule and a positioning stage is presented, according to some embodiments. In some embodiments, active alignment and/or optical feedback between a first photonic integrated subcircuit 4806 and the ferrule 4812 can be used to guide a positioning stage 4892 to correctly locate and/or position the first photonic integrated subcircuit 4806 to the first cartridge 4802. In some examples, optical loss between the first photonic integrated subcircuit 4806 and the ferrule 4812 can be measured (e.g., continually, intermittently, etc.) during an alignment process (e.g., optical feedback alignment process), where the first photonic integrated subcircuit 4806 can be bonded to the first cartridge 4802 at a time when the measured loss is within an acceptable limit/range. In some embodiments, a precise mechanical mate and/or bond between the first cartridge 4802 and the ferrule 4812 can ensure that the first cartridge 4802 can be disconnected from the ferrule 4812 and can be reliably aligned when re-connected. In some embodiments, subsequent to alignment between the first photonic integrated subcircuit 4806 and the first cartridge 4802, an adhesive may be applied to permanently bond first photonic integrated subcircuit 4806 and the first cartridge 4802 together.

FIG. 49H illustrates edge coupling of a cartridge to a photonic integrated subcircuit via optical alignment structures, according to some embodiments. Similar to the above, optical feedback can be used to couple a first cartridge 4802 to a first photonic integrated subcircuit 4806. In some examples, optical alignment structures may be actively positioned (e.g., via optical feedback) and bonded to photonic integrated subcircuits on a wafer scale (e.g., as described in FIGS. 48A-48E) or on a chip-by-chip basis after wafer dicing. In some embodiments, this can enable passive mechanical alignment of one chip to another via commonly used means, such as two or more precision pins.

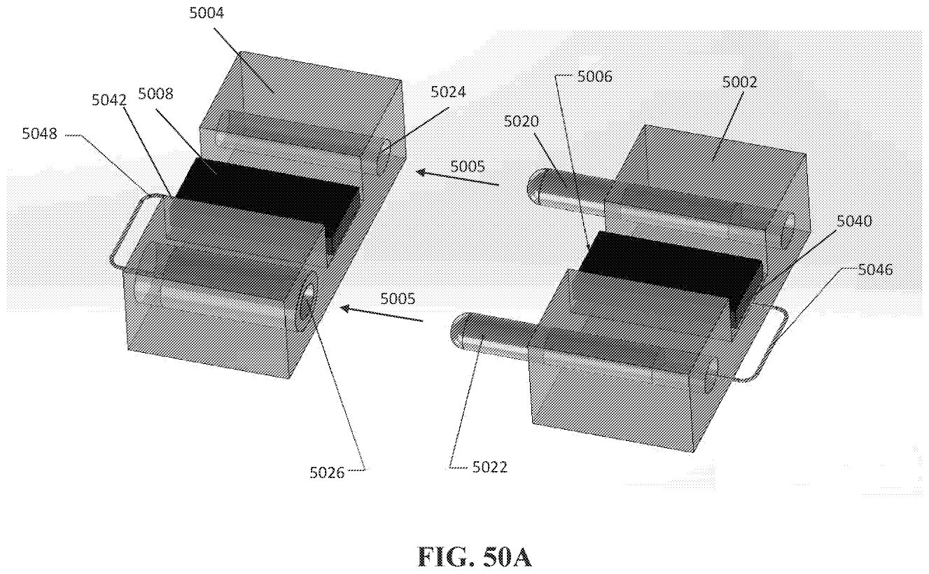

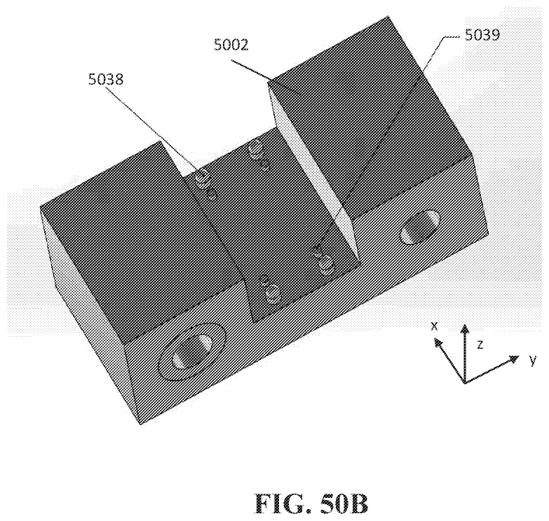

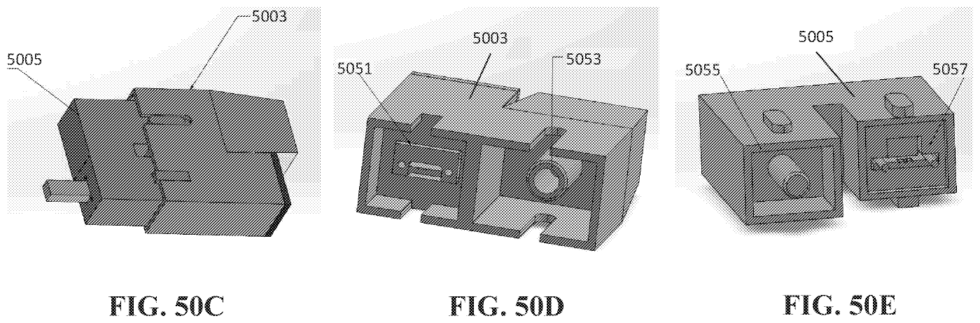

Referring to FIGS. 50A-50E, exemplary structures for coupling photonic integrated subcircuits directly together are presented according to some embodiments. FIG. 50A shows a first cartridge and a second cartridge to be coupled together using alignment features having a light path. FIG. 50B shows a cartridge including subcircuit mechanical alignment features. FIG. 50C shows a male and female cartridge configuration. FIG. 50D shows the female cartridge configuration. FIG. 50E shows the male cartridge configuration.

Referring to FIG. 50A, a first cartridge and a second cartridge to be coupled together using alignment features having a light path is presented, according to some embodiments. In some embodiments, FIG. 50A shows the coupling 5005 a first cartridge 5002 to a second cartridge 5004 via alignment features 5020, 5022, 5024, 5026, e.g., the coupling of the first and second cartridges 5002, 5004 directly to each other. In some embodiments, the first cartridge 5002 can include a first photonic integrated subcircuit 5006 and the second cartridge 5004 can include a second photonic integrated subcircuit 5008. In some embodiments, the first cartridge 5002 can include one or more alignment features. In one example, the first cartridge 5002 can include a first alignment feature 5020 and a second alignment feature 5022. In some embodiments, the first cartridge 5002 and/or the first photonic integrated subcircuit 5006 can include a first optical path 5040 (e.g., a first waveguide). In some embodiments, the embodiments of FIGS. 50A-50E can include multi-mode inputs and/or outputs cartridge configurations which can be more tolerant to misalignment (e.g., +/−10 micron alignment) and/or single mode inputs and/or outputs which can be less tolerant to misalignment (e.g., +/−1 micron alignment).

Referring again to FIG. 50A, in some embodiments, the second cartridge 5004 can include a corresponding third and fourth alignment features 5024, 5026. In some embodiments, the third and/or fourth alignment features 5024, 5026 can include receiving features. In an example, the third and/or fourth alignment features 5024, 5026 can include a hole and/or cavity as shown in FIG. 50A. In some embodiments, the third and/or fourth alignment features 5024, 5026, can be configured to receive the first and second alignment features 5020, 5022 (e.g., the first and second alignment features 5020, 5022 can be inserted into the third and/or fourth alignment features 5024, 5026). In some embodiments, the second cartridge 5004 can include one or more alignment features. In some embodiments, the second cartridge 4704 and/or the second photonic integrated subcircuit 4708 can include a second optical path 5042 (e.g., a second waveguide).

Referring still again to FIG. 50A, in some embodiments, a light path can be coupled to the alignment features 5020, 5022, 5024, 5026. In some embodiments, the first cartridge can include a third light path 5046. In some embodiments, the second cartridge can include a fourth light path 5048. In some embodiments, the third and fourth light paths 5046, 5048 can include fiber optics, optical fibers, among other optical components. In some embodiments, the alignment features 5020, 5022, 5024, 5026 including the light paths 5046, 5048 can be configured to optically and/or mechanically couple the first cartridge 5002 to the second cartridge 5004. In some examples, two photonic integrated subcircuits 5006, 5008, each containing waveguides 5040, 5042 with varying degrees of acceptable tolerance for misalignment, can be coupled. In one example, fiber-optic cables, referred to as fibers, may be coupled to waveguides 5040, 5042 on the first and second photonic integrated subcircuits that can require high precision alignment as shown.

Referring to FIG. 50B, cartridge including vertical alignment features is presented according to some embodiments. In some embodiments, a first cartridge 5002 can include a first and second subcircuit mechanical alignment features 5038, 5039. In some embodiments, the first subcircuit mechanical alignment feature 5038 can secure a photonic integrated subcircuit to the first cartridge along the X and/or Y axes. In some embodiments, the second subcircuit mechanical alignment feature 5039 can secure a photonic integrated subcircuit to the first cartridge along the Z axis.

FIG. 50C illustrates an example of alignment between two integrated photonic chips (e.g. containing waveguides) with varying degrees of acceptable tolerance for misalignment. For example, the connector may contain two sections. Inside one section, less precise edge coupling occurs, while inside the other there may be high precision fiber-to-fiber coupling. Fibers may be coupled to one another via commonly known techniques (e.g. via a standard lucent connector (LC) or a subscriber connector (SC) type connections). In some examples, a lucent connector can include a male/female fiber optic connector used to align a single fiber to another fiber and a subscriber connector (SC) can include a male/female fiber optic connector used to align a single fiber to another fiber. In one example, an SC can take advantage of a push-pull latching mechanism.

Referring to FIGS. 50C-50E, exemplary male and female cartridge configurations are presented, according to some embodiments. In some embodiments, the female cartridge 5003 can be configured to receive the male cartridge 5005. In some embodiments, the female cartridge 5003 can include a first connector 5051 and a second connector 5053. In some embodiments, the first connector 5051 can include a multi-fiber push-on (MPO) type connector. In some embodiments, the second connector 5053 can include a standard SC adapter. Similarly, the male cartridge 5005 can include a third and fourth connector 5055, 5057. In some embodiments, the third connector 5055 can include a standard SC adapter. In some embodiments, the second connector 5053 can include a multi-fiber push-on (MPO) type connector. In some examples, edge and/or surface coupling techniques, such as those described herein, can enable photonic integrated subcircuits (e.g., and their corresponding waveguides) which may require less precise alignment to couple without the added manufacturing cost and time of individual fiber coupling. In some examples, an adapter may contain features which allow the adapter to passively align to a photonic integrated subcircuit. In some embodiments, a female cartridge/adapter 5003 may contain a female ferrule or other structure within which resides a fiberoptic cable. In some embodiments, the male cartridge/adapter 5005 may contain a male ferrule or other structure within which resides a fiberoptic cable.

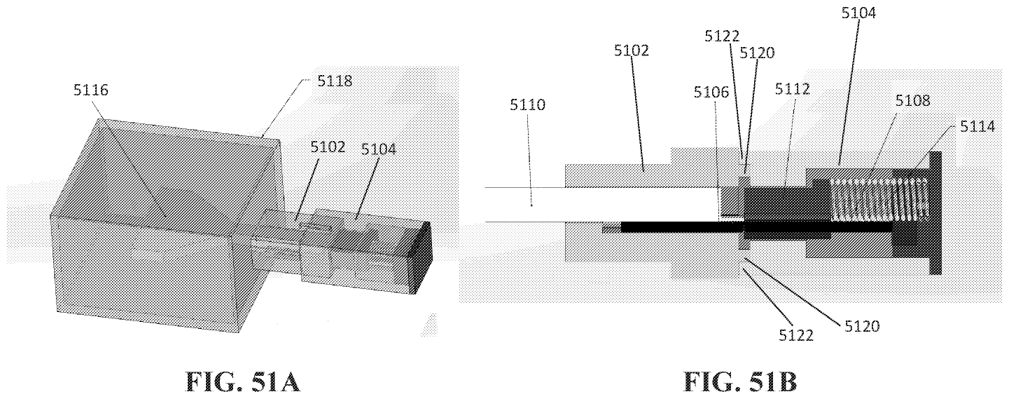

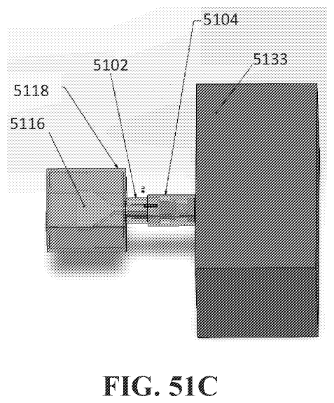

Referring to FIGS. 51A-51C, exemplary structures for coupling photonic integrated subcircuits directly together are presented, according to some embodiments. FIG. 51A shows a system for coupling photonic integrated subcircuits including a microfluidics. FIG. 51B shows a zoomed-in view of a first and second cartridge. FIG. 51C shows a plan view of the system for coupling photonic integrated subcircuits including a microfluidics channel.

Referring to FIGS. 51A-51C, exemplary structures for improved alignment accuracy between a first and a second photonic integrated subcircuit are presented, according to some embodiments. In some embodiments, a first cartridge 5102 can include a first alignment feature 5120. In some embodiments, the first cartridge 5105 can include a microfluidics channel 5110 disposed within the first cartridge 5102. In some embodiments, the first cartridge 5102 can include a first photonic integrated subcircuit 5106. In some embodiments, the first photonic integrated subcircuit 5106 can be disposed within the first cartridge 5102. In some embodiments, the first photonic integrated subcircuit 5106 can be adjacent to the microfluidics channel 5110. In some embodiments, a second cartridge 5104 can include a second alignment feature 5122. In some embodiments, the second alignment feature 5122 can include a receiving feature configured to receive the first alignment feature 5120. In some embodiments, the first alignment feature 5120 can include a receiving feature configured to receive the second alignment feature 5122. In some embodiments, a ferrule 5112 can be coupled to a spring 5114 disposed within the second cartridge 5104. In some embodiments, a second photonic integrated subcircuit 5108 can be disposed within the second cartridge 5104. In some embodiments, a second photonic integrated subcircuit 5108 can be adjacent to the ferrule 5112. In some embodiments, the first alignment feature 5120 and the second alignment feature 5122 can be configured to enable alignment between the first photonic integrated subcircuit 5106 and the second photonic integrated subcircuit 5108. As shown, the first alignment feature 5120 and the second alignment feature 5122 are one example among other alignment features that can be used (e.g., the first and second alignment features 5120, 5122 are not limited to example alignment features shown). In some embodiments, when the first photonic integrated subcircuit 5106 is aligned to the second photonic integrated subcircuit 5108, a first light path of the first photonic integrated subcircuit 5106 can be optically coupled to a second light path of the second photonic integrated subcircuit 5108. In some embodiments, the first cartridge 5102 can include a microfluidics structure 5116 and a cartridge housing 5118. In some embodiments, the second cartridge can include a cartridge reader 5133. In some embodiments, methods/systems described herein establish gross chip-to-chip alignment and immobilization of photonic chips so that the optical alignment procedure and/or the optical connection can be highly accurate, repeatable and robust against vibration. In some examples, a handheld connector may be used for cartridge to cartridge coupling (e.g., between a cartridge chip containing a cartridge housing and microfluidics and a reader chip containing a floating ferrule and spring), as shown. In some embodiments, photonic integrated subcircuits 5102, 5104 can be loosely constrained by the structure of the connector and may also be spring loaded, allowing for precision alignment to occur via other structures (e.g., precision pins, etc.). In some embodiments, a diagnostic cartridge containing microfluidics (e.g., 5116), a photonic integrated subcircuit (e.g., 5102) that can couple to a second photonic subcircuit (e.g., 5104) within in a reader cartridge. In some embodiments, the first and second cartridges 5102, 5204 can include a multi-fiber push-on (MPO) connector.

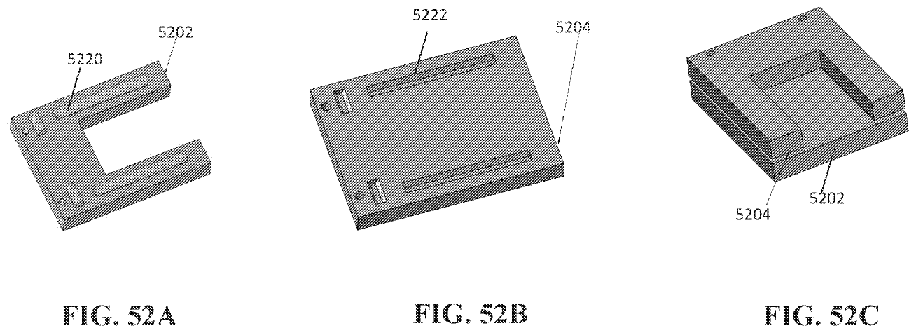

Referring to FIGS. 52A-52C, exemplary structures for coupling photonic integrated subcircuits directly together are presented, according to some embodiments. FIG. 52A shows a first cartridge including top alignment features. FIG. 52B shows a second cartridge including bottom alignment features. FIG. 52C shows the first and second cartridges coupled together.

In some embodiments, FIG. 52A shows a first cartridge 5202 having a first alignment feature 5220. Similarly, FIG. 52B shows a second cartridge 5202 including a second alignment feature 5222. In some embodiments, the first alignment feature 5120 can include a top alignment feature. In some embodiments, the second alignment feature 5122 can include a bottom alignment feature. In some embodiments, the first cartridge 5202 can include a first photonic integrated subcircuit and the second cartridge 5204 can include a second photonic integrated subcircuit. In some embodiments, the first cartridge can include one or more alignment features. In some embodiments, the first alignment feature 5020 can include one or more rods. In some embodiments, the first alignment feature 5220 can be formed in, but not necessarily limited to, a shape of a rod or half a rod, as shown in FIG. 52A. In some examples, the first alignment feature 5220 can be in a rod shape, a cylindrical shape, a cuboid shape, a half a rod shape, a half a cylindrical shape, a half a cuboid shape, etc. In some embodiments, the first cartridge 5202 and/or the first photonic integrated subcircuit can include a first optical path (e.g., a first waveguide).

Referring again to FIG. 52B, in some embodiments, the second cartridge 5204 can include a corresponding second alignment feature 5222. In some embodiments, the second alignment feature 5222 can include a receiving feature. In an example, the second alignment feature 5222 can include a hole and/or cavity as shown in FIG. 52B. In some embodiments, the second alignment feature 5222 can be configured to receive the first alignment features 5220, (e.g., the first alignment feature 5220 can be inserted into the second alignment features 5222). In some examples, the second alignment feature 5222 can include a groove, a hole, receptacle and/or a cavity. In some embodiments, the second cartridge 5204 can include one or more alignment features. In some embodiments, the second cartridge 5204 and/or the second photonic integrated subcircuit can include a second optical path (e.g., a second waveguide). In some embodiments, top coupling techniques can be used to align photonic integrated subcircuits. In some examples, FIGS. 52A-52C illustrates an example of how two cartridges and/or photonic integrated subcircuits (e.g., male and female chips) can be aligned together.

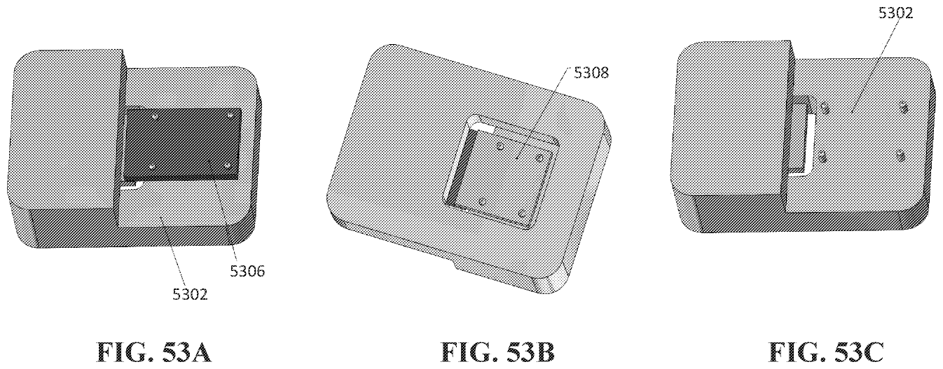

Referring to FIGS. 53A-53C, exemplary structures for coupling photonic integrated subcircuits having overlapping photonic integrated subcircuits are presented, according to some embodiments. FIG. 53A shows a top view of a first cartridge and a first photonic integrated subcircuit. FIG. 53B shows a bottom view of a the first cartridge and second photonic integrated subcircuit. FIG. 53C shows the first cartridge with the first photonic integrated subcircuit removed. As shown, the first cartridge 5302 can include a first photonic integrated subcircuit 5306 coupled to a second photonic integrated subcircuit 5308. As shown, the first photonic integrated subcircuit 5306 can overlap and/or partially overlap with the second photonic integrated subcircuit 5308. In some embodiments, the overlap can enable optical coupling between the first photonic integrated subcircuit 5306 and the second photonic integrated subcircuit 5308. In some embodiments, this top coupling may occur without an adapter (e.g., using multiple v-grooves which may precisely and repeatably constrain cylindrical pins). In some examples, an adapter may be used for alignment (e.g., via an adapter featuring analogous v-groove features). In some examples of top coupling, of a photonic integrated subcircuit may contain cylindrical trenches constrained by cylindrical protrusions, as shown in FIGS. 53A-53B. In some examples, alignment may occur with an adapter (e.g., the described protrusions are features of an adapter). In some embodiments, the protrusions may be pins that have been directly inserted into the second integrated photonic subcircuit.

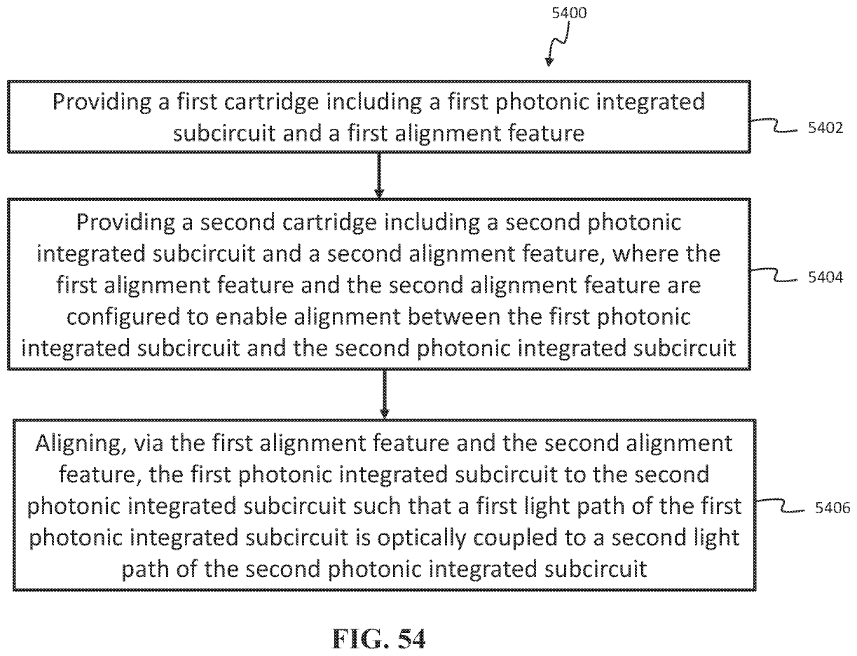

Referring to FIG. 54, a flowchart of an example method for coupling photonic integrated subcircuits is presented, according to some embodiments. In some embodiments, in a step 5402, the method includes providing a first cartridge including a first photonic integrated subcircuit and a first alignment feature. In some embodiments, in a step 5404, the method includes providing a second cartridge comprising a second photonic integrated subcircuit and a second alignment feature, where the first alignment feature and the second alignment feature are configured to enable alignment between the first photonic integrated subcircuit and the second photonic integrated subcircuit. In some embodiments, in a step 5406, the method includes aligning, via the first alignment feature and the second alignment feature, the first photonic integrated subcircuit to the second photonic integrated subcircuit such that a first light path of the first photonic integrated subcircuit is optically coupled to a second light path of the second photonic integrated subcircuit. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described components and systems can generally be integrated together in a single device or system or packaged into multiple devices or systems.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A system for coupling photonic integrated subcircuits, the system comprising:
a first cartridge comprising a first photonic integrated subcircuit and a first alignment feature; and
a second cartridge comprising a second photonic integrated subcircuit and a second alignment feature,
wherein the first alignment feature and the second alignment feature are configured to enable alignment between the first photonic integrated subcircuit and the second photonic integrated subcircuit, and
wherein, when the first photonic integrated subcircuit is aligned to the second photonic integrated subcircuit, a first light path of the first photonic integrated subcircuit is optically coupled to a second light path of the second photonic integrated subcircuit.

2. The system of claim 1, wherein the second alignment feature comprises a receiving feature configured to receive the first alignment feature.

3. The system of claim 1, wherein the first light path is within a side edge of the first photonic integrated subcircuit and the second light path is within a side edge of the second photonic integrated subcircuit.

4. The system of claim 1, wherein the first light path is within a top surface of the first photonic integrated subcircuit and the second light path is within a bottom surface of the second photonic integrated subcircuit.

5. The system of claim 4, wherein the top surface of the first subcircuit partially overlaps the bottom surface of the second subcircuit.

6. The system of claim 1, wherein at least one of the first cartridge or the second cartridge comprises a carrier configured to hold a respective one of the first photonics integrated subcircuit and the second photonics integrated subcircuit.

7. The system of claim 6, wherein a surface of the carrier comprises one or more pedestals located between the respective photonics integrated subcircuit and the carrier.

8. The system of claim 6, wherein the first photonic integrated subcircuit comprises at least two trench features and the carrier comprises at least two extruded portions, and wherein each trench feature is configured to receive a respective extruded portion such that the first photonic integrated subcircuit is secured to the carrier.

9. The system of claim 6, wherein the first photonic integrated circuit is bonded to the carrier.

10. The system of claim 9, wherein the first photonic integrated circuit is bonded to the carrier using an adhesive.

11. The system of claim 1, wherein the first alignment feature comprises at least one of a rod shape, a cylindrical shape, or a cuboid shape.

12. The system of claim 1, wherein the first cartridge comprises a third alignment feature and the second cartridge comprises a fourth alignment feature,
wherein the third alignment feature and the fourth alignment feature are configured to further enable alignment between the first photonic integrated subcircuit and the second photonic integrated subcircuit.

13. The system of claim 1, wherein the second alignment feature comprises a groove, a hole or a receptacle.

14. The system of claim 1, wherein the second alignment feature comprises a triangular groove, rectangular groove or a cylindrical groove.

15. The system of claim 1, further comprising a first optical component coupled to the first photonic integrated subcircuit and the first alignment feature.

16. The system of claim 15, wherein the first optical component comprises an optical fiber.

17. The system of claim 1, further comprising a ferrule having a third alignment feature, the third alignment feature is configured to receive at least one of the first alignment feature or the second alignment feature.

18. A system for coupling photonic integrated subcircuits, the system comprising:
a first cartridge comprising a first alignment feature;
a microfluidics channel disposed within the first cartridge;
a first photonic integrated subcircuit disposed within the first cartridge and adjacent to the microfluidics channel;
a second cartridge comprising a second alignment feature;
a ferrule coupled to a spring disposed within the second cartridge; and
a second photonic integrated subcircuit disposed within the second cartridge and adjacent to the ferrule,
wherein the first alignment feature and the second alignment feature is configured to enable alignment between the first photonic integrated subcircuit and the second photonic integrated subcircuit,
wherein, when the first photonic integrated subcircuit is aligned to the second photonic integrated subcircuit, a first light path of the first photonic integrated subcircuit is optically coupled to a second light path of the second photonic integrated subcircuit.

19. The system of claim 18, wherein the first and second cartridges comprise a multi-fiber push-on (MPO) connector.

20. The system of claim 18, wherein the second alignment feature comprises a receiving feature configured to receive the first alignment feature.

21. A method for coupling photonic integrated subcircuits, the method comprising:
providing a first cartridge comprising a first photonic integrated subcircuit and a first alignment feature; and
providing a second cartridge comprising a second photonic integrated subcircuit and a second alignment feature, wherein the first alignment feature and the second alignment feature are configured to enable alignment between the first photonic integrated subcircuit and the second photonic integrated subcircuit; and
aligning, via the first alignment feature and the second alignment feature, the first photonic integrated subcircuit to the second photonic integrated subcircuit such that a first light path of the first photonic integrated subcircuit is optically coupled to a second light path of the second photonic integrated subcircuit.
